(19) United States
(12) Patent Application Publication
(10) Pub. No.: US 2026/0274872 A1
(43) Pub. Date: Sep. 17, 2026

(54) DESIGN AND DEPLOYMENT OF MULTICOMPONENT 1,1-AMINOSILYLATION AND 1,1-AMINOBORATION REACTIONS

(71) Applicant: The Regents of the University of California, Oakland, CA (US)

(72) Inventors: Erik Romero, San Diego, CA (US); Leonel Jimenez Barrios, La Jolla, CA (US)

(21) Appl. No.: 19/560,845

(22) Filed: Mar. 9, 2026

Related U.S. Application Data
(60) Provisional application No. 63/771,530, filed on Mar. 13, 2025.

(51) Int. Cl. C07F 7/08; C07F 5/02

(52) U.S. Cl. CPC C07F 7/0812; C07F 5/027

(57) ABSTRACT

A process of forming a 1,1-aminosilane includes contacting for a predetermined length of time a mixture comprising an amine, an aldehyde, a sila-borane, and a copper catalyst in a solvent to form the 1,1-aminosilane. Also, a process of forming a 1,1-aminoborane includes contacting for a predetermined length of time a mixture comprising an amine, an aldehyde, bis(pinacolato)diboron (B₂Pin₂), and a copper catalyst in a solvent to form the 1,1-aminoborane.

### CROSS-REFERENCE TO RELATED APPLICATIONS

This application the benefit of and priority to U.S. Provisional Application No. 63/771,530, filed on Mar. 13, 2025, and which is incorporated herein by reference in its entirety.

### FIELD

The present technology is generally related to the preparation of geminal aminosilanes and aminoboranes. More specifically, it is related to the preparation of 1,1-aminosilanes and 1,1-aminoboranes using a copper-catalyzed, multicomponent reaction system.

### SUMMARY

Provided in one aspect is process of forming a 1,1-aminosilane, the process includes contacting, for a predetermined length of time, a mixture comprising an amine, an aldehyde, a sila-borane, and a copper catalyst in a solvent to form the 1,1-aminosilane.

In some embodiments, the amine is a compound of formula NHR¹R², wherein: R¹ and R² are independently selected from H, substituted or unsubstituted alkyl, substituted or unsubstituted alkenyl, substituted or unsubstituted alkynyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroaralkyl, provided that R¹ and R² are not both H; or R¹ and R² together form a substituted or unsubstituted ring with the nitrogen atom to which they are attached, wherein the ring may further incorporate one or more O, N, or S atoms.

In some embodiments, R¹ and R² are independently selected from H, substituted or unsubstituted alkyl, substituted or unsubstituted alkenyl, substituted or unsubstituted alkynyl, substituted or unsubstituted cycloalkyl, substituted or unsubstituted aryl, substituted or unsubstituted heteroaryl, substituted or unsubstituted aralkyl, or substituted or unsubstituted heteroaralkyl, provided that R¹ and R² are not both H.

In some embodiments, R¹ and R² together form a substituted or unsubstituted ring with the nitrogen atom to which they are attached, wherein the ring may further incorporate one or more O, N, or S atoms.

In some embodiments, the aldehyde is a compound of formula R³C(O)H, wherein R³ is substituted or unsubstituted alkyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroalkyl.

In some embodiments, the sila-borane is a compound of formula:

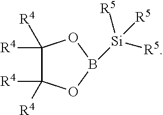

In this compound, each R⁴ is individually H, substituted or unsubstituted alkyl, or substituted or unsubstituted aryl; and each R⁵ is individually H, substituted or unsubstituted alkyl, substituted or unsubstituted aryl, substituted or unsubstituted cycloalkyl, substituted or unsubstituted heterocycloalkyl, substituted or unsubstituted heteroaryl, or substituted or unsubstituted alkoxy.

In some embodiments, the sila-borane is triethylsilylpinacolborane.

In some embodiments, the copper catalyst is CuX(IPr), wherein IPr is a 1-(2,6-diisopropylphenyl)-1H-imidazole group, and X is F, Cl, Br, triflate, or other suitable anion. In some embodiments, X is Cl or triflate.

In some embodiments, the 1,1-aminosilane is a compound of formula:

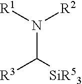

where: R³ is substituted or unsubstituted alkyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroalkyl; R¹ and R² are independently selected from H, substituted or unsubstituted alkyl, substituted or unsubstituted alkenyl, substituted or unsubstituted alkynyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroaralkyl, provided that R¹ and R² are not both H; or R¹ and R² together form a substituted or unsubstituted ring with the nitrogen atom to which they are attached, wherein the ring may further incorporate one or more O, N, or S atoms, and R⁵ is individually H, substituted or unsubstituted alkyl, substituted or unsubstituted aryl, substituted or unsubstituted cycloalkyl, substituted or unsubstituted heterocycloalkyl, substituted or unsubstituted heteroaryl, or substituted or unsubstituted alkoxy. In some embodiments, the predetermined length of time is from about 12 hours to about 72 hours.

Provided in one aspect is a process of forming a 1,1-aminoborane, the process including contacting for a predetermined length of time a mixture comprising an amine, an aldehyde, bis(pinacolato)diboron (B₂Pin₂), and a copper catalyst in a solvent to form the 1,1-aminoborane.

In some embodiments, the amine is a compound of formula NR⁶R⁷R⁸, where R⁶ is H or Si(R⁹)₃; R⁷ and R⁸ are independently selected from H, substituted or unsubstituted alkyl, substituted or unsubstituted alkenyl, substituted or unsubstituted alkynyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroaralkyl, provided that R⁷ and R⁸ are not both H; or R⁷ and R⁸ together form a substituted or unsubstituted ring with the nitrogen atom to which they are attached, wherein the ring may further incorporate one or more O, N, or S atoms; and each R⁹ is independently substituted or unsubstituted alkyl, substituted or unsubstituted aryl, substituted or unsubstituted cycloalkyl, substituted or unsubstituted heterocycloalkyl, substituted or unsubstituted heteroaryl, or substituted or unsubstituted alkoxy.

In some embodiments, R⁷ and R⁸ are independently selected from H, substituted or unsubstituted alkyl, substituted or unsubstituted alkenyl, substituted or unsubstituted alkynyl, substituted or unsubstituted cycloalkyl, substituted or unsubstituted aryl, substituted or unsubstituted heteroaryl, substituted or unsubstituted aralkyl, or substituted or unsubstituted heteroaralkyl, provided that R⁷ and R⁸ are not both H.

In some embodiments, R⁷ and R⁸ together form a substituted or unsubstituted ring with the nitrogen atom to which they are attached, wherein the ring may further incorporate one or more O, N, or S atoms.

In some embodiments, the aldehyde is a compound of formula R¹⁰C(O)H, wherein R¹⁰ is substituted or unsubstituted alkyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroalkyl.

In some embodiments, the copper catalyst is CuX(IPr), wherein IPr is a 1-(2,6-diisopropylphenyl)-1H-imidazole group, and X is F, Cl, Br, triflate, or other suitable anion. In some embodiments, the copper catalyst is CuX(^{Et}CAA₅) or CuX(^{iPr}BICAAC), and X is F, Cl, Br, triflate, or other suitable anion.

In some embodiments, the 1,1-aminoborane described herein is a compound of formula:

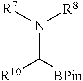

where R¹⁰ is substituted or unsubstituted alkyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroalkyl; R⁷ and R⁸ are independently selected from H, substituted or unsubstituted alkyl, substituted or unsubstituted alkenyl, substituted or unsubstituted alkynyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroaralkyl, provided that R⁷ and R⁸ are not both H; or R⁷ and R⁸ together form a substituted or unsubstituted ring with the nitrogen atom to which they are attached, wherein the ring may further incorporate one or more O, N, or S atoms. In some embodiments, the predetermined length of time is from about 12 hours to about 72 hours.

### BRIEF DESCRIPTION OF THE DRAWINGS

FIGS. 1A, 1B, and 1C include listings of products of the aminosilylation reaction on a 0.5 mmol scale, illustrating the scope and variability of the functional groups, according to the Examples. All yields given are of isolated products. b. 80° C., 72 h. c. PhO-BPin (10 mol %), 80° C., 24 h. d. CuCl (10 mol %) instead of Cat1, 80° C., 72 h.

FIG. 2 is a listing of FDA approved drugs, and their precursors, used as reagents for 1,1-aminosilylation, according to the Examples. Isolated yields are provided.

FIG. 3 shows the robustness screen of functional group tolerance, according to the Examples and testing. Yields correspond to GC yields of product calibrated against mesitylene as internal standard. Yields in parentheses are of residual additive. Yields in brackets are of product after 48 hours for selected additives.

FIGS. 4A, 4B, 4C, and 4D include listings of products of the aminoboration reaction on a 0.5 mmol scale, illustrating the scope and variability of the functional groups, according to the Examples. All yields given are of isolated products.

FIG. 5 shows several larger scale reactions to prepare aryl derived 1,1-aminoboranes and primary amine derived 1,1-aminoboranes salts, according to the Examples (such as those described in Example 4). Isolated yields are provided.

FIG. 6 shows the post-synthetic diversification of the described 1,1-aminoborane products.

FIG. 7 shows the utility of the 1,1-aminoboronation reaction described herein for the preparation of bortezomib and novel derivatives.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, alkenyl, alkynyl, aryl, aryloxy, aralkyloxy, heteroaryl, heterocyclyloxy, heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

The term “alkenyl” refers to a type of alkyl group in which at least one carbon-carbon double bond is present. In one embodiment, an alkenyl group has the formula —C(R)═CR₂, wherein R refers to the remaining portions of the alkenyl group, which may be the same or different. In some embodiments, R is H or an alkyl. In some embodiments, an alkenyl is selected from ethenyl (i.e., vinyl), propenyl (i.e., allyl), butenyl, pentenyl, pentadienyl, and the like. Non-limiting examples of an alkenyl group include —CH═CH₂, —C(CH₃)═CH₂, —CH═CHCH₃, —C(CH₃)—CHCH₃, and —CH₂CH═CH₂.

The term “alkynyl” refers to a type of alkyl group in which at least one carbon-carbon triple bond is present. In one embodiment, an alkenyl group has the formula —C≡C—R, wherein R refers to the remaining portions of the alkynyl group. In some embodiments, R is H or an alkyl. In some embodiments, an alkynyl is selected from ethynyl, propynyl, butynyl, pentynyl, hexynyl, and the like. Non-limiting examples of an alkynyl group include —C≡CH, —C≡CCH₃—C≡CCH₂CH₃, —CH₂C≡CH.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups. In some embodiments, cycloalkyl groups are selected from among cyclopropyl, cyclobutyl, cyclopentyl, cyclopentenyl, cyclohexyl, cyclohexenyl, cycloheptyl, cyclooctyl,

Cycloalkylalkyl groups are alkyl groups as defined above in which a hydrogen or carbon bond of an alkyl group is replaced with a bond to a cycloalkyl group as defined above. Cycloalkylalkyl groups may be substituted or unsubstituted. In some embodiments, cycloalkylalkyl groups have from 4 to 16 carbon atoms, 4 to 12 carbon atoms, and typically 4 to 10 carbon atoms. Substituted cycloalkylalkyl groups may be substituted at the alkyl, the cycloalkyl or both the alkyl and cycloalkyl portions of the group. Representative substituted cycloalkylalkyl groups may be mono-substituted or substituted more than once, such as, but not limited to, mono-substituted, di-substituted, or tri-substituted with substituents such as those listed above.

Aryl groups are cyclic aromatic hydrocarbons that do not contain heteroatoms. Aryl groups herein include monocyclic, bicyclic, and tricyclic ring systems. Aryl groups may be substituted or unsubstituted. Thus, aryl groups include, but are not limited to, phenyl, azulenyl, heptalenyl, biphenyl, fluorenyl, phenanthrenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. In some embodiments, the aryl groups are phenyl or naphthyl. The phrase “aryl groups” includes groups containing fused rings, such as fused aromatic-aliphatic ring systems (e.g., indanyl, tetrahydronaphthyl, and the like). Aryl groups may be substituted or unsubstituted. Representative substituted aryl groups may be mono-substituted (e.g., tolyl) or substituted more than once. For example, monosubstituted aryl groups include, but are not limited to, 2-, 3-, 4-, 5-, or 6-substituted phenyl or naphthyl groups, which may be substituted with substituents such as those listed above.

Aralkyl groups are alkyl groups as defined above in which a hydrogen or carbon bond of an alkyl group is replaced with a bond to an aryl group as defined above. Aralkyl groups may be substituted or unsubstituted. In some embodiments, aralkyl groups contain 7 to 16 carbon atoms, 7 to 14 carbon atoms, or 7 to 10 carbon atoms. Substituted aralkyl groups may be substituted at the alkyl, the aryl or both the alkyl and aryl portions of the group. Representative aralkyl groups include but are not limited to benzyl and phenethyl groups and fused (cycloalkylaryl)alkyl groups such as 4-indanylethyl. Representative substituted aralkyl groups may be substituted one or more times with substituents such as those listed above.

Heterocyclyl groups include aromatic (also referred to as heteroaryl) and non-aromatic ring compounds containing 3 or more ring members, of which one or more is a heteroatom such as, but not limited to, N, O, and S (also referred to as heterocycloalkyl). Heterocyclyl groups may be substituted or unsubstituted. In some embodiments, the heterocyclyl group contains 1, 2, 3 or 4 heteroatoms. In some embodiments, heterocyclyl groups include mono-, bi- and tricyclic rings having 3 to 16 ring members, whereas other such groups have 3 to 6, 3 to 10, 3 to 12, or 3 to 14 ring members. Heterocyclyl groups encompass aromatic, partially unsaturated, and saturated ring systems, such as, for example, imidazolyl, imidazolinyl and imidazolidinyl groups. The phrase “heterocyclyl group” includes fused ring species including those comprising fused aromatic and non-aromatic groups, such as, for example, benzotriazolyl, 2,3-dihydrobenzo[1,4]dioxinyl, and benzo[1,3]dioxolyl. The phrase also includes bridged polycyclic ring systems containing a heteroatom such as, but not limited to, quinuclidyl. The phrase includes heterocyclyl groups that have other groups, such as alkyl, oxo or halo groups, bonded to one of the ring members, referred to as “substituted heterocyclyl groups.” Heterocycloalkyls include rings having 3 to 10 atoms in its ring system and aromatic heterocyclic groups include rings having 5 to 10 atoms in its ring system. Examples of non-aromatic heterocyclic groups are pyrrolidinyl, tetrahydrofuranyl, dihydrofuranyl, tetrahydrothienyl, oxazolidinonyl, tetrahydropyranyl, dihydropyranyl, tetrahydrothiopyranyl, piperidinyl, morpholinyl, thiomorpholinyl, thioxanyl, piperazinyl, aziridinyl, azetidinyl, oxetanyl, thietanyl, homopiperidinyl, oxepanyl, thiepanyl, oxazepinyl, diazepinyl, thiazepinyl, 1,2,3,6-tetrahydropyridinyl, pyrrolin-2-yl, pyrrolin-3-yl, indolinyl, 2H-pyranyl, 4H-pyranyl, dioxanyl, 1,3-dioxolanyl, pyrazolinyl, dithianyl, dithiolanyl, dihydropyranyl, dihydrothienyl, dihydrofuranyl, pyrazolidinyl, imidazolinyl, imidazolidinyl, 3-azabicyclo[3.1.0]hexanyl, 3-azabicyclo[4.1.0]heptanyl, 3H-indolyl, indolin-2-onyl, isoindolin-1-onyl, isoindoline-1,3-dionyl, 3,4-dihydroisoquinolin-1(2H)-onyl, 3,4-dihydroquinolin-2(1H)-onyl, isoindoline-1,3-dithionyl, benzo[d]oxazol-2(3H)-onyl, 1H-benzo[d]imidazol-2(3H)-onyl, benzo[d]thiazol-2(3H)-onyl, and quinolizinyl. Examples of aromatic heterocyclic groups are pyridinyl, imidazolyl, pyrimidinyl, pyrazolyl, triazolyl, pyrazinyl, tetrazolyl, furyl, thienyl, isoxazolyl, thiazolyl, oxazolyl, isothiazolyl, pyrrolyl, quinolinyl, isoquinolinyl, indolyl, benzimidazolyl, benzofuranyl, cinnolinyl, indazolyl, indolizinyl, phthalazinyl, pyridazinyl, triazinyl, isoindolyl, pteridinyl, purinyl, oxadiazolyl, thiadiazolyl, furazanyl, benzofurazanyl, benzothiophenyl, benzothiazolyl, benzoxazolyl, quinazolinyl, quinoxalinyl, naphthyridinyl, and furopyridinyl. The foregoing groups are either C-attached (or C-linked) or N-attached where such is possible. For instance, a group derived from pyrrole includes both pyrrol-1-yl (N-attached) or pyrrol-3-yl (C-attached). Further, a group derived from imidazole includes imidazol-1-yl or imidazol-3-yl (both N-attached) or imidazol-2-yl, imidazol-4-yl or imidazol-5-yl (all C-attached). Representative substituted heterocyclyl groups may be mono-substituted or substituted more than once, such as, but not limited to, morpholinyl groups, which are 2-, 3-, 4-, 5-, or 6-substituted, or disubstituted with various substituents such as those listed above.

Heteroaryl groups are aromatic ring compounds containing 5 or more ring members, of which, one or more is a heteroatom such as, but not limited to, N, O, and S. Heteroaryl groups may be substituted or unsubstituted. Heteroaryl groups include, but are not limited to, groups such as pyrrolyl, pyrazolyl, triazolyl, tetrazolyl, oxazolyl, isoxazolyl, thiazolyl, pyridinyl, pyridazinyl, pyrimidinyl, pyrazinyl, thiophenyl, benzothiophenyl, furanyl, benzofuranyl, indolyl, azaindolyl (pyrrolopyridinyl), indazolyl, benzimidazolyl, imidazopyridinyl (azabenzimidazolyl), pyrazolopyridinyl, triazolopyridinyl, benzotriazolyl, benzoxazolyl, benzothiazolyl, benzothiadiazolyl, imidazopyridinyl, isoxazolopyridinyl, thianaphthyl, purinyl, xanthinyl, adeninyl, guaninyl, quinolinyl, isoquinolinyl, tetrahydroquinolinyl, quinoxalinyl, and quinazolinyl groups. Heteroaryl groups include fused ring compounds in which all rings are aromatic such as indolyl groups and include fused ring compounds in which only one of the rings is aromatic, such as 2,3-dihydro indolyl groups. Representative substituted heteroaryl groups may be substituted one or more times with various substituents such as those listed above.

The term “heteroalkyl” refers to an alkyl group in which one or more skeletal atoms of the alkyl are selected from an atom other than carbon, e.g., oxygen, nitrogen (e.g. —NH—, —N (alkyl)-, sulfur, or combinations thereof. A heteroalkyl is attached to the rest of the molecule at a carbon atom of the heteroalkyl.

Heteroaralkyl groups are alkyl groups as defined above in which a hydrogen or carbon bond of an alkyl group is replaced with a bond to a heteroaryl group as defined above. Heteroaralkyl groups may be substituted or unsubstituted. Substituted heteroaralkyl groups may be substituted at the alkyl, the heteroaryl or both the alkyl and heteroaryl portions of the group. Representative substituted heteroaralkyl groups may be substituted one or more times with substituents such as those listed above.

Groups described herein having two or more points of attachment (i.e., divalent, trivalent, or polyvalent) within the compound of the present technology are designated by use of the suffix, “ene.” For example, divalent alkyl groups are alkylene groups, divalent aryl groups are arylene groups, divalent heteroaryl groups are divalent heteroarylene groups, and so forth. Substituted groups having a single point of attachment to the compound of the present technology are not referred to using the “ene” designation. Thus, e.g., chloroethyl is not referred to herein as chloroethylene.

Alkoxy groups are hydroxyl groups (—OH) in which the bond to the hydrogen atom is replaced by a bond to a carbon atom of a substituted or unsubstituted alkyl group as defined above. Alkoxy groups may be substituted or unsubstituted. Examples of linear alkoxy groups include but are not limited to methoxy, ethoxy, propoxy, butoxy, pentoxy, hexoxy, and the like. Examples of branched alkoxy groups include but are not limited to isopropoxy, sec-butoxy, tert-butoxy, isopentoxy, isohexoxy, and the like. Examples of cycloalkoxy groups include but are not limited to cyclopropyloxy, cyclobutyloxy, cyclopentyloxy, cyclohexyloxy, and the like. Representative substituted alkoxy groups may be substituted one or more times with substituents such as those listed above.

The term “carboxylate” as used herein refers to a —COOH group.

The term “ester” as used herein refers to —COOR^{a} and —C(O)O-G groups. R^{a} is a substituted or unsubstituted alkyl, cycloalkyl, alkenyl, alkynyl, aryl, aralkyl, heterocyclylalkyl or heterocyclyl group as defined herein. G is a carboxylate protecting group. Carboxylate protecting groups are well known to one of ordinary skill in the art. An extensive list of protecting groups for the carboxylate group functionality may be found in Protective Groups in Organic Synthesis, Greene, T. W.; Wuts, P. G. M., John Wiley & Sons, New York, NY, (3rd Edition, 1999) which can be added or removed using the procedures set forth therein and which is hereby incorporated by reference in its entirety and for any and all purposes as if fully set forth herein.

The term “amide” (or “amido”) includes C- and N-amide groups, i.e., —C(O)NR^{b}R^{c}, and —NR^{b}C(O)R^{c} groups, respectively. R^{b} and R^{c} are independently hydrogen, or a substituted or unsubstituted alkyl, cycloalkyl, aryl, heterocycloalkyl, heteroaryl, aralkyl, or heteroaralkyl as defined herein. Amido groups therefore include but are not limited to carbamoyl groups (—C(O)NH₂) and formamide groups (—NHC(O)H). In some embodiments, the amide is —NRDC(O)—(C1-5 alkyl) and the group is termed “carbonylamino.”

The term “amine” (or “amino”) as used herein refers to —NR^{d}R^{e} groups, wherein R^{d} and R^{e} are independently hydrogen, or a substituted or unsubstituted alkyl, cycloalkyl, aryl, heterocycloalkyl, heteroaryl, aralkyl, or heteroaralkyl as defined herein. In some embodiments, Rd and Re together form a substituted or unsubstituted ring with the nitrogen atom to which they are attached, wherein the ring may further incorporate one or more O, N, or S atoms, such as heterocycloalkyl as described here. In some embodiments, the amine is alkylamino, dialkylamino, arylamino, or alkylarylamino. In other embodiments, the amine is NH₂, methylamino, dimethylamino, ethylamino, diethylamino, propylamino, isopropylamino, phenylamino, or benzylamino.

The term “halogen” or “halo” as used herein refers to bromine, chlorine, fluorine, or iodine. In some embodiments, the halogen is fluorine. In other embodiments, the halogen is chlorine or bromine.

The term “hydroxyl” as used herein can refer to —OH or its ionized form, —O—. A “hydroxyalkyl” group is a hydroxyl-substituted alkyl group, such as HO—CH₂—.

Disclosed herein are the preparation of geminal aminosilanes and aminoboranes using a copper-catalyzed, multicomponent reaction system.

### 1,1-Aminosilylation

Geminal aminosilanes are valuable reagents in radical and polar processes and show potential as potent silicon-based drug candidates. Herein, a Cu-catalyzed multicomponent reaction is disclosed for the direct synthesis of 1,1-aminosilanes from simple feedstock chemicals, providing a robust, cost-effective, operationally simple, and scalable alternative with broad functional group tolerance and exceptional yields is disclosed. This reaction is compatible with both aliphatic and aromatic aldehydes, primary and secondary amines, and can be applied to FDA approved drugs and their precursors, unlocking new opportunities in pharmaceutical and materials science. Beyond its synthetic utility, this approach delivers bottleable 1,1-aminosilanes that serve as powerful reagents in post-functionalization strategies. This disclosure establishes a new paradigm in aminosilylation chemistry, paving the way for next-generation therapeutics and functional materials.

Provided in one aspect is a process of forming a 1,1-aminosilane, the process comprising contacting for a predetermined length of time a mixture comprising an amine, an aldehyde, a sila-borane, and a copper catalyst in a solvent to form the 1,1-aminosilane.

The amine may be a primary or secondary amine. In some embodiments, the amine is a compound of formula NHR¹R², wherein: R¹ and R² are independently selected from H, substituted or unsubstituted alkyl, substituted or unsubstituted alkenyl, substituted or unsubstituted alkynyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroaralkyl, provided that R¹ and R² are not both H; or R¹ and R² together form a substituted or unsubstituted ring with the nitrogen atom to which they are attached, wherein the ring may further incorporate one or more O, N, or S atoms.

In some embodiments, R¹ and R² are independently selected from H, substituted or unsubstituted alkyl, substituted or unsubstituted alkenyl, substituted or unsubstituted alkynyl, substituted or unsubstituted cycloalkyl, substituted or unsubstituted aryl, substituted or unsubstituted heteroaryl, substituted or unsubstituted aralkyl, or substituted or unsubstituted heteroaralkyl, provided that R¹ and R² are not both H. In some embodiments, R¹ and R² are each independently H, substituted or unsubstituted alkyl, substituted or unsubstituted cycloalkyl, or substituted or unsubstituted aralkyl, provided that that R¹ and R² are not both H. In some embodiments, R¹ and R² are each independently H, propyl, pentyl, hexyl, cyclohexyl, or benzyl, provided that R¹ and R² are not both H.

In some embodiments, R¹ and R² together form a substituted or unsubstituted ring with the nitrogen atom to which they are attached, wherein the ring may further incorporate one or more O, N, or S atoms. In some embodiments, R¹ and R² together form a substituted or unsubstituted morpholinyl, substituted or unsubstituted thiomorpholinyl, substituted or unsubstituted aziridinyl, substituted or unsubstituted azetidinyl, substituted or unsubstituted pyrrolidinyl, substituted or unsubstituted piperidinyl, substituted or unsubstituted piperazinyl, and substituted or unsubstituted azepinyl.

The aldehyde may be an aliphatic or an aromatic aldehyde. In some embodiments, the aldehyde is a compound of formula R³C(O)H, wherein R³ is substituted or unsubstituted alkyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroalkyl.

In some embodiments, R³ is —CH₂CH₂Ph, iso-butyl, substituted or unsubstituted cyclopropyl, substituted or unsubstituted cyclohexyl, tert-butyl, substituted or unsubstituted phenyl, substituted or unsubstituted furanyl, substituted or unsubstituted thienyl, substituted or unsubstituted pyrrolyl, substituted or unsubstituted oxazolyl, substituted or unsubstituted thiazolyl, substituted or unsubstituted imidazolyl, substituted or unsubstituted pyrazolyl, or substituted or unsubstituted indolyl.

The sila-borane may be triethylsilylpinacolborane. In some embodiments, the sila-borane is a compound of formula:

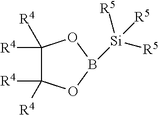

In the above sila-borane structure, each R⁴ is individually H, substituted or unsubstituted alkyl, or substituted or unsubstituted aryl; and each R⁵ is individually H, substituted or unsubstituted alkyl, substituted or unsubstituted aryl, substituted or unsubstituted cycloalkyl, substituted or unsubstituted heterocycloalkyl, substituted or unsubstituted heteroaryl, or substituted or unsubstituted alkoxy.

In some embodiments, each R⁴ is individually substituted or unsubstituted alkyl and each R⁵ is individually substituted or unsubstituted alkyl. In some embodiments, each R⁴ is individually methyl or ethyl, and each R⁵ is individually methyl, ethyl, or propyl. In some embodiments, each R⁴ is individually methyl, and each R⁵ is individually ethyl.

The copper catalysts that may be employed herein are those comprising copper ligated to N-heterocyclic carbenes. Suitable examples include, but are not limited to, 1,3-bis(2,6-diisopropylphenyl)-2-imidazolidinylidene, 1,3-bis(2,6-diisopropylphenyl)-2-imidazolidinylidene, 1,3-bis(2,4,6-trimethylphenyl)imidazol-2-ylidene, and 1,3-bis(2,4,6-trimethylphenyl)-4,5-dihydro imidazol-2-ylidene. The structures of these are shown below:

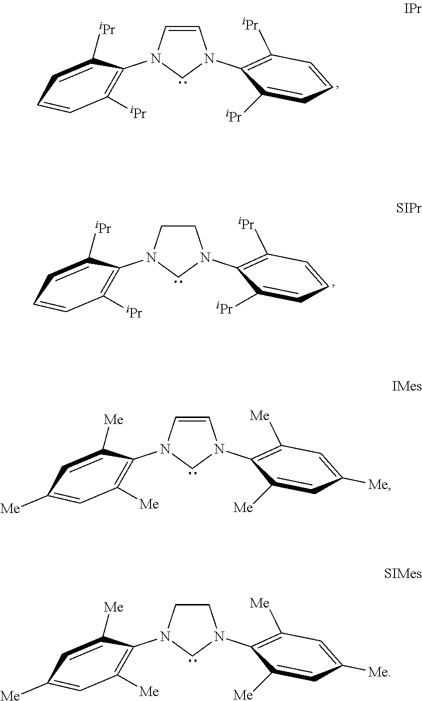

In some embodiments, the copper catalyst is CuX(IPr), wherein IPr is a 1-(2,6-diisopropylphenyl)-1H-imidazole group, and X is F, Cl, Br, triflate, or other suitable anion. In some embodiments, X is Cl or triflate. In some embodiments X is Cl. In some embodiments, X is triflate.

For the process described herein, the copper catalyst may be present in an amount of about 1 mol % to about 5 mol %, including about 1 mol %, about 1.5 mol %, about 2 mol %, about 2.5 mol %, about 3 mol %, about 3.5 mol %, about 4 mol %, about 4.5 mol %, and about 5 mol %. In some embodiments, the copper catalyst is present in amount of about 2.5 mol %.

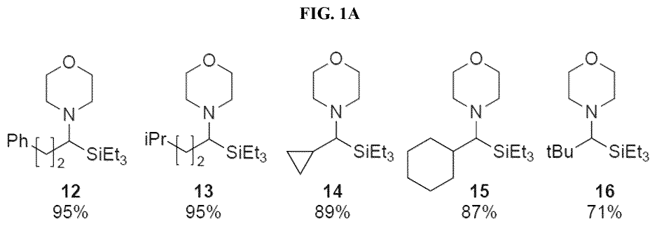

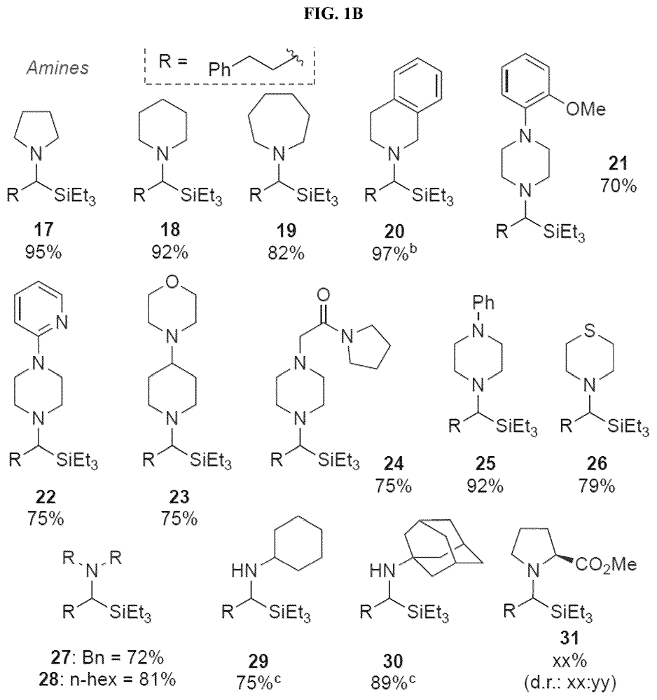

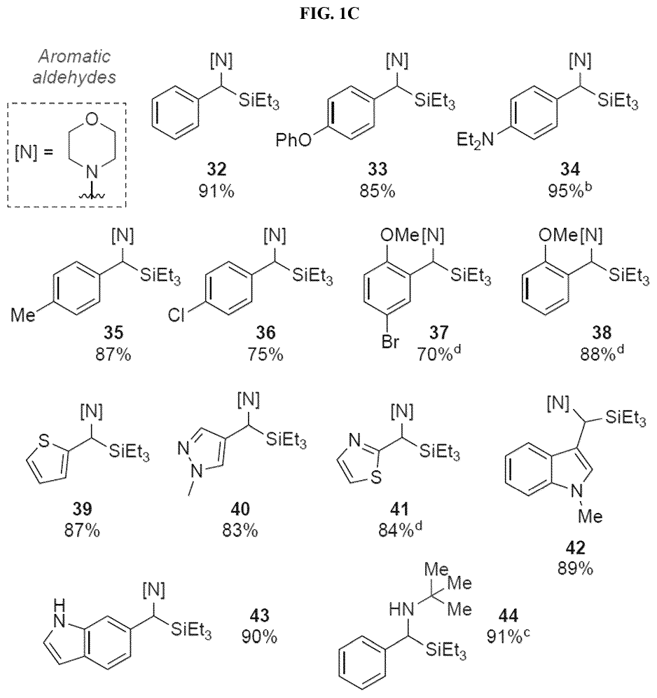

The 1,1-aminosilanes may be any one of the products of the aminosilylation reaction shown in FIGS. 1A, 1B, and 1C. In some embodiments, the 1,1-aminosilane described herein is a compound of formula:

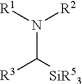

In the 1,1-aminosilane structure, R³ is substituted or unsubstituted alkyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroalkyl; R¹ and R² are independently selected from H, substituted or unsubstituted alkyl, substituted or unsubstituted alkenyl, substituted or unsubstituted alkynyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroaralkyl, provided that R¹ and R² are not both H; or R¹ and R² together form a substituted or unsubstituted ring with the nitrogen atom to which they are attached, wherein the ring may further incorporate one or more O, N, or S atoms, and R⁵ is individually H, substituted or unsubstituted alkyl, substituted or unsubstituted aryl, substituted or unsubstituted cycloalkyl, substituted or unsubstituted heterocycloalkyl, substituted or unsubstituted heteroaryl, or substituted or unsubstituted alkoxy, wherein specific embodiments for R¹, R², R³ and R⁵ include those as described above.

For the process described herein, the solvent may be acetonitrile or tetrahydrofuran. In some embodiments, the solvent is acetonitrile. In some embodiments, the solvent is tetrahydrofuran.

The solvent may be present in a concentration of from about 0.1 molar to about 0.4 molar, including about 0.1 molar, about 0.15 molar, about 0.2 molar, about 0.25 molar, about 0.3 molar, about 0.35 molar, and about 0.4 molar. In some embodiments, the solvent is present in a concentration of about 0.2 molar.

The predetermined length of time may be about 12 h to about 72 h, including about 12 h, about 18 h, about 24 h, about 30 h, about 36 h, about 42 h, about 48 h, about 54 h, about 60 h, about 66 h, and about 72 h. In some embodiments, the predetermined length of time is 16 h.

For the process described herein, the contacting step is conducted at a temperature of about 30° C. to about 80° C., including about 30° C., about 35° C., about 40° C., about 45° C., about 50° C., about 55° C., about 60° C., about 65° C., about 70° C., about 75° C., about 80° C. In some embodiments, the contacting step is conducted at a temperature of about 40° C. Also, in some embodiments, the contacting step may be conducted under nitrogen atmosphere.

For the process described herein, the amine and the sila-borane are present in a molar ratio of about 1:1.1. In some embodiments, the aldehyde and the sila-borane are present in a molar ratio of about 1:1.1 to about 8:1.1, including about 1:1.1. In some embodiments, the amine and aldehyde are present in a molar ratio of 1:1.

As shown in the Examples, the catalytic additive may be included in the mixture to improve the yield of the 1,1-aminosilane product, especially if the amine is a primary amine. In some embodiments, the catalytic additive is an aryl pinacol borate, such as PhO-BPin. The catalytic additive may be present in an amount of about 10 mol %, about 20 mol %, or about 50 mol %. The catalytic additive may be present in an amount of about 10 mol % or about 20 mol %.

Also provided in another aspect is an 1,1-aminosilanes selected from any one of the products of the aminosilylation reaction shown in FIGS. 1A, 1B, and 1C.

### 1,1-Aminoborylation

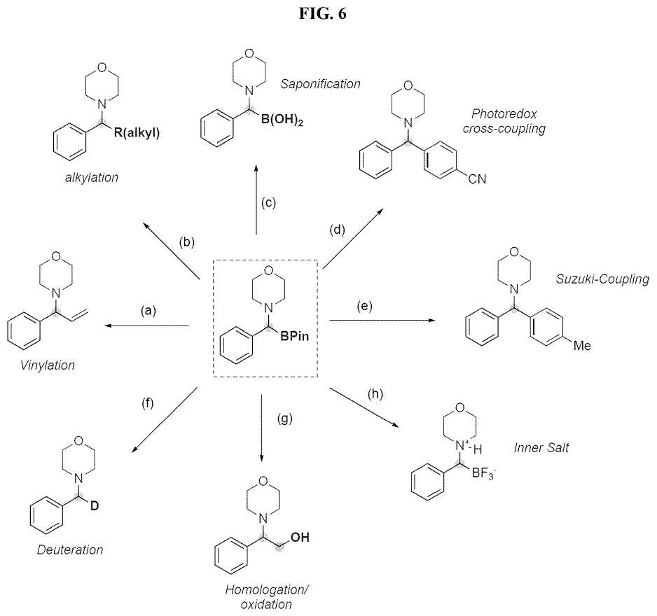

Also disclosed is a Cu-catalyzed multicomponent reaction for the direct synthesis of 1,1-aminoboranes. This robust, cost-effective, and scalable method exhibits broad functional-group tolerance, works with aliphatic and aromatic aldehydes and primary and secondary amines (including FDA-approved drugs and their precursors), and provides bottleable 1,1-aminoboranes that serve as versatile reagents for post-functionalization (see FIG. 6).

Provided in one aspect is a process of forming a 1,1-aminoborane, the process comprising contacting for a predetermined length of time a mixture comprising an amine, an aldehyde, bis(pinacolato)diboron (B₂Pin₂), and a copper catalyst in a solvent to form the 1,1-aminoborane.

The amine may be a primary or secondary amine. In some embodiments, the amine is a compound of formula NR⁶R⁷R⁸, wherein: R⁶ is H or Si(R⁹)₃; R⁷ and R⁸ are independently selected from H, substituted or unsubstituted alkyl, substituted or unsubstituted alkenyl, substituted or unsubstituted alkynyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroaralkyl, provided that R⁷ and R⁸ are not both H; or R⁷ and R⁸ together form a substituted or unsubstituted ring with the nitrogen atom to which they are attached, wherein the ring may further incorporate one or more O, N, or S atoms; and each R⁹ is independently substituted or unsubstituted alkyl, substituted or unsubstituted aryl, substituted or unsubstituted cycloalkyl, substituted or unsubstituted heterocycloalkyl, substituted or unsubstituted heteroaryl, or substituted or unsubstituted alkoxy.

In some embodiments, R⁷ and R⁸ are independently selected from H, substituted or unsubstituted alkyl, substituted or unsubstituted alkenyl, substituted or unsubstituted alkynyl, substituted or unsubstituted cycloalkyl, substituted or unsubstituted aryl, substituted or unsubstituted heteroaryl, substituted or unsubstituted aralkyl, or substituted or unsubstituted heteroaralkyl, provided that R⁷ and R⁸ are not both H. In some embodiments, R⁷ and R⁸ are each independently H, substituted or unsubstituted alkyl, substituted or unsubstituted cycloalkyl, or substituted or unsubstituted aralkyl, provided that that R⁷ and R⁸ are not both H. In some embodiments, R⁷ and R⁸ are each independently H, propyl, pentyl, hexyl, cyclohexyl, or benzyl, provided that R⁷ and R⁸ are not both H.

In some embodiments, R⁷ and R⁸ together form a substituted or unsubstituted ring with the nitrogen atom to which they are attached, wherein the ring may further incorporate one or more O, N, or S atoms. In some embodiments, R⁷ and R⁸ together form a substituted or unsubstituted morpholinyl, substituted or unsubstituted thiomorpholinyl, substituted or unsubstituted aziridinyl, substituted or unsubstituted azetidinyl, substituted or unsubstituted pyrrolidinyl, substituted or unsubstituted piperidinyl, substituted or unsubstituted piperazinyl, and substituted or unsubstituted azepinyl.

In some embodiments, each R⁹ is independently substituted or unsubstituted alkyl. In some embodiments, each R⁹ is independently methyl. In some embodiments, each R⁹ is independently ethyl. In some embodiments, each R⁹ is independently substituted or unsubstituted aryl. In some embodiments, each R⁹ is independently substituted or unsubstituted cycloalkyl. In some embodiments, each R⁹ is independently substituted or unsubstituted heterocycloalkyl. In some embodiments, each R⁹ is independently substituted or unsubstituted heteroaryl. In some embodiments, each R⁹ is independently or substituted or unsubstituted alkoxy.

The aldehyde may be an aliphatic or an aromatic aldehyde. In some embodiments, the aldehyde is a compound of formula R¹⁰C(O)H, wherein R¹⁰ is substituted or unsubstituted alkyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroalkyl.

In some embodiments, R¹⁰ is —CH₂CH₂Ph, iso-butyl, substituted or unsubstituted cyclopropyl, substituted or unsubstituted cyclohexyl, tert-butyl, substituted or unsubstituted phenyl, substituted or unsubstituted furanyl, substituted or unsubstituted thienyl, substituted or unsubstituted pyrrolyl, substituted or unsubstituted oxazolyl, substituted or unsubstituted thiazolyl, substituted or unsubstituted imidazolyl, substituted or unsubstituted pyrazolyl, or substituted or unsubstituted indolyl.

The copper catalysts that may be employed herein are those comprising copper ligated to N-heterocyclic carbenes. Suitable examples include, but are not limited to, 1,3-bis(2,6-diisopropylphenyl)-2-imidazolidinylidene, 1,3-bis(2,6-diisopropylphenyl)-2-imidazolidinylidene, 1,3-bis(2,4,6-trimethylphenyl)imidazol-2-ylidene, 1,3-Bis(2,4,6-trimethylphenyl)-4,5-dihydroimidazol-2-ylidene. The structures of these are shown below:

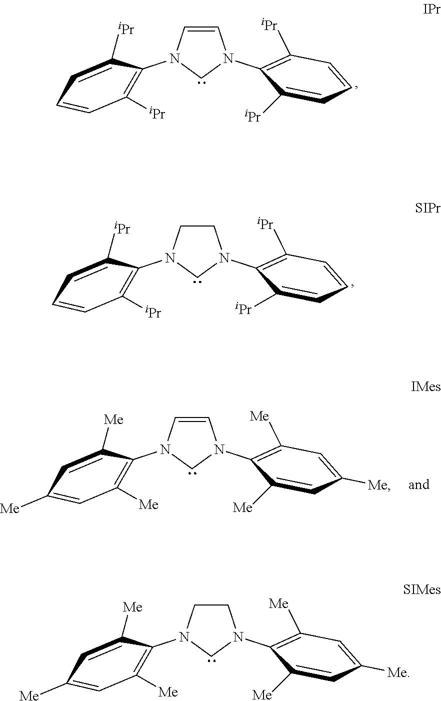

In some embodiments, the copper catalyst is CuX(IPr), wherein IPr is a 1-(2,6-diisopropylphenyl)-1H-imidazole group, and X is F, Cl, Br, triflate, or other suitable anion. In some embodiments, X is Cl or triflate. In some embodiments X is Cl. In some embodiments, X is triflate.

Other copper catalysts that may be employed herein are those comprising copper ligated to cyclic(alkyl)(amino)carbenes (CAACs). Examples of suitable CAACs include but are not limited to:

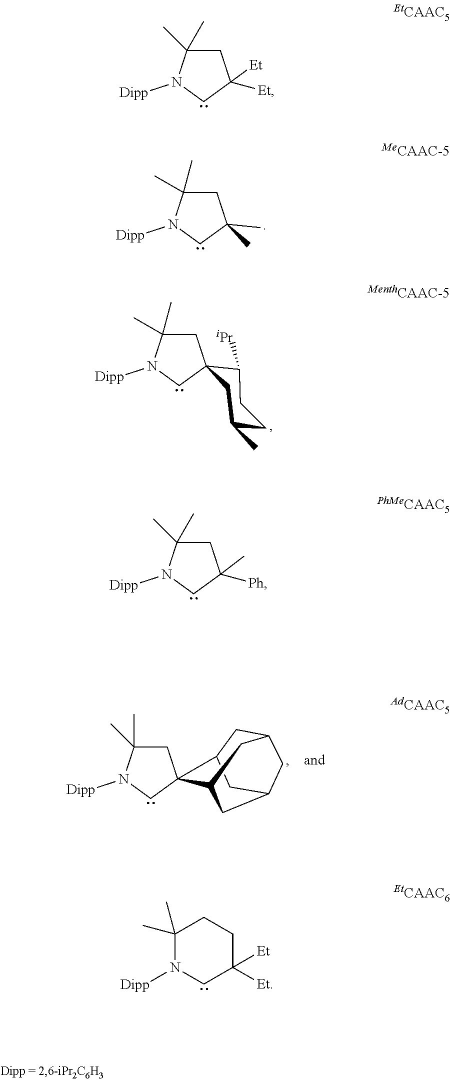

In some embodiments, the copper catalyst is CuX(^{Et}CAA₅), and X is F, Cl, Br, triflate, or other suitable anion. In some embodiments, X is Cl or triflate. In some embodiments X is Cl. In some embodiments, X is triflate.

Other copper catalysts that may be employed herein are those comprising copper ligated to bicyclic(alkyl)(amino)carbenes (BiCAACs). Examples of suitable BiCAACs include but are not limited to:

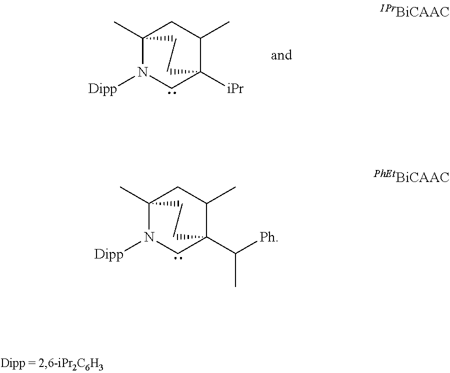

In some embodiments, the copper catalyst is CuX(^{iPr}BiCAAC), and X is F, Cl, Br, triflate, or other suitable anion. In some embodiments, X is Cl or triflate. In some embodiments X is Cl. In some embodiments, X is triflate.

For the process described herein, the copper catalyst may be present in an amount of about 0.01 mol % to about 5 mol %, including about 0.01 mol %, about 0.05 mol %, about 0.1 mol %, about 0.5 mol %, about 1 mol %, about 1.5 mol %, about 2 mol %, about 2.5 mol %, about 3 mol %, about 3.5 mol %, about 4 mol %, about 4.5 mol %, and about 5 mol %. In some embodiments, the copper catalyst is present in amount of about 1 mol % to about 5 mol %. In some embodiments, the copper catalyst is present in amount of about 2.5 mol %. In some embodiments, the copper catalyst is present in amount of about 5 mol %.

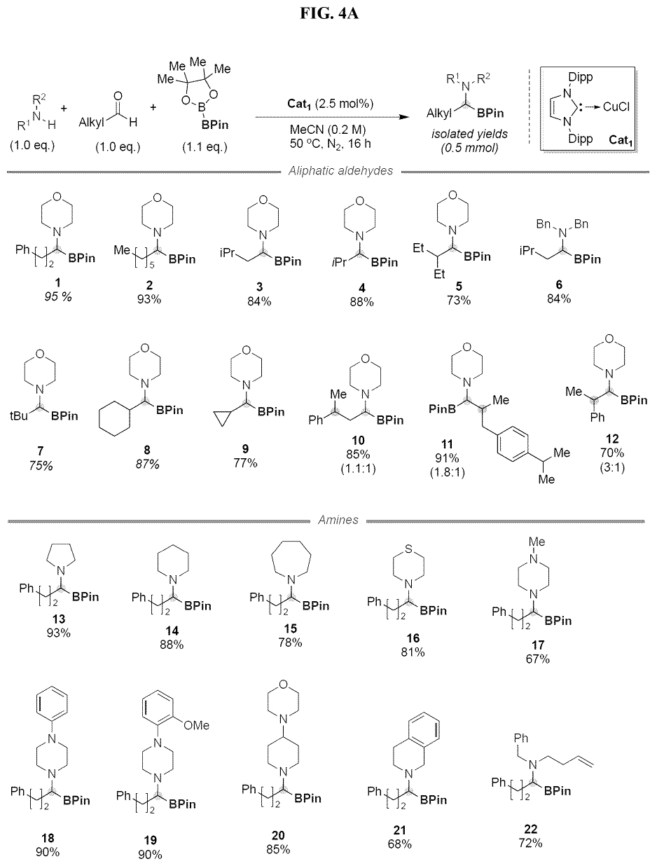

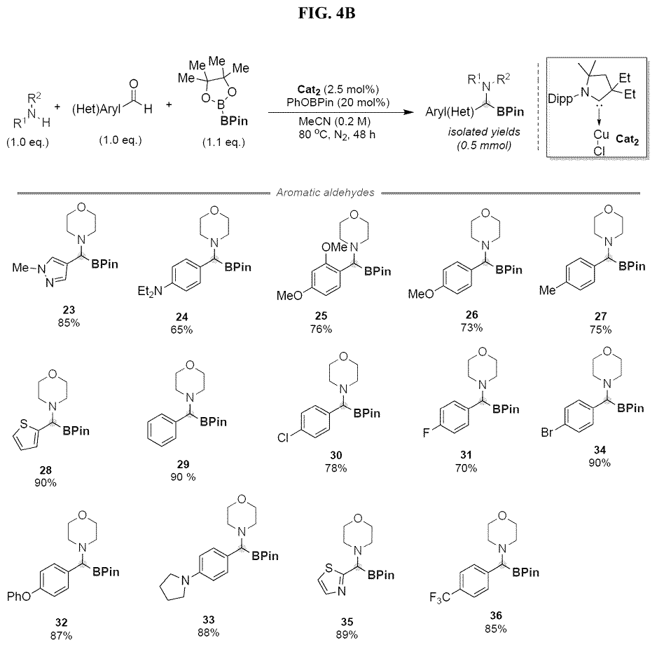

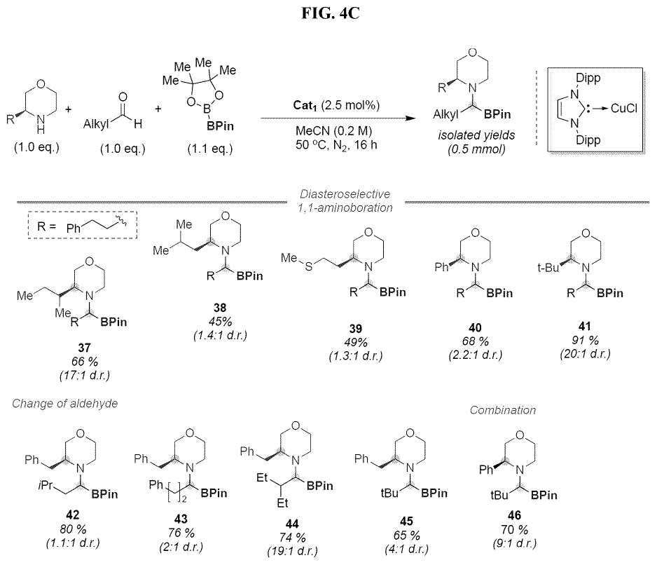

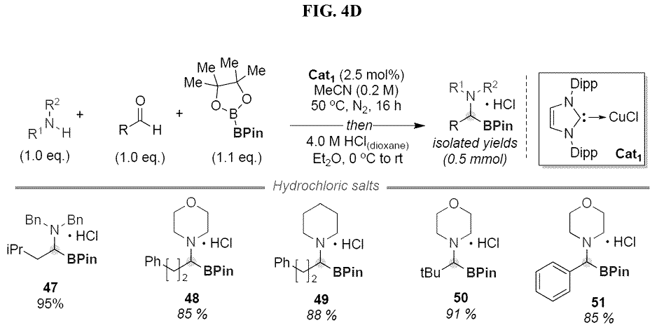

The 1,1-aminboranes may be any one of the products of the aminosilylation reaction shown in FIGS. 4A, 4B, 4C, and 4D. In some embodiments, the 1,1-aminoborane described herein is a compound of formula:

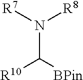

In the 1,1-aminoborane structure, R¹⁰ is substituted or unsubstituted alkyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroalkyl; R⁷ and R⁸ are independently selected from H, substituted or unsubstituted alkyl, substituted or unsubstituted alkenyl, substituted or unsubstituted alkynyl, substituted or unsubstituted cycloalkyl, substituted or unsubstituted aryl, substituted or unsubstituted heterocycloalkyl, substituted unsubstituted heteroaryl, substituted or unsubstituted aralkyl, or substituted or unsubstituted heteroaralkyl, provided that R⁷ and R⁸ are not both H; or R⁷ and R⁸ together form a substituted or unsubstituted ring with the nitrogen atom to which they are attached, wherein the ring may further incorporate one or more O, N, or S atoms, wherein specific embodiments for R⁷, R⁸, and R¹⁰ include those as described above.

Suitable solvents include, but are not limited to, dichloromethane, toluene, ether and acetonitrile. For the process described herein, the solvent may be acetonitrile or toluene. In some embodiments, the solvent is acetonitrile. In some embodiments, the solvent is toluene.

The solvent may be present in a concentration of from about 0.1 molar to about 0.4 molar, including about 0.1 molar, about 0.15 molar, about 0.2 molar, about 0.25 molar, about 0.3 molar, about 0.35 molar, and about 0.4 molar. In some embodiments, the solvent is present in a concentration of about 0.2 molar.

The predetermined length of time may be about 12 h to about 72 h, including about 12 h, about 18 h, about 24 h, about 30 h, about 36 h, about 42 h, about 48 h, about 54 h, about 60 h, about 66 h, and about 72 h. In some embodiments, the predetermined length of time is 16 h.

For the process described herein, the contacting step is conducted at a temperature of about 25° C. to about 85° C., including about 25° C., about 30° C., about 35° C., about 40° C., about 45° C., about 50° C., about 55° C., about 60° C., about 65° C., about 70° C., about 75° C., about 80° C., and about 85° C. In some embodiments, the contacting step is conducted at a temperature of about 50° C. to about 80° C. In some embodiments, the contacting step is conducted at a temperature of about 50° C. In some embodiments, the contacting step is conducted at a temperature of about 60° C. Also, in some embodiments, the contacting step may be conducted under nitrogen atmosphere.

For the process described herein, the amine and the B₂Pin₂ are present in a molar ratio of about 1:1.1. In some embodiments, the aldehyde and the B₂Pin₂ are present in a molar ratio of about 1:1.1 to about 8:1.1, including about 1:1.1. In some embodiments, the amine and aldehyde are present in a molar ratio of 1:1.

As shown in the Examples, the catalytic additive may be included in the mixture to improve the yield of the 1,1-aminoborane product, especially if the amine is a primary amine. In some embodiments, the catalytic additive is an aryl pinacol borate, such as PhO-BPin. The catalytic additive may be present in an amount of about 1 mol %, about 5 mol %, about 10 mol % or about 20 mol %. The catalytic additive may be present in an amount of about 10 mol % or about 20 mol %.

Also provided in another aspect is an 1,1-aminosilanes selected from any one f the products of the aminoboration reaction shown in FIGS. 4A, 4B, 4C, and 4D.

The present invention, thus generally described, will be understood more readily by reference to the following examples, which are provided by way of illustration and are not intended to be limiting of the present invention.

### EXAMPLES

### Discussion.

Medicinal drug design¹ and agrochemical discovery² rely heavily on N-containing groups while synthesis of hit compounds is benefitted by post-modifiable functions like boryl and silyl groups.³ Therefore, significant effort has been devoted to crafting new strategies to introduce these prized functional groups. Beyond the installation of each functional group independently, recent research has focused on the simultaneous introduction of amines and boryl or silyl groups onto a single organic molecule (i.e., aminoboration⁴ and aminosilylation,⁵ respectively). While aminosilylation is significantly less popular than aminoboration, it boasts notable benefits that underscore the need for further investigations. 1,1-aminosilanes are more shelf stable than 1,1-aminoboranes, thereby obviating the need for highly complex procedures to isolate them from reaction mixtures.⁶ Second, 1,1-aminosilanes exhibit analogous reactivity to geminal aminoboranes, making them bottleable substitutes for the latter in post-functionalization processes. Lastly, α-aminosilanes have unexpected pharmacological properties⁷ as more potent silicon-containing surrogates of inhibitors for angiotensin-converting enzyme (ACE)⁸ and human neutrophil elastase (HNE).⁹ These benefits highlight the need for increasing access to 1,1-aminosilanes from cheap, feedstock chemicals using earth-abundant transition-metal (TM) catalysts.

1,1-aminosilanes are available from a number routes as illustrated in Scheme 1. For example, nucleophilic reduction of pre-formed imines with silyl anion equivalents (Scheme 1, A) may be used to prepare α-aminosilanes.¹⁰ Alternatively, they may be prepared by hydroamination or silylation of vinyl silanes (3)₁₁ and enamides (4),¹² respectively (Scheme 1, B), or via deoxygenative hydrosilylation of benzamides (5) (Scheme 1, C).¹³ Activated C—H bonds adjacent to nitrogen (6 or 7) can also be silylated using Rh-/Ir-,¹⁴ Ru-,¹⁵ or Cu-based¹⁶ catalysts with hydrosilane reagents, albeit at high temperatures or using harsh chloramine reagents (Scheme 1, D). Lastly, other methods to prepare 1 include amidation of allyl silane C—H bonds,¹⁷ or by silylation of α-amino radicals.¹⁸ Taken together, moderate yields and modest substrate compatibility combined with highly reactive reagents, and the need for expensive noble-metal catalysts precludes the widespread deployment of these approaches.

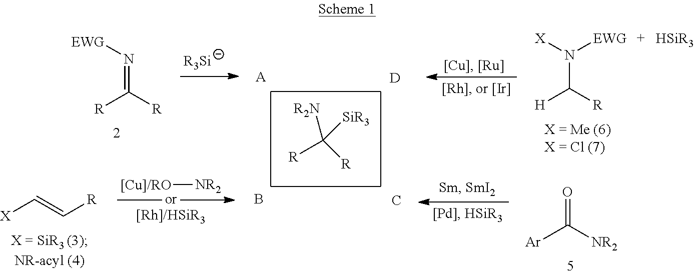

As an alternative to these non-desirable routes to 1,1-aminosilanes, reported here is a process for their preparation that utilizes multicomponent reactions (MCRs). In MCRs, assembly occurs via a cascade of elementary reaction steps governed by various microscopic equilibria ending in an irreversible termination event. While hundreds of MCRs are reported,²⁰ only one aminosilylation MCR was reported recently by Studer and coworkers using photoredox Ir-catalysis (see Scheme 1, D).⁵ While this approach is transformative, notable limitations such as expensive silyl radical precursors, noble metal catalysts, and the compatibility of only n-alkyl aldehydes limit broad reaching applications.

The present reaction mechanism capitalizes on the chemical equilibria associated with condensation reactions, the thermodynamic favorability of forming B—O bonds, and the kinetic benefit of electrostatic ion pairing (Scheme 2). Combination of amines with aldehydes results in the formation of hemi-aminals 8, which lie in equilibrium with iminium hydroxides 9 (step 1). While others in the literature activate diboron²¹ and silaborane reagents²² with exogenous ionic bases like alkoxides²³ or fluoride,^{6c} it was reasoned that the hydroxide ion will affect the same activation of the silaborane reagent to furnish ion pair 10 (step 2).²⁴ After activation of these boron reagents, transmetallation occurs with copper chloride complexes; however, when exogenous bases are used, alkali metal cations are in solution to extrude salts,²² giving rise to neutral copper-boryl/silyl complexes. In the proposed mechanism, no alkali metals are present, so transmetallation is expected to furnish a cuprate ion²⁵ charge balanced by the iminium ion 11 (step 3). This electrostatic attraction would obviate the challenging bimolecular kinetics operative in cases where a neutral catalyst reacts with the same iminium ion.²⁶ Silyl nucleophilic attack of the iminium ion would close the catalytic cycle (step 4), forming geminal aminosilanes and the starting copper catalyst. Here, the only byproduct is the boric acid pinacol ester (HO-BPin). This ion pairing²⁷ concept allows practitioners to overcome substrate limitations present in previous methods to access gem-aminosilanes.

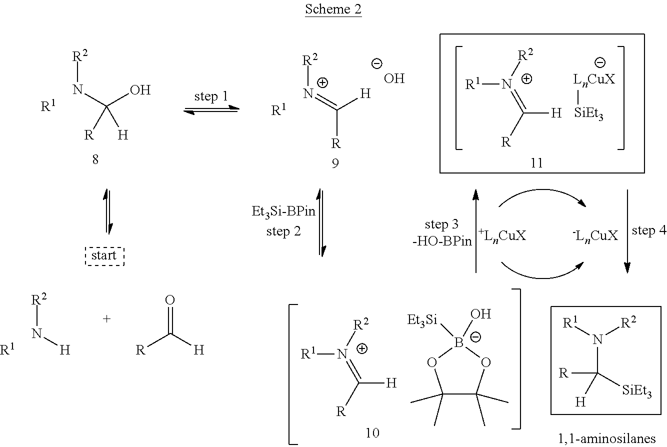

Equimolar concentrations of morpholine, 3-phenylpropanal, (triethylsilyl) pinacolborane (PinBSiEt₃) were combined with 5 mol % (IPr)CuCl as catalyst in acetonitrile at 80° C. for 16 hours. Quantitative formation of 1,1-aminosilane was observed by gas chromatography-mass spectrometry (GC-MS) with further confirmation by NMR. The aminosilylation reaction was developed using a 1:1:1.1 molar ratio of amine, aldehyde, and silaborane, respectively, in the presence of 2.5 mol % (IPr)CuCl (Cat1) in acetonitrile (0.2 M) at 40° C. for 16 hours. Importantly, no reaction occurred in the absence of Cat1. With these conditions in hand, a survey for compatibility with a range of structural and electronic motifs was conducted (Scheme 3).

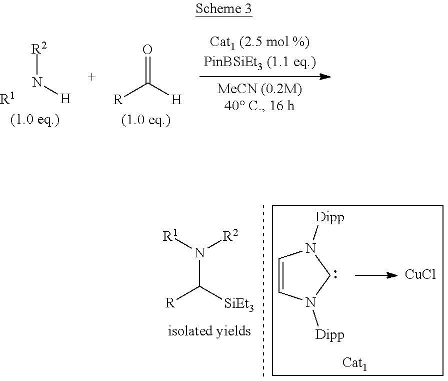

The size of the alkyl group of the aldehyde was surveyed and resulting yields were reported (FIGS. 1A, 1B, and 1C). In all cases 12-16, no significant variation in yields were observed with all affording at least 70% yield with accommodation of even a bulky tert-butyl group. The impact of amine group modifications was then evaluated. Increasing ring size from pyrrolidine to azepane showed slightly decreasing yields from 95% for 17 to 82% in 19. Piperidine 3,4-benzannulation (20) and other heteroatoms on/connected to the amine ring (21-26) were well tolerated, as were acyclic secondary amines (27-28). Surprisingly, primary amines as partners (29-30) were also compatible when PhO-BPin was included as a catalytic additive (10 mol %). Omission of PhO-BPin resulted in inefficient reactivity of primary amines, instead affording aldimines as the dominant products by extrusion of H₂O. It is believed that the impact of PhO-BPin lies in its proclivity to hydrolyze upon contact with water, thereby releasing phenol. Phenol is sufficiently acidic (pKa=10) to protonate off-cycle aldimine intermediates to resume ion pairing catalysis. Lastly, proline methylester was well tolerated, giving 66% yield of aminosilylated product 31 with a diastereomeric ratio of 2.5:1, supporting the ability of this method to accommodate amino acid derivatives. Without being bound by theory, it is believed that the ion pairing concept would for generation of a broad scope of aminosilylation products from both aliphatic and aromatic aldehydes, which would be unprecedented for a single catalyst system. Exchange of 3-phenylpropanal for aromatic aldehydes enabled isolation of phenyl aminosilane 32 in 91% yield with further compatibility for electron rich (33-35) and electron poor (36) aldehydes in excellent yields (>75%). Importantly, ortho-functionalization with methoxy groups did not impede catalysis (37-38). The presence of electron-rich heteroarenes like thiophene, pyrazole, thiazole, or indole were compatible as well (39-43). Like with aliphatic aldehydes, aminosilanes derived from primary amines and benzaldehyde were readily accessed (44).

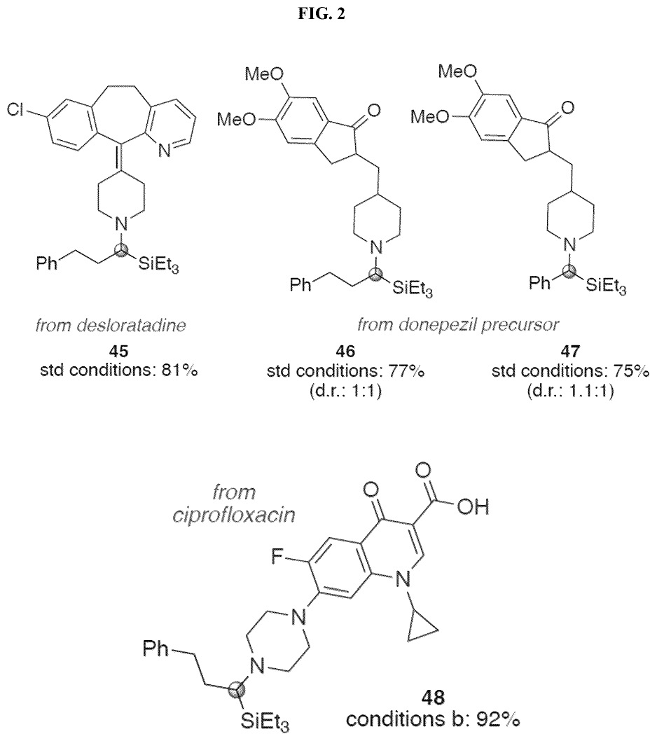

For amine-containing drugs like desloratadine and the penultimate precursor to donepezil, aminosilylation products 45-46 were obtained in excellent yields (>77%) using 3-phenylpropanal as the coupling partner (FIG. 2). The donepezil precursor with benzaldehyde as the partner was also tested, obtaining 47 in 75% yield. In contrast to other methods, ciprofloxacin in its carboxylic acid form was deployed, rather than the methyl ester, to cleanly form carboxylic acid containing aminosilane product 48 in 92% yield. Single crystals of 48 suitable for an X-ray diffraction study were grown by vapor diffusion of Et₂O into a saturated CHCl₃:MeCN (10:1) solution.

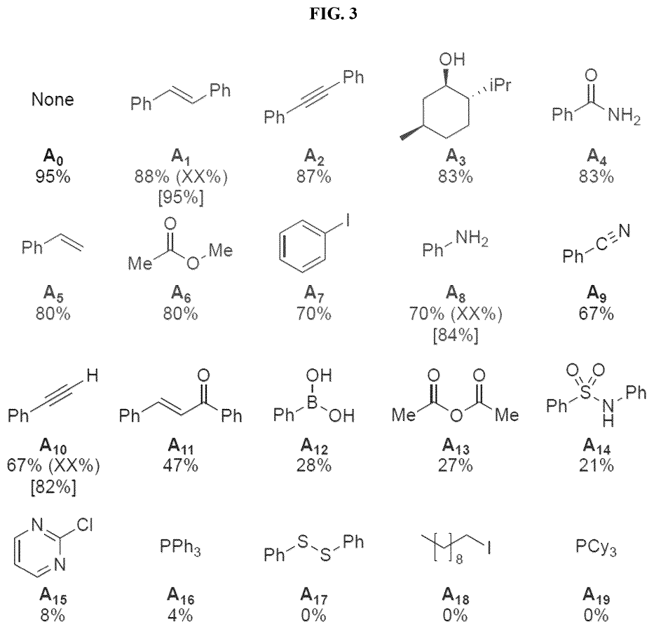

The compatibility of Cat1 with many synthetically valuable functional groups was also tested.²⁹ Using 3-phenylpropanal and morpholine as the model reagents (Scheme 4), nine different functional groups were tested, many of which were compatible with Cat1 and the reaction conditions (FIG. 3) Additives A₁₋₈ enabled product formation above 70% with minimal consumption of the additive itself. Notable functional groups in this tier included free alcohols (A3) and anilines (A8) as well as primary amides (A4), each bearing mildly acidic protons and coordinating properties. Additionally, terminal alkenes (A5) and internal alkenes/alkynes (A1-2) were well tolerated. Aryl nitriles (A9), terminal alkynes (A10), and electrophilic α,β-unsaturated ketones (A11) showed moderate compatibility. The incompatible tier (<30% yield of product) included additives featuring strongly Lewis basic or electrophilic tendencies (A12-19). For example, boronic acids (A12), anhydrides (A13), disulfides (A17), and alkyl iodides (A18) readily reacted with good nucleophiles, as evidenced by the severely reduced concentration of remaining additive. In contrast, strongly coordinating phosphines like PPh₃ (A16) and PCy₃ (A19) were not consumed but were likely to impede reactivity by complexing the copper catalyst.

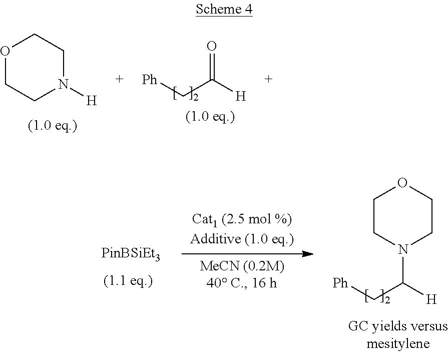

When this multicomponent strategy was developed, the hypothesis for enhanced reactivity was predicated on in-situ formation of iminium cuprate ion pair 11. While the scope and robustness screen results support broad applications, evidence supporting the formation of 11 as the key Cu-based intermediate is challenging to obtain synthetically due to the propensity of ion paired species to recombine. Instead, indirect avenues to gather support for 11 was pursued. First, the mechanistic proposal predicts the chloride X-ligand remains coordinated to Cu throughout the transformation. If Cu—Cl dissociation occurs to generate iminium chloride and LCu-SiEt₃ intermediates, then weakly coordinating anions like trifluoromethanesulfonate (OTf) should furnish more active catalysts. However, exchange of Cat1 for IPr—Cu-OTf (Cat2) under the standard reaction conditions resulted in a significantly reduced product formation of only 39% (Scheme 5).

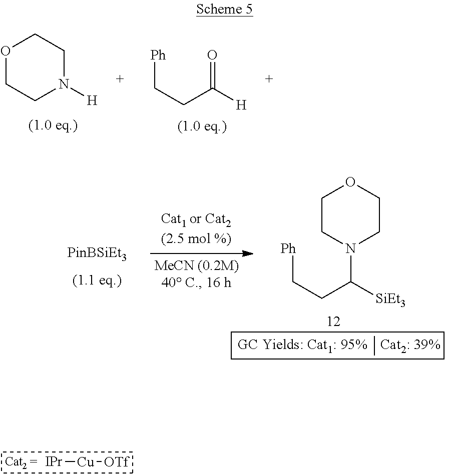

This indicates that more strongly coordinating X-ligands (Cl>OTf) on Cu support the mechanistic hypothesis. Second, it was rationalized that aldehyde substrates bearing strong resonance effects could migrate the positive charge of the electrophilic iminium ion to a distal site, effectively disconnecting the amination and silylation steps of the mechanism to achieve selective 1,n-aminosilylation by “charge walking” catalysis (Scheme 6, inset). In line with this hypothesis, aminosilane products 49-50 were formed regioselectively in excellent isolated yields (Scheme 6, note a indicates that the standard conditions from Scheme 3 were used on 0.5 mmol scale). The ability of the catalyst to follow the electrophilic site to a remote position supports the electrostatic ion pairing mechanism.

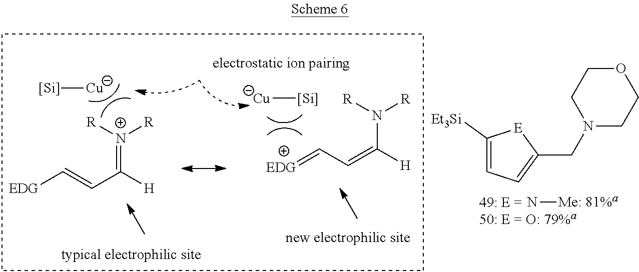

Scale-up and post-functionalization. The scalability of the protocol was first surveyed by preparing a large batch of dibenzyl aminosilane 27. On 7.5 mmol scale using only 1.0 mol % Cat1 for 72 hours, 27 was obtained in 72% yield (2.3 g) (Scheme 7).

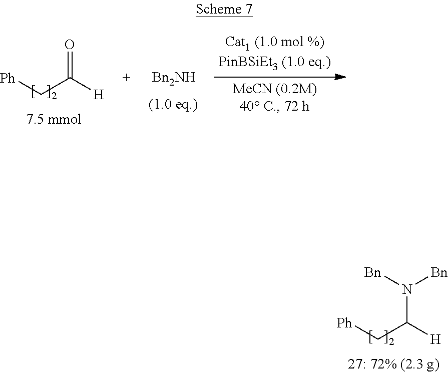

While tetra-alkylsilanes are often inert, the presence of the α-amino group enables fluoride-assisted functionalization of these aminosilanes with electrophiles via a polar process.³⁰ Combination of 37 with cesium fluoride (CsF) and benzaldehyde afforded the synthetically significant 1,2-aminoalcohol 51 in 77% unoptimized yield (d.r.=1.2:1). See Scheme 8. More recently, α-aminosilanes were revealed as valuable precursors to α-amino radicals via photoredox catalysis;³¹ however, the scope of accessible α-aminosilanes for this purpose is generally limited due to few synthetic access points. In light of this research direction, 34 was subjected to modified literature photoredox conditions for α-amino radical generation and arylation, obtaining 52 in 60% unoptimized yield.³² Lastly, pure samples of 27 and 32 were left under air for 40 days with no observable decomposition by ¹H NMR, supporting the enhanced stability of 1,1-aminosilanes over 1,1-aminoboranes.^{6a, 6b}

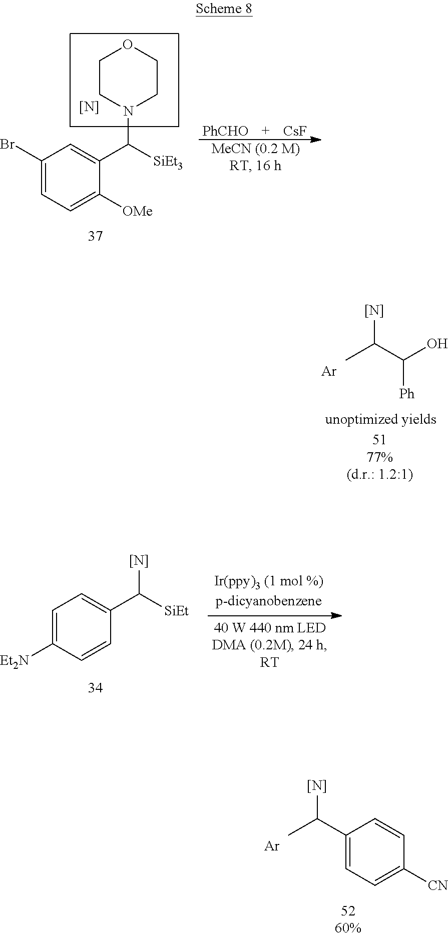

General. Unless indicated otherwise, all reactions were performed under a nitrogen atmosphere using Schlenk line techniques or a nitrogen-filled glovebox. Reactions at elevated temperature were maintained by thermostatically controlled heating blocks. Solvents were purchased from commercial suppliers and used without further purification, unless otherwise indicated. Acetonitrile was left for at least 48 hours over activated 4 Å molecular sieves prior to use. Organic chemicals were used as received unless otherwise noted.

Silica gel chromatography was performed with Silicycle silica gel. Reactions were monitored by thin-layer chromatography (TLC) carried out on glass-back silica gel plates (60F254) visualizing with UV light (254 nm) or by staining with ceric ammonium nitrate (CAM).

¹H NMR spectra were recorded on JEOL ECZ 400 NMR or Bruker Avance 300 MHz spectrometers. ¹³C NMR spectra were recorded on a JEOL ECZ 400 MHz NMR spectrometer. ¹H and ¹³C chemical shifts (8) are reported in ppm relative to the residual solvent signal (CDCl₃=7.26 ppm for ¹H and 77.16 ppm for ¹³C). Coupling constants are reported in Hertz (Hz). Multiplicities are abbreviated as follows: s=singlet, d=doublet, t=triplet, q=quartet, p=pentet, quint=quintet, h=heptet, m=multiplet, dd=doublet of doublets, ddd=doublet of doublets of doublets, dddd=doublet of doublets of doublets of doublets, dt=doublet of triplet, dq=doublet of quartet, td=triplet of doublet, dtd=doublet of triplet of doublets, pd=pentet of doublet, qd=quartet of doublet, br=broad.

Melting points were collected using a DigiMelt MPA 160 apparatus with a 5° C./min ramp rate and borosilicate melting point capillary tubes. Cat1,¹ Cat2,² and the free base of proline methyl ester³ were prepared using established procedures.

Gas chromatography-mass spectrometry (GC-MS) analyses were conducted on an Agilent 8890 gas chromatograph with a 5977B mass-spectrometer equipped with an EI XTR ion source. Hydrogen was used as the carrier gas. GC setup and method: J&W HP-5 capillary column: 20 m×180 μm×0.18 μm, inlet temperature: 250° C., detector (FID) temperature: 325° C., injection volume: 1 μL. 30:1 split ratio, temperature program (rate-temperature-hold time): 0° C./min-70° C.-1.0 min; 40° C./min-175° C.-0 min; 30° C./min-300° C.-0 min; 20° C./min-325° C.-3.0 min. MS transfer line set at 340° C.

Preparative high performance liquid chromatography (prep-HPLC) purifications were conducted on a Shimadzu Nexera LC equipped with a Nexera SPD-40 UV Detector. A Shim-pack GIS C18, 5 μm, 20×250 mm preparative column using a gradient of 0-100% MeOH in H₂O at a flow rate of 8 mL/min. MeOH and H₂O solvents contained 0.1% v/v trifluoroacetic acid as additive.

### Example 1. Synthesis of triethyl(4,4,5,5-tetramethyl-1,3,2-dioxaborolan-2-yl)silane (Et₃SiBpin)

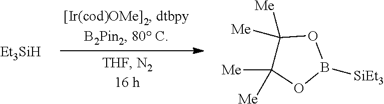

The synthesis of Et₃SiBpin was achieved by modification of known literature procedures.⁴ In a nitrogen-filled glovebox, a 250-mL Schlenk flask was charged with B₂pin₂ (10.0 g, 39.4 mmol), [Ir(COD)OMe]₂ (131 mg, 0.197 mmol, 0.5 mol %), 4,4′-di-tertbutylbipyridine (52.3 mg, 0.195 mmol, 0.5 mol %), Et₃SiH (25.2 mL, 158 mmol, 4 equiv.), THF (32 mL), and a magnetic stir bar. The flask was sealed with a rubber septum and taped tightly. The flask was heated at 80° C. for 16 h. The reaction mixture was cooled to 0° C. followed by addition of 30 mL of MeOH while stirring vigorously. After addition, the solution is stirred for 30 minutes to consume all of the generated HBpin byproduct. Volatiles were evaporated under reduced pressure, and the resulting oil was crudely purified by silica gel chromatography with 5% Et₂O in hexanes as eluent, yielding a grey oil. The grey oil was further purified by short-path distillation (80° C., 250 mtorr), yielding Et₃SiBpin (6.35 g, 69% yield) as a clear and colorless oil. Analytical data matched that reported in the literature. ¹H NMR (400 MHz CDCl₃) δ 1.23 (s, 12H, Bpin-CH₃), 0.96 (t, 9H, J=7.9 Hz, CH₂CH₃), 0.59 (q, 6H, J=7.9 Hz, CH₂CH₃).

### Example 2. Methods (A-D) Used to Prepare the Silanes

Method A: An oven dried 1-dram vial equipped with a magnetic stir bar was charged with Cat1 (6.1 mg, 0.0125 mmol, 2.5 mol %), Et₃SiBpin (133 mg, 0.6 mmol, 1.1 equiv.), and MeCN (3.0 mL, 0.17 M). The solution was allowed to stir for 2 minutes at ambient temperature. Then, amine (0.50 mmol, 1.0 equiv.) and aldehyde (67 mg, 0.5 mmol, 1.0 equiv.) were added in that order. The reaction vial was capped with a PTFE lined screw cap and removed from the glovebox. The reaction was stirred for 16 hours on a hot plate preheated to 40° C. After 16 hours, the solution was allowed to cool to room temperature and taken into the glovebox. Volatiles in the reaction mixture were concentrated under reduced pressure. Then 4 mL of a 1:1 hexane/Et₂O mixture was added to the vial to dissolve the crude oil. The resulting solution was then filtered through a Pasteur pipette containing 3 cm neutral alumina, washing with 2×3 mL of a 1:1 hexane/Et₂O mixture. The combined filtrate was concentrated under reduced pressure.

Method B: An oven dried 1-dram vial equipped with a magnetic stir bar was charged with Cat1 (6.1 mg, 00.0125 mmol, 2.5 mol %), Et₃SiBpin (133 mg, 0.6 mmol, 1.1 equiv.), and MeCN (3.0 mL, 0.17 M). The solution was allowed to stir for 2 minutes at ambient temperature. Then, amine (0.50 mmol, 1.0 equiv.) and aldehyde (0.5 mmol, 1.0 equiv.) were added in that order. The reaction vial was capped with a PTFE lined screw cap and removed from the glovebox. The reaction was stirred for 16 hours on a hot plate preheated to 80° C. After 16 hours, the solution was allowed to cool to room temperature and taken into the glovebox. Volatiles in the reaction mixture were concentrated under reduced pressure. Then 4 mL of a 1:1 hexane/Et₂₀ mixture was added to the vial to dissolve the crude oil. The resulting solution was then filtered through a Pasteur pipette containing 3 cm neutral alumina, washing with 2×3 mL of a 1:1 hexane/Et₂O mixture. The combined filtrate was concentrated under reduced pressure.

Method C: An oven dried 1-dram vial equipped with a magnetic stir bar was charged with Cat1 (6.1 mg, 0.0125 mmol, 2.5 mol %), PhOBpin (55 mg, 0.25 mmol, 0.5 equiv.), Et₃ SiBpin (133 mg, 0.6 mmol, 1.1 equiv.), and MeCN (3.0 mL, 0.17 M). The solution was allowed to stir for 2 minutes at ambient temperature. Then, amine (0.50 mmol, 1.0 equiv.) and aldehyde (0.5 mmol, 1.0 equiv.) were added in that order. The reaction vial was capped with a PTFE lined screw cap and removed from the glovebox. The reaction was stirred for 16 hours on a hot plate preheated to 80° C. After 16 hours, the solution was allowed to cool to room temperature and taken into the glovebox. Volatiles in the reaction mixture were concentrated under reduced pressure. Then 4 mL of a 1:1 hexane/Et₂O mixture was added to the vial to dissolve the crude oil. The resulting solution was then filtered through a Pasteur pipette containing 3 cm neutral alumina, washing with 2×3 mL of a 1:1 hexane/Et₂O mixture. The combined filtrate was concentrated under reduced pressure.

Method D: To an oven dried dram vial equipped with a magnetic stir bar was added into a glovebox. The vial was charged with CuCl (5.0 mg, 0.010 mmol, 10 mol %), Et₃SiBpin (133 mg, 0.6 mmol, 1.1 equiv.), and MeCN (3.0 mL, 0.17 M). The solution was allowed to stir for 2 minutes at ambient temperature. Then, amine (0.50 mmol, 1.0 equiv.) and aldehyde (0.5 mmol, 1.0 equiv.) were added in that order. The reaction vial was capped with a PTFE lined screw cap and removed from the glovebox. The reaction was stirred for 16 hours on a hot plate preheated to 80° C. After 16 hours, the solution was allowed to cool to room temperature and taken into the glovebox. Volatiles in the reaction mixture were concentrated under reduced pressure. The resulting solution was then filtered through a Pasteur pipette containing 3 cm neutral alumina, washing with 2×3 mL of a 1:1 hexane/Et₂O mixture. The combined filtrate was concentrated under reduced pressure.

Three purification strategies (1-3) used to purify the silanes.

Strategy 1: Flash column chromatography over silica gel. See individual products for detailed eluent systems.

Strategy 2: Dissolution of the crude oil in 3 mL Et₂O followed by addition of 1 mL 4 M HCl(dioxane) to precipitate the desired product. The ether was decanted away. An additional 3 mL Et₂O was added and again decanted. The remaining residue was suspended in 3 mL Et₂₀ before being neutralized with 3 mL of a saturated K₂CO₃ solution. The Et₂O was separated from the aqueous phase. The aqueous phase was washed with 3×3 mL Et₂O. The combined Et₂₀ extracts were dried over Na₂SO₄, filtered, and concentrated under reduced pressure to afford the analytically pure aminosilane products.

Strategy 3: Heat crude oil at 110° C. under high vacuum with a Hickman head attachment for 1 hour to distill byproducts.

4-(3-phenyl-1-(triethylsilyl)propyl)morpholine (12). Method A: 3-phenylpropionaldehyde (67 mg, 0.5 mmol, 1.0 equiv.), morpholine (44 mg, 0.5 mmol, 1.0 equiv.), and Et₃ SiBpin (133 mg, 0.6 mmol, 1.1 equiv.). Purification: 95:5 n-hex:EtOAc; Rf=0.6. Transparent yellow oil (151 mg, 0.473 mmol, 95%). ¹H NMR (400 MHz, CDCl₃) δ 7.32-7.15 (m, 5H), 3.72-3.62 (m, 4H), 2.81 (ddd, J=13.6, 10.2, 5.0 Hz, 1H), 2.65 (q, J=4.1 Hz, 5H), 2.13 (dd, J=9.4, 4.4 Hz, 1H), 1.97 (dtd, J=14.5, 9.7, 5.0 Hz, 1H), 1.70-1.59 (m, 1H), 0.95 (t, J=7.9 Hz, 9H), 0.61 (qd, J=7.9, 2.9 Hz, 6H). ¹³C{¹H} NMR (100 MHz, CDCl₃) δ 128.5, 128.4, 77.5, 77.2, 76.8. MS (EI) m/z: [M+] Calc'd for C₁₉H₃₃NOSi: 319.2331; Found: 319.2.

4-(3-methyl-1-(triethylsilyl)butyl)morpholine (13). Method A: 3-methylbutanal (43 mg, 0.5 mmol, 1.0 equiv.), morpholine (44 mg, 0.5 mmol, 1.0 equiv.), and Et₃SiBpin (133 mg, 0.6 mmol, 1.1 equiv.). Purification: Strategy 2. Clear oil (129 mg, 0.475 mmol, 95%). ¹H NMR (400 MHz, CDCl₃) δ 3.62 (t, J=4.6 Hz, 4H), 2.60 (tq, J=11.4, 5.6 Hz, 4H), 2.28-2.19 (m, 1H), 1.77-1.59 (m, 2H), 0.97 (t, J=7.9 Hz, 9H), 0.88 (t, J=6.6 Hz, 6H), 0.59 (qd, J=7.9, 3.1 Hz, 6H). ¹³C{¹H} NMR (100 MHz, CDCl₃) δ 77.4, 77.1, 76.8, 67.9, 52.2, 52.1, 36.2, 26.9, 23.6, 21.8, 7.9, 3.9. MS (EI) m/z: [M+] Calc'd for C₁₅H₃₃NOSi: 271.2331; Found: 271.2.

4-(cyclopropyl(triethylsilyl)methyl)morpholine (14). Method A: cyclopropanecarbaldehyde (35 mg, 0.5 mmol, 1.0 equiv.), morpholine (44 mg, 0.5 mmol, 1.0 equiv.), and Et₃SiBpin (133 mg, 0.6 mmol, 1.1 equiv.). Purification: Strategy 2. Title compound as a transparent clear oil (113 mg, 0.442 mmol, 89%). ¹H NMR (400 MHz, CDCl₃) δ 3.65 (ddd, J=5.3, 3.5, 1.4 Hz, 4H), 2.86 (dt, J=10.1, 4.4 Hz, 2H), 2.57 (dt, J=10.9, 4.6 Hz, 2H), 1.36 (d, J=11.3 Hz, 1H), 0.98 (t, J=7.9 Hz, 9H), 0.89-0.78 (m, 1H), 0.71-0.57 (m, 7H), 0.41 (tdd, J=9.0, 5.5, 4.3 Hz, 1H), 0.23 (dtd, J=9.4, 5.3, 4.2 Hz, 1H), −0.00-−0.08 (m, 1H). ¹³C{¹H} NMR (100 MHz, CDCl₃) δ 77.4, 77.1, 76.7, 67.9, 61.0, 7.9, 7.6, 7.0, 3.8, 1.9. MS (EI) m/z: [M+] Calc'd for C₁₄H₂₉NOSi: 255.2018; Found: 255.2.

4-(cyclohexyl(triethylsilyl)methyl)morpholine (15). Method A: cyclohexane carbaldehyde (56 mg, 0.5 mmol, 1.0 equiv.), morpholine (44 mg, 0.5 mmol, 1.0 equiv.), and Et₃ SiBpin (133 mg, 0.6 mmol, 1.1 equiv.). Purification: Strategy 2. Transparent clear oil (129 mg, 0.475 mmol, 95%). ¹H NMR (400 MHz, CDCl₃) δ 3.61 (t, J=4.6 Hz, 4H), 2.76 (dt, J=11.6, 4.6 Hz, 2H), 2.65 (dt, J=11.4, 4.6 Hz, 2H), 1.93 (d, J=5.0 Hz, 1H), 1.79-1.56 (m, 6H), 1.31-1.05 (m, 6H), 0.97 (t, J=7.9 Hz, 9H), 0.64 (qd, J=7.8, 3.2 Hz, 6H). ¹³C{¹H} NMR (100 MHz, CDCl₃) δ 77.4, 77.1, 76.8, 68.0, 62.0, 53.5, 39.6, 33.6, 27.0, 26.4, 8.1, 5.2. MS (EI) m/z: [M+] Calc'd for C₁₇H₃₅NOSi: 297.2488; Found: 297.2.

4-(2,2-dimethyl-1-(triethylsilyl)propyl)morpholine (16). Method A: pivalaldehyde (43 mg, 0.5 mmol, 1.0 equiv.), morpholine (44 mg, 0.5 mmol, 1.0 equiv.), and Et₃SiBpin (133 mg, 0.6 mmol, 1.1 equiv.). Purification: Strategy 2. Clear transparent oil (96 mg, 0.350 mmol, 71%). ¹H NMR (400 MHz, CDCl₃) δ 3.61 (dt, J=6.1, 3.2 Hz, 4H), 2.86 (q, J=3.9 Hz, 4H), 1.93 (s, 1H), 1.03-0.95 (m, 18H), 0.78-0.56 (m, 6H). ¹³C{¹H} NMR (100 MHz, CDCl₃) δ 77.43, 77.12, 76.80, 68.24, 65.95, 30.38, 24.95, 8.18, 6.09. MS (EI) m/z: [M+] Calc'd for C₁₅H₃₃NOSi: 271.2331; Found: 271.2.

1-(3-phenyl-1-(triethylsilyl)propyl)pyrrolidine (17). Method A: 3-phenyl propionaldehyde (67 mg, 0.5 mmol, 1.0 equiv.), pyrrolidine (36 mg, 0.5 mmol, 1.0 equiv.), and Et₃SiBpin (133 mg, 0.6 mmol, 1.1 equiv.). Purification: Strategy 2. Orange oil (144 mg, 0.474 mmol, 95%). ¹H NMR (400 MHz, CDCl₃) δ 7.34-7.27 (m, 2H), 7.20 (dd, J=7.9, 2.5 Hz, 3H), 2.76-2.57 (m, 6H), 2.29-2.22 (m, 1H), 1.96-1.68 (m, 6H), 0.99 (t, J=7.9 Hz, 9H), 0.73-0.59 (m, 6H). ¹³C{¹H} NMR (100 MHz, CDCl₃) δ 143.3, 128.4, 128.4, 125.7, 77.4, 77.3, 77.1, 76.8, 52.4, 50.3, 35.4, 31.0, 23.9, 8.0, 4.1. MS (EI) m/z: [M+] Calc'd for C₁₉H₃₃NSi: 303.2382; Found: 303.2.

1-(3-phenyl-1-(triethylsilyl)propyl)piperidine (18). Method A: 3-phenyl propionaldehyde (67 mg, 0.5 mmol, 1.0 equiv.), piperidine (43 mg, 0.5 mmol, 1.0 equiv.), and Et₃SiBpin (133 mg, 0.6 mmol, 1.1 equiv.). Purification: Strategy 2. Transparent yellow oil (146 mg, 0.460 mmol, 92%). ¹H NMR (400 MHz, CDCl₃) δ 7.24 (dd, J=7.9, 6.7 Hz, 2H), 7.17-7.10 (m, 3H), 2.76 (ddd, J=13.8, 10.4, 5.0 Hz, 1H), 2.56 (ddd, J=9.5, 6.8, 3.5 Hz, 4H), 2.08 (dd, J=9.4, 4.6 Hz, 1H), 1.93 (dtd, J=14.4, 9.8, 4.9 Hz, 1H), 1.56 (dtd, J=12.2, 6.3, 3.2 Hz, 1H), 1.48 (tt, J=6.4, 3.2 Hz, 3H), 1.36 (q, J=6.2 Hz, 2H), 0.91 (t, J=7.9 Hz, 9H), 0.56 (qd, J=7.9, 4.2 Hz, 6H). ¹³C{¹H} NMR (100 MHz, CDCl₃) δ 143.2, 128.5, 125.6, 77.4, 77.1, 76.8, 55.0, 53.3, 36.2, 29.5, 27.0, 24.7, 7.9, 4.2. MS (EI) m/z: [M+] Calc'd for C₂₀H₃₅NSi: 317.2539; Found: 317.2.

1-(3-phenyl-1-(triethylsilyl)propyl)azepane (19). Method A: 3-phenyl propionaldehyde (67 mg, 0.5 mmol, 1.0 equiv.), azepane (50 mg, 0.5 mmol, 1.0 equiv.), and Et₃SiBpin (133 mg, 0.6 mmol, 1.1 equiv.). Purification: Strategy 1 (95:5 n-hex:EtOAc; Rf=0.7). Transparent clear oil (136 mg, 0.410 mmol, 82%). ¹H NMR (400 MHz, CDCl₃) δ 7.33-7.12 (m, 5H), 2.86 (ddd, J=13.5, 10.4, 4.7 Hz, 1H), 2.79-2.69 (m, 4H), 2.59 (ddd, J=13.5, 10.3, 6.4 Hz, 1H), 2.21 (dd, J=10.6, 3.9 Hz, 1H), 1.91 (dtd, J=14.9, 10.4, 4.7 Hz, 1H), 1.68-1.50 (m, 9H), 0.93 (t, J=7.9 Hz, 9H), 0.58 (qd, J=7.8, 6.0 Hz, 6H). ¹³C{¹H} NMR (100 MHz, CDCl₃) δ 143.4, 128.5, 128.3, 125.6, 77.4, 77.1, 76.8, 56.6, 55.3, 36.0, 31.3, 30.7, 27.2, 7.9, 4.0. MS (EI) m/z: [M+] Calc'd for C₂₁H₃₇NSi: 331.2695; Found: 331.2.

2-(3-phenyl-1-(triethylsilyl)propyl)-1,2,3,4-tetrahydroisoquinoline (20). Method B: 3-phenylpropionaldehyde (67 mg, 0.5 mmol, 1.0 equiv.), 1,2,3,4-tetrahydroisoquinoline (67 mg, 0.5 mmol, 1.0 equiv.), and Et₃SiBpin (133 mg, 0.6 mmol, 1.1 equiv.). Purification: Strategy 1 (85:15 n-hex:EtOAc; Rf=0.6). Dark brown oil (177 mg, 0.484 mmol, 97%). ¹H NMR (400 MHz, CDCl₃) δ 7.29-7.22 (m, 2H), 7.17 (d, J=7.1 Hz, 3H), 7.12-7.07 (m, 3H), 7.02-6.97 (m, 1H), 3.84 (s, 2H), 2.90 (dd, J=8.5, 3.1 Hz, 2H), 2.81 (dq, J=18.2, 4.4 Hz, 3H), 2.65 (ddd, J=13.3, 9.9, 6.5 Hz, 1H), 2.37-2.29 (m, 1H), 2.10-1.97 (m, 1H), 1.74-1.64 (m, 1H), 1.00-0.90 (m, 9H), 0.70-0.56 (m, 6H). ¹³C{¹H} NMR (100 MHz, CDCl₃) δ 143.0, 136.4, 135.1, 128.9, 128.6, 128.4, 126.5, 125.8, 125.8, 125.4, 77.5, 77.2, 76.9, 66.0, 54.4, 53.97, 49.7, 36.1, 30.7, 29.6, 15.4, 8.0, 4.2. MS (EI) m/z: [M+] Calc'd for C₂₄H₃₅NSi: 365.2539; Found: 365.1.

1-(2-methoxyphenyl)-4-(3-phenyl-1-(triethylsilyl)propyl)piperazine (21). Method A: 3-phenylpropionaldehyde (67 mg, 0.5 mmol, 1.0 equiv.), 1 1-(2-methoxyphenyl)piperazine (96 mg, 0.5 mmol, 1.0 equiv.), and Et₃SiBpin (133 mg, 0.6 mmol, 1.1 equiv.). Purification: Strategy 1 (85:15 n-hex:EtOAc; Rf=0.4). Clear transparent oil (148 mg, 0.348 mmol, 70%). ¹H NMR (400 MHz, CDCl₃) δ 7.32-7.14 (m, 5H), 7.03-6.82 (m, 4H), 3.87 (d, J=1.5 Hz, 3H), 3.04 (s, 4H), 2.86 (tp, J=10.3, 4.4 Hz, 5H), 2.65 (td, J=12.0, 6.4 Hz, 1H), 2.22 (ddd, J=9.3, 4.4, 1.4 Hz, 1H), 2.11-1.98 (m, 1H), 1.66 (ddddd, J=14.7, 10.7, 6.2, 4.5, 1.5 Hz, 1H), 0.96 (td, J=7.9, 1.4 Hz, 10H), 0.63 (qdd, J=8.3, 3.1, 1.5 Hz, 6H). ¹³C{¹H} NMR (100 MHz, CDCl₃) δ 152.3, 143.0, 141.8, 128.5, 128.4, 128.4, 125.7, 122.8, 121.0, 118.3, 111.0, 77.5, 77.2, 76.9, 55.3, 54.2, 52.1, 51.8, 36.5, 29.4, 8.0, 4.1. MS (EI) m/z: [M+] Calc'd for C₂₆H₄₀N₂OSi: 424.2910; Found: 424.2.

1-(3-phenyl-1-(triethylsilyl)propyl)-4-(pyrrolid-2-yl)piperazine (22). Method A: 3-phenylpropionaldehyde (67 mg, 0.5 mmol, 1.0 equiv.), 1-(pyrrolid-2-yl)piperazine (82 mg, 0.5 mmol, 1.0 equiv.), and Et₃SiBpin (133 mg, 0.6 mmol, 1.1 equiv.). Purification: Strategy 1 (85:15 n-hex:EtOAc; Rf=0.5) afforded the title compound as a transparent orange oil (148 mg, 0.475 mmol, 75%). ¹H NMR (400 MHz, CDCl₃) δ 8.18 (dd, J=5.2, 2.0 Hz, 1H), 7.45 (ddd, J=8.8, 7.1, 2.0 Hz, 1H), 7.29-7.23 (m, 2H), 7.20-7.13 (m, 3H), 6.67-6.55 (m, 2H), 3.69 (s, 1H), 3.48 (q, J=4.4 Hz, 4H), 2.85-2.71 (m, 5H), 2.64 (ddd, J=13.5, 9.8, 6.6 Hz, 1H), 2.22 (dd, J=9.5, 4.4 Hz, 1H), 1.98 (dtd, J=14.5, 9.7, 5.0 Hz, 1H), 1.64 (dddd, J=14.3, 10.7, 6.6, 4.5 Hz, 1H), 0.94 (t, J=7.9 Hz, 9H), 0.61 (qd, J=7.9, 3.0 Hz, 6H). ¹³C{¹H} NMR (100 MHz, CDCl₃) δ 159.9, 148.0, 137.5, 137.4, 128.5, 128.4, 125.7, 113.2, 107.2, 77.5, 77.1, 76.8, 67.1, 54.2, 51.7, 46.3, 36.1, 29.4, 7.9, 4.1. MS (EI) m/z: [M+] Calc'd for C₂₄H₃₇N₃Si: 395.2757; Found: 395.2.

4-(1-(3-phenyl-1-(triethylsilyl)propyl)piperidin-4-yl)morpholine (23). Method A: 3-phenylpropionaldehyde (67 mg, 0.5 mmol, 1.0 equiv.), 4-(piperidin-4-yl)morpholine (85 mg, 0.5 mmol, 1.0 equiv.), and Et₃SiBpin (133 mg, 0.6 mmol, 1.1 equiv.). Purification: Strategy 2. Transparent yellow oil (150 mg, 0.372 mmol, 75%). ¹H NMR (400 MHz, CDCl₃) δ 7.31-7.24 (m, 2H), 7.17 (dt, J=6.4, 1.6 Hz, 3H), 3.73 (dd, J=10.5, 5.8 Hz, 5H), 2.89-2.72 (m, 3H), 2.65-2.52 (m, 6H), 2.45 (td, J=11.5, 2.3 Hz, 1H), 2.15 (dd, J=9.5, 4.6 Hz, 1H), 2.06 (tt, J=11.3, 3.8 Hz, 1H), 1.94 (dtd, J=14.5, 9.7, 4.9 Hz, 1H), 1.85-1.72 (m, 2H), 1.60 (dddd, J=14.5, 10.8, 6.5, 4.6 Hz, 1H), 1.44 (qdd, J=11.5, 6.7, 4.2 Hz, 2H), 0.93 (t, J=7.9 Hz, 9H), 0.58 (qd, J=7.9, 3.4 Hz, 6H). ¹³C{¹H} NMR (100 MHz, CDCl₃) δ 143.0, 128.5, 125.6, 77.5, 77.1, 76.8, 67.4, 62.6, 54.2, 54.0, 52.5, 50.6, 50.1, 49.8, 36.1, 29.7, 29.5, 7.9, 4.1. MS (EI) m/z: [M+] Calc'd for C₂₄H₄₂N₂OSi: 402.3066; Found: 402.2.

2-(4-(3-phenyl-1-(triethylsilyl)propyl)piperazin-1-yl)-1-(pyrrolidine-1-yl)ethan-1-one (24). Method A: 3-phenylpropionaldehyde (67 mg, 0.5 mmol, 1.0 equiv.), 1-cyclopentyl-2-(piperazin-1-yl)ethan-1-one (98 mg, 0.5 mmol, 1.0 equiv.), and Et₃SiBpin (133 mg, 0.6 mmol, 1.1 equiv.). Purification: Strategy 2. Transparent orange oil (160 mg, 0.373 mmol, 75%). ¹H NMR (400 MHz, CDCl₃) δ 7.29-7.26 (m, 1H), 7.24 (s, 1H), 7.20-7.10 (m, 3H), 3.47 (dt, J=9.2, 6.8 Hz, 4H), 3.09 (s, 2H), 2.79 (ddd, J=14.7, 10.2, 4.9 Hz, 1H), 2.73-2.44 (m, 8H), 2.13 (dd, J=9.3, 4.5 Hz, 1H), 1.93 (dq, J=13.3, 6.8 Hz, 3H), 1.87-1.78 (m, 2H), 1.66-1.54 (m, 1H), 0.92 (t, J=7.9 Hz, 9H), 0.58 (qd, J=7.8, 3.0 Hz, 6H). ¹³C{¹H} NMR (100 MHz, CDCl₃) δ 168.3, 143.0, 128.5, 128.3, 125.6, 77.5, 77.4, 77.2, 76.8, 61.7, 54.5, 53.9, 51.5, 46.3, 45.8, 36.2, 29.4, 26.3, 24.2, 7.9, 4.0. MS (EI) m/z: [M+] Calc'd for C₂₅H₄₃N₃OSi: 429.3175; Found: 429.2. [M-SiEt3]+ Calc'd for C₁₉H₂₈N₃O: 314.2227; Found: 314.2.

1-phenyl-4-(3-phenyl-1-(triethylsilyl)propyl)piperazine (25). Method A: 3-phenylpropionaldehyde (67 mg, 0.5 mmol, 1.0 equiv.), 1-phenylpiperazine (81 mg, 0.5 mmol, 1.0 equiv.), and Et₃SiBpin (133 mg, 0.6 mmol, 1.1 equiv.). Purification: Strategy 1 (85:15 n-hex:EtOAc; Rf=0.5). Transparent clear oil (181 mg, 0.459 mmol, 92%). ¹H NMR (400 MHz, CDCl₃) δ 7.28 (d, J=1.9 Hz, 1H), 7.24 (dd, J=9.1, 7.0 Hz, 3H), 7.17 (d, J=7.4 Hz, 3H), 6.95-6.89 (m, 2H), 6.85-6.79 (m, 1H), 3.13 (dd, J=6.1, 4.4 Hz, 4H), 2.82 (dq, J=10.3, 4.9 Hz, 5H), 2.63 (ddd, J=13.5, 9.9, 6.6 Hz, 1H), 2.21 (dd, J=9.4, 4.4 Hz, 1H), 1.99 (dtd, J=14.5, 9.7, 4.9 Hz, 1H), 1.64 (dddd, J=14.4, 10.6, 6.6, 4.5 Hz, 1H), 0.94 (t, J=7.9 Hz, 9H), 0.61 (qd, J=7.9, 2.8 Hz, 6H). ¹³C{¹H} NMR (100 MHz, CDCl₃) δ 151.8, 142.9, 129.1, 128.5, 128.5, 128.4, 125.8, 119.6, 116.1, 77.5, 77.2, 76.8, 54.13, 51.9, 50.2, 36.2, 29.4, 8.0, 4.1. MS (EI) m/z: [M+] Calc'd for C₂₅H₃₈N₂Si: 394.2804; Found: 394.1.

4-(3-phenyl-1-(triethylsilyl)propyl)thiomorpholine (26). Method A: 3-phenyl propionaldehyde (67 mg, 0.5 mmol, 1.0 equiv.), thiomorpholine (52 mg, 0.5 mmol, 1.0 equiv.), and Et₃SiBpin (133 mg, 0.6 mmol, 1.1 equiv.). Purification: Strategy 1 (95:5 n-hex:EtOAc; Rf=0.7). Dark orange oil (132 mg, 0.393 mmol, 79%). ¹H NMR (400 MHz, CDCl₃) δ 7.30-7.24 (m, 2H), 7.19-7.13 (m, 3H), 2.92 (ddt, J=10.0, 7.9, 4.7 Hz, 4H), 2.84-2.73 (m, 1H), 2.65-2.55 (m, 5H), 2.08 (dd, J=9.9, 4.3 Hz, 1H), 1.95 (dtd, J=14.7, 9.8, 4.9 Hz, 1H), 1.60 (dddd, J=14.2, 10.6, 6.6, 4.3 Hz, 1H), 0.92 (t, J=7.9 Hz, 9H), 0.58 (qd, J=7.8, 3.2 Hz, 6H). ¹³C{¹H} NMR (100 MHz, CDCl₃) δ 146.2, 129.9, 127.9, 124.6, 112.0, 110.6, 77.5, 77.2, 76.8, 67.6, 62.8, 62.8, 54.3, 44.4, 12.7, 12.5, 7.8, 4.0. MS (EI) m/z: [M+] Calc'd for C₁₉H₃₃NSSi: 335.2103; Found: 335.1.

N,N-dibenzyl-3-phenyl-1-(triethylsilyl)propan-1-amine (27). Method A: 3-phenylpropionaldehyde (67 mg, 0.5 mmol, 1.0 equiv.), dibenzylamine (99 mg, 0.5 mmol, 1.0 equiv.), and Et₃SiBpin (133 mg, 0.6 mmol, 1.1 equiv.). Purification: Strategy 1 (85:15 n-hex:EtOAc; Rf=0.4). afforded the title compound as a transparent yellow (155 mg, 0.361 mmol, 72%). ¹H NMR (400 MHz, CDCl₃) δ 7.38-7.07 (m, 15H), 3.66 (d, J=1.4 Hz, 4H), 2.76 (ddd, J=13.4, 10.6, 5.4 Hz, 1H), 2.47-2.35 (m, 2H), 2.06 (dddd, J=13.2, 10.9, 7.5, 5.4 Hz, 1H), 1.75-1.64 (m, 1H), 0.91 (t, J=7.8 Hz, 9H), 0.77-0.60 (m, 6H). ¹³C{¹H} NMR (100 MHz, CDCl₃) δ 143.2, 129.2, 128.5, 128.4, 128.2, 126.9, 125.7, 77.4, 77.1, 76.8, 56.8, 47.6, 35.8, 29.4, 7.9, 4.1. MS (EI) m/z: [M+] Calc'd for C₂₉H₃₉NSi: 429.2852; Found: 429.3.

N-hexyl-N-(3-phenyl-1-(triethylsilyl)propyl)hexan-1-amine (28). Method A: 3-phenylpropionaldehyde (67 mg, 0.5 mmol, 1.0 equiv.), dihexylamine (93 mg, 0.5 mmol, 1.0 equiv.), and Et₃SiBpin (133 mg, 0.6 mmol, 1.1 equiv.). Purification: Strategy 1 (90:10 n-hex:EtOAc; Rf=0.6). Transparent clear oil (170 mg, 0.407 mmol, 81%). ¹H NMR (400 MHz, CDCl₃) δ 7.27-7.11 (m, 5H), 2.81 (ddd, J=13.4, 10.9, 5.1 Hz, 1H), 2.58-2.31 (m, 5H), 2.26 (dd, J=8.8, 4.9 Hz, 1H), 1.86-1.73 (m, 1H), 1.60 (ddt, J=13.8, 10.8, 5.4 Hz, 1H), 1.40-1.16 (m, 16H), 0.92 (t, J=7.9 Hz, 9H), 0.85 (t, J=6.8 Hz, 6H), 0.57 (qd, J=7.9, 5.1 Hz, 6H). ¹³C{¹H} NMR (100 MHz, CDCl₃) δ 143.5, 128.4, 128.3, 125.6, 77.4, 77.1, 76.8, 54.1, 50.8, 36.1, 32.1, 30.5, 30.0, 27.3, 22.9, 14.2, 8.0, 4.2. MS (EI) m/z: [M+] Calc'd for C₂₇H₅₁NSi: 417.4; Found: 417.3.

N-(3-phenyl-1-(triethylsilyl)propyl)cyclohexanamine (29). Method C: 3-phenylpropionaldehyde (67 mg, 0.5 mmol, 1.0 equiv.), cyclohexylamine (93 mg, 0.5 mmol, 1.0 equiv.), and Et₃SiBpin (133 mg, 0.6 mmol, 1.1 equiv.). Purification: Strategy 3. Afforded the title compound as a transparent orange oil (160 mg, 0.407 mmol, 75%). ¹H NMR (400 MHz, CDCl₃) δ 7.30-7.24 (m, 2H), 7.22-7.16 (m, 3H), 2.75 (ddd, J=13.6, 11.4, 5.5 Hz, 1H), 2.66-2.53 (m, 1H), 2.42 (tt, J=10.3, 3.8 Hz, 1H), 2.28 (dd, J=7.2, 4.9 Hz, 1H), 1.91-1.54 (m, 7H), 1.34-1.01 (m, 5H), 0.98 (t, J=7.9 Hz, 9H), 0.66-0.52 (m, 6H). ¹³C{¹H} NMR (100 MHz, CDCl₃) δ 128.5, 128.4, 128.3, 125.6, 77.4, 77.1, 76.8, 56.1, 42.3, 34.9, 34.9, 34.7, 33.7, 26.3, 25.4, 25.2, 7.9, 7.8, 2.6. MS (EI) m/z: [M+] Calc'd for C₂₁H₃₇NSi: 331.2695; Found: 331.1.

Methyl (3-phenyl-1-(triethylsilyl)propyl)-L-prolinate (30). Method D: 3-phenylpropionaldehyde (67 mg, 0.5 mmol, 1.0 equiv.), methyl L-prolinate (93 mg, 0.5 mmol, 1.0 equiv.), and Et₃SiBpin (133 mg, 0.6 mmol, 1.1 equiv.). Purification: Strategy 1 (85:15 n-hex:EtOAc; Rf=0.5). Afforded the title compound as a transparent orange oil (122 mg, 0.337 mmol, 67%). ¹H NMR (400 MHz, CDCl₃) δ 7.28 (d, J=7.0 Hz, 2H), 7.17 (dd, J=14.0, 7.3 Hz, 4H), 3.68 (s, 1H), 3.67 (s, 1H), 3.66-3.48 (m, 1H), 3.02-2.88 (m, 1H), 2.61 (ddt, J=17.7, 13.7, 6.2 Hz, 1H), 2.53-2.42 (m, 1H), 2.06-1.61 (m, 5H), 1.57 (d, J=2.6 Hz, 1H), 0.96 (dt, J=11.4, 7.9 Hz, 9H), 0.69-0.50 (m, 6H). ¹³C{¹H} NMR (100 MHz, CDCl₃) δ 176.0, 175.6, 143.7, 142.9, 128.6, 128.6, 128.4, 128.4, 128.3, 125.9, 125.5, 77.5, 77.2, 76.8, 64.9, 64.6, 51.6, 50.3, 49.4, 47.7, 34.8, 32.8, 29.9, 29.8, 29.3, 25.1, 24.8, 8.0, 7.9, 4.2, 4.2, 3.7, 3.6. MS (EI) m/z: [M+] Calc'd for C21H35NO2Si: 361.2437; Found: 361.2. [M-SiEt3]+ Calc'd for C₁₅H₂₀NO₂: 246.1489; Found: 246.1.

N,N-dibenzyl-1-phenyl-1-(triethylsilyl)methanamine (31). Method B: Benzaldehyde (53 mg, 0.5 mmol, 1.0 equiv.), dibenzylamine (99 mg, 0.5 mmol, 1.0 equiv.), and Et₃SiBpin (133 mg, 0.6 mmol, 1.1 equiv.). Purification: Strategy 1 (95:5 n-hex:EtOAc; Rf=0.35). Afforded the title compound as a transparent colorless oil (133 mg, 0.331 mmol, 66%). ¹H NMR (400 MHz, CDCl₃) δ 7.43-7.15 (m, 15H), 3.90 (d, J=13.6 Hz, 2H), 3.55 (s, 1H), 3.41 (d, J=13.6 Hz, 2H), 0.82 (t, J=7.9 Hz, 9H), 0.63 (qdd, J=8.5, 6.4, 3.9 Hz, 6H). ¹³C{¹H} NMR (100 MHz, CDCl₃) δ 140.4, 138.9, 131.1, 129.1, 128.4, 128.1, 127.0, 126.3, 77.5, 77.2, 76.9, 57.0, 56.2, 7.8, 3.8. MS (EI) m/z: [M+] Calc'd for C₂₅H₄₁NSi: 401.2539; Found: 401.3.

4-(phenyl(triethylsilyl)methyl)morpholine (32). Method A: Benzaldehyde (53 mg, 0.5 mmol, 1.0 equiv.), morpholine (44 mg, 0.5 mmol, 1.0 equiv.), and Et₃SiBpin (133 mg, 0.6 mmol, 1.1 equiv.). Purification: Strategy 1 (95:5 n-hex:EtOAc; Rf=0.5). afforded the title compound as a transparent clear oil (164 mg, 0.564 mmol, 91%). ¹H NMR (400 MHz, CDCl₃) δ 7.27-7.09 (m, 5H), 3.65 (td, J=4.8, 2.4 Hz, 4H), 2.98 (d, J=2.5 Hz, 1H), 2.54-2.38 (m, 4H), 0.87 (td, J=7.9, 2.5 Hz, 9H), 0.61-0.43 (m, 6H). ¹³C{¹H} NMR (100 MHz, CDCl₃) δ 141.7, 128.8, 128.1, 125.7, 125.1, 77.4, 77.1, 76.8, 67.5, 63.9, 54.5, 7.7, 3.8. MS (EI) m/z: [M+] Calc'd for C₁₇H₂₉NOSi: 291.2018; Found: 291.2.

4-((4-phenoxyphenyl)(triethylsilyl)methyl)morpholine (33). Method A: 4-phenoxybenzaldehyde (99 mg, 0.5 mmol, 1.0 equiv.), morpholine (44 mg, 0.5 mmol, 1.0 equiv.), and Et₃SiBpin (133 mg, 0.6 mmol, 1.1 equiv.). Purification: Strategy 1 (85:15 n-hex:EtOAc; Rf=0.5). Transparent clear oil (162 mg, 0.442 mmol, 85%). ¹H NMR (400 MHz, CDCl₃) δ 7.36-7.29 (m, 2H), 7.20-7.15 (m, 2H), 7.11-7.04 (m, 1H), 7.01-6.96 (m, 2H), 6.94-6.89 (m, 2H), 3.67 (t, J=4.7 Hz, 4H), 3.00 (d, J=2.8 Hz, 1H), 2.52 (dt, J=11.5, 4.6 Hz, 4H), 0.89 (t, J=7.9 Hz, 9H), 0.54 (tdd, J=15.0, 7.8, 5.9 Hz, 6H). ¹³C{¹H} NMR (100 MHz, CDCl₃) δ 155.0, 136.7, 129.9, 129.7, 129.7, 125.0, 122.9, 118.9, 118.5, 77.5, 77.2, 76.8, 67.6, 63.2, 54.5, 7.7, 3.9. MS (EI) m/z: [M+] Calc'd for C₂₃H₃₃NO₂Si: 383.2281; Found: 383.2.

N,N-diethyl-4-(morpholino (triethylsilyl)methyl)aniline (34). Method D: 4-(diethylamino)benzaldehyde (89 mg, 0.5 mmol, 1.0 equiv.), morpholine (44 mg, 0.5 mmol, 1.0 equiv.), and Et₃SiBpin (133 mg, 0.6 mmol, 1.1 equiv.). Purification: Strategy 1 (85:15 n-hex:EtOAc; Rf=0.5). afforded the title compound as a transparent yellow oil (172 mg, 0.474 mmol, 95%). ¹H NMR (400 MHz, CDCl₃) δ 7.02-6.96 (m, 2H), 6.62-6.56 (m, 2H), 3.65 (t, J=4.7 Hz, 4H), 3.31 (q, J=7.1 Hz, 4H), 2.88 (s, 1H), 2.55-2.36 (m, 4H), 1.14 (td, J=7.0, 1.3 Hz, 6H), 0.89 (td, J=7.9, 1.3 Hz, 9H), 0.54 (dtd, J=11.5, 8.7, 4.9 Hz, 6H). ¹³C{¹H} NMR (100 MHz, CDCl₃) δ 146.2, 129.9, 127.9, 112.0, 77.4, 77.1, 76.8, 67.7, 62.8, 54.3, 44.4, 12.7, 7.8, 4.0. MS (EI) m/z: [M+] Calc'd for C₂₁H₃₈N₂OSi: 362.2753; Found: 362.2.

4-(p-tolyl(triethylsilyl)methyl)morpholine (35). Method A: 4-methylbenzaldehyde (60 mg, 0.5 mmol, 1.0 equiv.), morpholine (44 mg, 0.5 mmol, 1.0 equiv.), and Et₃SiBpin (133 mg, 0.6 mmol, 1.1 equiv.). Purification: Strategy 1 (90:10 n-hex:EtOAc; Rf=0.6). Transparent clear oil (133 mg, 0.435 mmol, 87%). ¹H NMR (400 MHz, CDCl₃) δ 7.05 (q, J=8.2 Hz, 4H), 3.64 (t, J=4.7 Hz, 4H), 2.95 (s, 1H), 2.48 (dt, J=11.5, 4.7 Hz, 4H), 2.29 (s, 3H), 0.87 (t, J=7.9 Hz, 9H), 0.58-0.41 (m, 6H). ¹³C{¹H} NMR (100 MHz, CDCl₃) δ 138.5, 135.1, 128.8, 128.7, 77.5, 77.1, 76.8, 67.6, 63.4, 54.5, 24.9, 21.1, 7.7, 3.9. MS (EI) m/z: [M+] Calc'd for C₁₈H₃₁NOSi: 305.2175; Found: 305.2.

4-((4-chlorophenyl)(triethylsilyl)methyl)morpholine (36). Method A: 4-chlorobenzaldehyde (70 mg, 0.5 mmol, 1.0 equiv.), morpholine (44 mg, 0.5 mmol, 1.0 equiv.), and Et₃ SiBpin (133 mg, 0.6 mmol, 1.1 equiv.). Purification: Strategy 1 (85:15 n-hex:EtOAc; Rf=0.5). Transparent clear oil (122 mg, 0.375 mmol, 75%). ¹H NMR (400 MHz, CDCl₃) δ 7.28-7.16 (m, 2H), 7.16-7.11 (m, 2H), 3.64 (t, J=4.7 Hz, 4H), 2.96 (s, 1H), 2.45 (t, J=4.8 Hz, 4H), 0.87 (t, J=7.9 Hz, 9H), 0.58-0.40 (m, 6H). ¹³C{¹H} NMR (100 MHz, CDCl₃) δ 140.5, 131.2, 129.9, 128.5, 128.2, 77.4, 77.1, 76.8, 67.5, 63.2, 54.5, 7.7, 3.7. MS (EI) m/z: [M+] Calc'd for C₁₇H₂₈NClOSi: 325.1629; Found: 325.1.

4-((5-bromo-2-methoxyphenyl)(triethylsilyl)methyl)morpholine (37). Method D: 5-bromo-2-methoxybenzaldehyde (108 mg, 0.5 mmol, 1.0 equiv.), morpholine (44 mg, 0.5 mmol, 1.0 equiv.), and Et₃SiBpin (133 mg, 0.6 mmol, 1.1 equiv.). Purification: Strategy 1 (85:15 n-hex:EtOAc; Rf=0.5). Transparent clear oil (141 mg, 0.352 mmol, 70%). ¹H NMR (400 MHz, CDCl₃) δ 7.51 (d, J=2.6 Hz, 1H), 7.19 (dd, J=8.7, 2.6 Hz, 1H), 6.67 (d, J=8.6 Hz, 1H), 3.75 (s, 3H), 3.66 (td, J=4.5, 1.8 Hz, 4H), 3.60 (s, 1H), 2.54-2.38 (m, 4H), 0.87 (t, J=7.9 Hz, 9H), 0.62-0.41 (m, 6H). ¹³C{¹H} NMR (100 MHz, CDCl₃) δ 155.9, 132.9, 131.8, 128.7, 113.2, 111.9, 77.4, 77.1, 76.8, 67.6, 55.4, 54.4, 53.7, 7.6, 3.3. MS (EI) m/z: [M+] Calc'd for C₁₈H₃₀NO₂BrSi: 399.1229; Found: 399.0.

4-((2-methoxyphenyl)(triethylsilyl)methyl)morpholine (38). Method D: 2-methoxybenzaldehyde (68 mg, 0.5 mmol, 1.0 equiv.), morpholine (44 mg, 0.5 mmol, 1.0 equiv.), and Et₃SiBpin (133 mg, 0.6 mmol, 1.1 equiv.). Purification: Strategy 1 (85:15 n-hex:EtOAc; Rf=0.4). Transparent clear oil (141 mg, 0.439 mmol, 88%). ¹H NMR (400 MHz, CDCl₃) δ 7.37 (dd, J=7.6, 1.8 Hz, 1H), 7.09 (ddd, J=8.2, 7.3, 1.8 Hz, 1H), 6.88 (td, J=7.5, 1.2 Hz, 1H), 6.79 (dd, J=8.2, 1.2 Hz, 1H), 3.76 (s, 3H), 3.68-3.60 (m, 5H), 2.56-2.37 (m, 4H), 0.86 (t, J=7.9 Hz, 9H), 0.61-0.38 (m, 6H). ¹³C{¹H} NMR (100 MHz, CDCl₃) δ 156.9, 130.0, 129.6, 126.1, 120.4, 110.2, 77.4, 77.1, 76.8, 67.7, 55.2, 54.4, 53.7, 7.7, 3.5. MS (EI) m/z: [M+] Calc'd for C₁₈H₃₁NO₂Si: 321.2124; Found: 321.2.

4-((2,4-dimethoxyphenyl)(triethylsilyl)methyl)morpholine (39). Method D: 2,4-dimethoxybenzaldehyde (83 mg, 0.5 mmol, 1.0 equiv.), morpholine (44 mg, 0.5 mmol, 1.0 equiv.), and Et₃SiBpin (133 mg, 0.6 mmol, 1.1 equiv.). Purification: Strategy 1 (85:15 n-hex:EtOAc; Rf=0.5). Transparent clear oil (143 mg, 0.407 mmol, 81%). ¹H NMR (400 MHz, CDCl₃) δ 7.29-7.19 (m, 1H), 6.51-6.37 (m, 2H), 3.79 (d, J=1.2 Hz, 3H), 3.78-3.73 (m, 3H), 3.68-3.56 (m, 5H), 2.49 (dt, J=9.8, 4.7 Hz, 4H), 0.94-0.83 (m, 9H), 0.52 (ddt, J=19.0, 15.1, 7.4 Hz, 6H). ¹³C{¹H} NMR (100 MHz, CDCl₃) δ 158.5, 158.0, 130.2, 121.8, 104.1, 98.0, 77.5, 77.1, 76.8, 67.6, 55.2, 55.1, 54.2, 53.1, 7.7, 3.6. MS (EI) m/z: [M+] Calc'd for C₁₉H₃₃NO₃Si: 351.2230; Found: 351.2.

4-(thiophen-2-yl(triethylsilyl)methyl)morpholine (40). Method A: thiophene-2-carbaldehyde (56 mg, 0.5 mmol, 1.0 equiv.), morpholine (44 mg, 0.5 mmol, 1.0 equiv.), and Et₃SiBpin (133 mg, 0.6 mmol, 1.1 equiv.). Purification: Strategy 1 (85:15 n-hex:EtOAc; Rf=0.6). Transparent clear oil (129 mg, 0.434 mmol, 87%). ¹H NMR (400 MHz, CDCl₃) δ 7.14 (dt, J=5.1, 1.0 Hz, 1H), 6.92 (dd, J=5.1, 3.4 Hz, 1H), 6.75 (dd, J=3.5, 1.2 Hz, 1H), 3.66 (ddd, J=5.7, 3.6, 2.0 Hz, 4H), 3.47 (s, 1H), 2.62-2.53 (m, 2H), 2.51-2.41 (m, 2H), 0.93 (t, J=7.9 Hz, 9H), 0.68-0.57 (m, 6H). MS (EI) m/z: [M+] Calc'd for C₁₅H₂₇NOSSi: 297.1583; Found: 297.1.

4-((1-methyl-1H-pyrazol-4-yl)(triethylsilyl)methyl)morpholine (41). Method D: 1-methyl-1H-pyrazole-4-carbaldehyde (55 mg, 0.5 mmol, 1.0 equiv.), morpholine (44 mg, 0.5 mmol, 1.0 equiv.), and Et₃SiBpin (133 mg, 0.6 mmol, 1.1 equiv.). Purification: Strategy 1 (85:15 n-hex:EtOAc; Rf=0.6). Transparent yellow oil (123 mg, 0.416 mmol, 83%). ¹H NMR (400 MHz, CDCl₃) δ 7.27 (s, 1H), 7.12 (s, 1H), 3.87 (s, 3H), 3.71-3.58 (m, 4H), 3.12 (s, 1H), 2.50 (ddd, J=10.9, 5.5, 3.4 Hz, 2H), 2.35 (dt, J=10.7, 5.0 Hz, 2H), 0.93 (t, J=7.9 Hz, 9H), 0.58 (qd, J=7.9, 2.5 Hz, 6H). ¹³C{¹H} NMR (100 MHz, CDCl₃) δ 140.4, 129.5, 118.0, 77.5, 77.4, 77.2, 76.9, 67.4, 53.1, 52.2, 38.9, 7.7, 3.8. MS (EI) m/z: [M+] Calc'd for C₁₅H₂₉N₃OSi: 295.2080; Found: 295.2.

4-(thiazol-2-yl(triethylsilyl)methyl)morpholine (42). Method D: thiazole-2-carbaldehyde (57 mg, 0.5 mmol, 1.0 equiv.), morpholine (44 mg, 0.5 mmol, 1.0 equiv.), and Et₃SiBpin (133 mg, 0.6 mmol, 1.1 equiv.). Purification: Strategy 1 (90:10 n-hex:EtOAc; Rf=0.5). Transparent yellow oil (126 mg, 0.422 mmol, 84%). ¹H NMR (400 MHz, CDCl₃) δ 7.65 (d, J=3.4 Hz, 1H), 7.20 (d, J=3.3 Hz, 1H), 3.73 (s, 1H), 3.68 (dd, J=5.7, 3.6 Hz, 4H), 2.62 (dd, J=5.7, 3.6 Hz, 5H), 0.92 (t, J=7.9 Hz, 9H), 0.73-0.54 (m, 8H). ¹³C{¹H} NMR (100 MHz, CDCl₃) & 172.2, 141.9, 118.5, 77.4, 77.1, 76.8, 67.5, 61.1, 53.9, 7.6, 3.5. MS (EI) m/z: [M+] Calc'd for C₁₄H₂₆N₂OSSi: 298.1535; Found: 298.1.

4-((1-methyl-1H-indol-3-yl)(triethylsilyl)methyl)morpholine (43). Method D: 1-methyl-1H-indole-3-carbaldehyde (57 mg, 0.5 mmol, 1.0 equiv.), morpholine (44 mg, 0.5 mmol, 1.0 equiv.), and Et₃SiBpin (133 mg, 0.6 mmol, 1.1 equiv.). Purification: Strategy 1 (85:15 n-hex:EtOAc; Rf=0.5). a transparent yellow oil (154 mg, 0.447 mmol, 89%). ¹H NMR (400 MHz, CDCl₃) δ 7.68 (dd, J=7.9, 1.2 Hz, 1H), 7.30-7.23 (m, 1H), 7.19 (ddd, J=8.2, 6.9, 1.2 Hz, 1H), 7.07 (ddd, J=8.0, 6.9, 1.2 Hz, 1H), 6.84 (s, 1H), 3.76 (s, 3H), 3.69-3.58 (m, 4H), 3.51 (s, 1H), 2.49 (dd, J=11.1, 6.2 Hz, 4H), 0.90 (t, J=7.9 Hz, 9H), 0.58 (q, J=8.0 Hz, 6H). ¹³C{¹H} NMR (100 MHz, CDCl₃) δ 129.3, 127.6, 121.4, 121.43, 119.9, 118.6, 109.0, 77.5, 77.2, 76.9, 67.6, 53.8, 52.6, 32.9, 7.9, 4.2. MS (EI) m/z: [M+] Calc'd for C₂₀H₃₂N₂OSi: 344.2284; Found: 344.2.

4-((1H-indol-6-yl)(triethylsilyl)methyl)morpholine (44). Method A: 1 1H-indole-6-carbaldehyde (73 mg, 0.5 mmol, 1.0 equiv.), morpholine (44 mg, 0.5 mmol, 1.0 equiv.), and Et₃SiBpin (133 mg, 0.6 mmol, 1.1 equiv.). Purification: Strategy 1 (85:15 n-hex:EtOAc; Rf=0.6). Dark brown oil (155 mg, 0.450 mmol, 89%). ¹H NMR (400 MHz, CDCl₃) δ 8.06 (s, 1H), 7.50 (d, J=8.1 Hz, 1H), 7.25 (s, 1H), 7.15 (t, J=2.8 Hz, 1H), 6.99 (dd, J=8.1, 1.4 Hz, 1H), 6.50 (ddd, J=3.1, 2.0, 0.9 Hz, 1H), 3.66 (t, J=4.7 Hz, 4H), 3.07 (s, 1H), 2.54 (dd, J=11.3, 4.7 Hz, 4H), 0.88 (t, J=7.9 Hz, 9H), 0.54 (tdd, J=15.0, 11.6, 7.3 Hz, 6H). ¹³C{¹H} NMR (100 MHz, CDCl₃) δ 136.3, 135.7, 126.2, 123.8, 121.6, 120.1, 110.8, 102.3, 77.5, 77.1, 76.8, 67.6, 64.1, 54.68, 7.8, 4.0. MS (EI) m/z: [M+] Calc'd for C₁₉H₃₀N₂OSi: 330.2127; Found: 330.2.

2-methyl-N-(phenyl(triethylsilyl)methyl)propan-2-amine (45). Method C: Benzaldehyde (53 mg, 0.5 mmol, 1.0 equiv.), tert-butylamine (37 mg, 0.5 mmol, 1.0 equiv.), and Et₃SiBpin (133 mg, 0.6 mmol, 1.1 equiv.). Purification: Strategy 1 (85:15 n-hex:EtOAc; Rf=0.6). Transparent clear oil (125 mg, 0.450 mmol, 90%). ¹H NMR (400 MHz, CDCl₃) δ 7.27-7.17 (m, 4H), 7.08-7.02 (m, 1H), 3.55 (s, 1H), 0.98-0.81 (m, 20H), 0.57-0.43 (m, 6H). ¹³C{¹H} NMR (100 MHz, CDCl₃) δ 147.3, 127.6, 126.8, 124.4, 77.4, 77.1, 76.8, 52.8, 47.6, 30.0, 7.5, 1.7. MS (EI) m/z: [M+] Calc'd for C₁₇H₃₁NSi: 277.2226; Found: 277.1. [M-SiEt₃]+ Calc'd for C₁₁H₁₆N: 162.1277; Found: 162.1.

8-chloro-11-(1-(3-phenyl-1-(triethylsilyl)propyl)piperidin-4-ylidene)-6,11-dihydro-5Hbenzo[5,6] cyclohepta[1,2-b]pyridine (46). Method A: 3-phenylpropionaldehyde (67 mg, 0.5 mmol, 1.0 equiv.), 8-chloro-11-(piperidin-4-ylidene)-6,11-dihydro-5H-benzo[5,6] cyclohepta[1,2-b]pyridine (155 mg, 0.5 mmol, 1.0 equiv.), and Et₃SiBpin (133 mg, 0.6 mmol, 1.1 equiv.). Purification: Strategy 1 (85:15 n-hex:EtOAc; Rf=0.6). Transparent red oil (220 mg, 0.405 mmol, 81%). ¹H NMR (400 MHz, CDCl₃) δ 8.36 (d, J=4.8 Hz, 1H), 7.37 (dd, J=7.7, 1.7 Hz, 1H), 7.22 (t, J=7.4 Hz, 2H), 7.17-7.05 (m, 6H), 7.02 (dd, J=7.7, 4.8 Hz, 1H), 3.36 (dddd, J=20.7, 14.0, 9.6, 5.8 Hz, 2H), 2.74 (tdq, J=14.7, 10.2, 5.4 Hz, 5H), 2.62-2.22 (m, 7H), 2.15 (ddd, J=9.2, 5.0, 2.4 Hz, 1H), 1.91 (dtd, J=14.3, 9.5, 4.4 Hz, 1H), 1.56 (ddt, J=14.9, 10.8, 5.6 Hz, 1H), 1.32-1.15 (m, 2H), 0.89 (t, J=8.0 Hz, 9H), 0.54 (qd, J=7.6, 4.0 Hz, 6H). ¹³C{¹H} NMR (100 MHz, CDCl₃) δ 158.0, 157.9, 146.7, 145.6, 143.0, 143.0, 139.8, 139.8, 139.6, 138.2, 138.1, 137.3, 137.2, 133.5, 132.6, 132.4, 131.1, 131.1, 129.0, 129.0, 128.5, 128.5, 128.51, 128.4, 126.0, 125.7, 122.1, 77.5, 77.2, 76.8, 54.4, 54.3, 54.1, 54.1, 53.0, 52.9, 36.3, 36.2, 32.4, 32.3, 32.3, 32.1, 32.0, 31.9, 31.6, 31.5, 29.8, 29.4, 29.3, 29.0, 28.8, 7.98, 4.1. MS (EI) m/z: [M+] Calc'd for C₃₄H₄₃N₂ClSi: 542.2884; Found: 542.4.

5,6-dimethoxy-2-((1-(3-phenyl-1-(triethylsilyl)propyl)piperidin-4-yl)methyl)-2,3-dihydro-1H-inden-1-one (47). Method A: 3-phenylpropionaldehyde (67 mg, 0.5 mmol, 1.0 equiv.), 5,6-dimethoxy-2-(piperidin-4-ylmethyl)-2,3-dihydro-1H-inden-1-one (145 mg, 0.5 mmol, 1.0 equiv.), and Et₃SiBpin (133 mg, 0.6 mmol, 1.1 equiv.). Purification: Strategy 1 (70:30 nhex:EtOAc; Rf=0.7). Afforded the title compound as a transparent yellow oil (200 mg, 0.383 mmol, 77%). ¹H NMR (400 MHz, CDCl₃) δ 7.30 (d, J=4.3 Hz, 3H), 7.24-7.15 (m, 2H), 7.13 (s, 1H), 6.86 (d, J=3.4 Hz, 1H), 3.97 (d, J=1.3 Hz, 3H), 3.91 (d, J=2.9 Hz, 3H), 3.60-3.09 (m, 2H), 2.99-2.60 (m, 5H), 2.48-2.29 (m, 2H), 2.16-1.70 (m, 4H), 1.59 (s, 3H), 1.08-0.94 (m, 9H), 0.92-0.53 (m, 6H). ¹³C{¹H} NMR (100 MHz, CDCl₃) δ 208.1, 155.4, 149.4, 148.9, 143.1, 129.4, 128.5, 128.3, 125.6, 107.4, 104.3, 77.5, 77.2, 76.9, 56.2, 56.1, 54.4, 54.4, 53.5, 51.6, 45.5, 39.0, 36.2, 36.2, 34.7, 34.7, 34.5, 34.3, 33.3, 33.1, 32.8, 29.5, 7.9, 4.4, 4.2. MS (EI) m/z: [M-SiEt₃]+ Calc'd for C₂₆H₃₂NO₃: 406.2382; Found: 406.2.

5,6-dimethoxy-2-((1-(phenyl(triethylsilyl)methyl)piperidin-4-yl)methyl)-2,3-dihydro-1H-inden-1-one (48). Method A: Benzaldehyde (53 mg, 0.5 mmol, 1.0 equiv.), 5,6-dimethoxy-2-(piperidin-4-ylmethyl)-2,3-dihydro-1H-inden-1-one (145 mg, 0.5 mmol, 1.0 equiv.), and Et₃SiBpin (133 mg, 0.6 mmol, 1.1 equiv.). Purification: Strategy 1 (85:15 nhex:EtOAc; Rf=0.5). Transparent clear oil (186 mg, 0.377 mmol, 75%). ¹H NMR (400 MHz, CDCl₃) δ 7.26-7.11 (m, 6H), 6.84 (d, J=2.1 Hz, 1H), 3.96 (s, 3H), 3.90 (s, 3H), 3.27-3.06 (m, 2H), 3.00 (d, J=1.8 Hz, 1H), 2.81 (d, J=10.7 Hz, 1H), 2.68 (d, J=14.8 Hz, 2H), 2.21-2.08 (m, 1H), 1.94-1.84 (m, 1H), 1.81-1.72 (m, 1H), 1.63 (dd, J=27.5, 11.6 Hz, 1H), 1.46-1.14 (m, 7H), 0.88 (td, J=7.8, 0.9 Hz, 9H), 0.52 (qd, J=7.7, 3.9 Hz, 6H). ¹³C NMR (100 MHz, CDCl₃) δ 207.8, 155.4, 149.4, 148.8, 142.5, 142.5, 129.3, 128.8, 127.9, 125.4, 107.4, 104.3, 77.6, 77.3, 77.0, 65.9, 63.8, 56.2, 56.0, 54.7, 54.7, 54.3, 54.3, 45.5, 45.5, 38.8, 38.7, 34.5, 34.4, 33.9, 33.8, 33.3, 33.2, 32.5, 32.4, 24.9, 15.3, 7.7, 3.9. MS (EI) m/z: [M-SiEt₃]+ Calc'd for C₂₄H₂₈NO₃: 378.2069; Found: 378.2.

1-cyclopropyl-6-fluoro-4-oxo-7-(4-(3-phenyl-1-(triethylsilyl)propyl)piperazin-1-ium-1-yl)-1,4-dihydroquinoline-3-carboxylate (49). Method B: 3-phenylpropionaldehyde (67 mg, 0.5 mmol, 1.0 equiv.), (155 mg, 0.5 mmol, 1.0 equiv.), and Et₃SiBpin (133 mg, 0.6 mmol, 1.1 equiv.). Purification: filtration through a plug of neutral alumina using 15 mL Et₂O as eluent. Product was eluted with 10 mL CHCl₃. Evaporation under reduced pressured afforded the title compound as a yellow solid (220 mg, 0.405 mmol, 81%). ¹H NMR (400 MHz, CDCl₃) δ 8.78 (s, 1H), 8.06-7.99 (m, 1H), 7.37-7.27 (m, 3H), 7.23-7.17 (m, 3H), 3.54 (dt, J=7.0, 3.3 Hz, 1H), 3.33-3.27 (m, 4H), 2.94-2.78 (m, 5H), 2.67 (ddd, J=13.5, 9.7, 6.5 Hz, 1H), 2.25 (dd, J=9.3, 4.5 Hz, 1H), 2.02 (dtd, J=14.5, 9.6, 5.1 Hz, 1H), 1.70 (tq, J=10.4, 6.0 Hz, 1H), 1.40 (t, J=6.7 Hz, 2H), 1.27 (d, J=3.3 Hz, 1H), 1.23-1.18 (m, 2H), 0.98 (t, J=7.9 Hz, 9H), 0.65 (qd, J=7.9, 2.7 Hz, 6H). ¹³C{¹H} NMR (100 MHz, CDCl₃) δ 176.9, 167.1, 155.0, 152.5, 147.3, 146.32, 146.2, 142.6, 139.1, 128.5, 128.4, 125.8, 112.1, 111.9, 107.8, 104.8, 77.5, 77.2, 76.9, 54.2, 51.5, 50.8, 50.8, 36.1, 35.4, 29.3, 24.9, 24.7, 8.2, 7.9, 4.1.

### Example 3

Equimolar concentrations of morpholine, 3-phenylpropanal, bis(pinacolato)diboron (B₂Pin₂ or BPin-BPin) were combined with 10 mol % (Ligand)CuCl as a catalyst in acetonitrile at 82° C. for 16 hours as shown in Scheme 9.

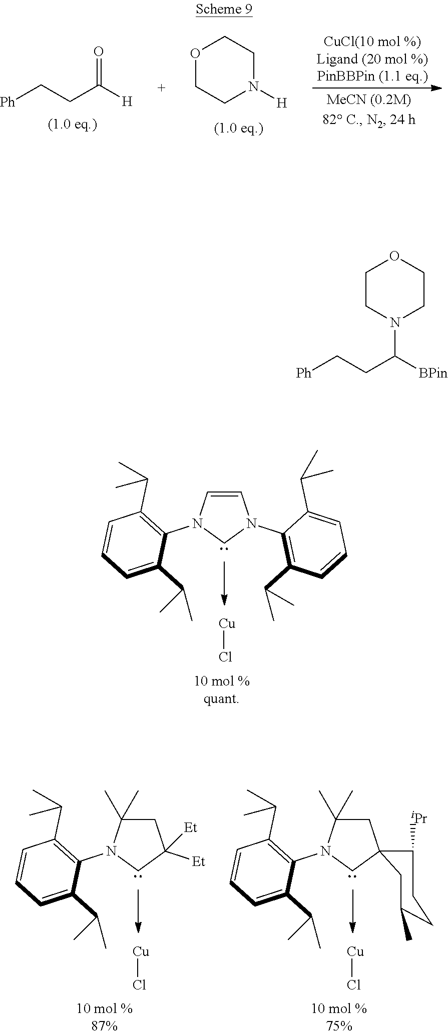

Quantitative formation of 1,1-aminoborane was observed by gas chromatography-mass spectrometry (GC-MS) with further confirmation by NMR with 10 mol % (IPr)CuCl (Cat1). High yields of 1,1-aminoborane was also observed with copper catalysts bearing cyclic(alkyl)(amino)carbene (CAAC) ligands, such as ^{Et}CAAC₆ (87% yield), or bicyclic(alkyl)(amino)carbenes (BICAACs) ligands, such as ^{iPr}BiCAAC (75% yield).

FIGS. 4A, 4B, 4C, and 4D include listings of products of the aminoboration reaction on a 0.5 mmol scale, illustrating the scope and variability of the functional groups, according to the Examples. With regard to the aldehyde, both aliphatic and aromatic aldehydes (including aryl aldehydes or heteroaryl aldehydes) are compatible. Specifically, FIG. 4A shows the reaction of amine (1.0 equiv.), aliphatic aldehyde (1.0 equiv.), bis(pinacolato)diboron (B₂Pin₂, 1.1 equiv.) combined with 2.5 mol % (IPr)CuCl (Cat1) as a catalyst in acetonitrile at 50° C. for 16 hours under nitrogen atmosphere. Specifically, FIG. 4B shows the reaction of amine (1.0 equiv.), aromatic aldehyde (1.0 equiv.), bis(pinacolato)diboron (B₂Pin₂, 1.1 equiv.) combined with 2.5 mol % (^{Et}CAAC₆)CuCl (Cat2) as a catalyst in acetonitrile at 80° C. for 48 hours under nitrogen atmosphere. FIG. 4C shows that diastereoselective 1,1-aminoborylation was also possible with substituted morpholine (1.0 equiv.), aliphatic aldehyde (1.0 equiv.), bis(pinacolato)diboron (B₂Pin₂, 1.1 equiv.) combined with 2.5 mol % (IPr)CuCl (Cat1) as a catalyst in acetonitrile at 50° C. for 16 hours under nitrogen atmosphere. FIG. 4D also shows that it was also possible to isolate the 1,1-aminoborane product as an hydrochloric acid salt following treatment with hydrochloric acid. All yields given are of isolated products.

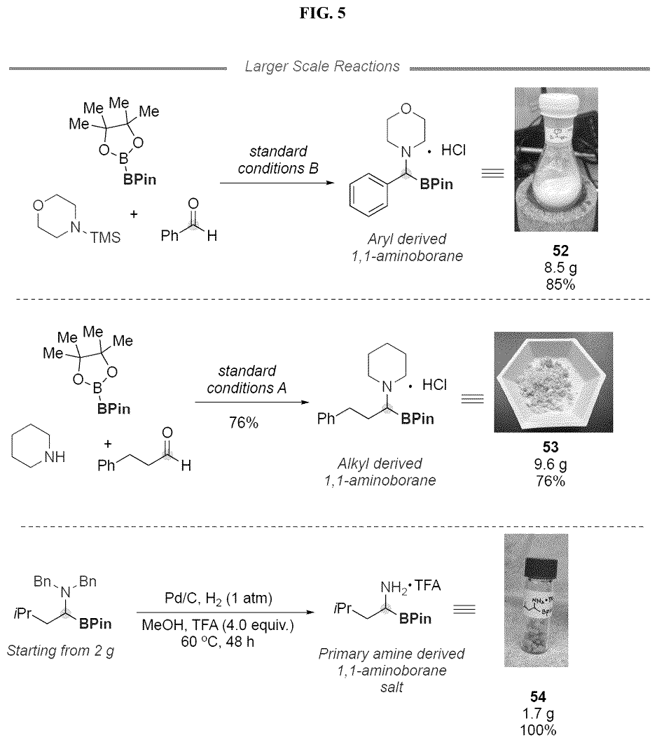

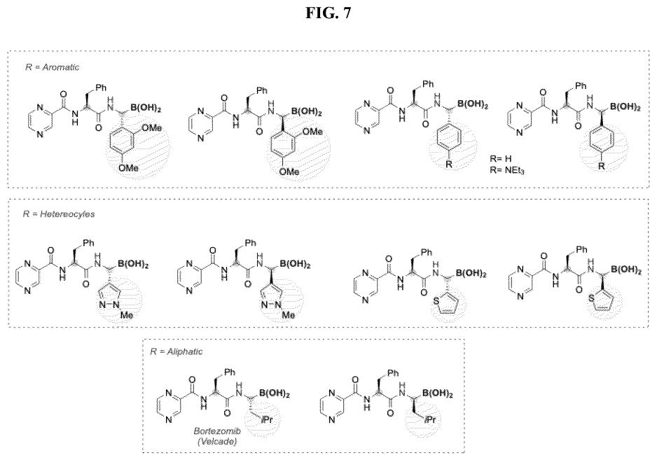

FIG. 5 illustrates several larger scale reactions to prepare aryl derived 1,1-aminoboranes and primary amine derived 1,1-aminoboranes salts, according to the Examples (such as those described in Example 4). Isolated yields are provided. FIG. 6 illustrates the post-synthetic diversification of the described 1,1-aminoborane products, including but not limited to vinylation, alkylation, saponification, photoredox cross-coupling, Suzuki-coupling, inner salt preparation, homologation/oxidation, and deuteration. FIG. 7 also illustrates the utility of the 1,1-aminoboronation reaction described herein for the preparation of bortezomib and novel derivatives.

Scheme 10 shows that trimethylsilyl-substituted amines are also compatible with the 1,1 aminoborylation described below as described in standard conditions B in Example 4. Additionally, the use of catalytic amount of 4,4,5,5-tetramethyl-2-phenoxy-1,3,2-dioxaborolane (PhOBPin) in the reaction was shown to increase the amount of desired 1,1-aminoborane. Specifically, for the reaction of 3-phenylpropanal (0.1 mmol), TMS-morpholine (0.1 mmol), B₂Pin₂ (0.11 mmol) in the presence of 10 mol % (^{Et}CAAC₆)CuCl (Cat2) in MeCN (0.2 M) at 82° C. provided the desired aminoborylation product. It is believed that the reaction is generating small amounts of water and as a result yielding the undesired protodeboronation by-product. To prevent undesired protodeboronation, at least 20 mol % of PhOBPin (e.g., 20 mol %, 50 mol %, and 100 mol %) was shown to react with any water formed in the reaction and suppress protodeboronation. When less than 20 mol % of PhOBPin is used the protodeboronation is still present.

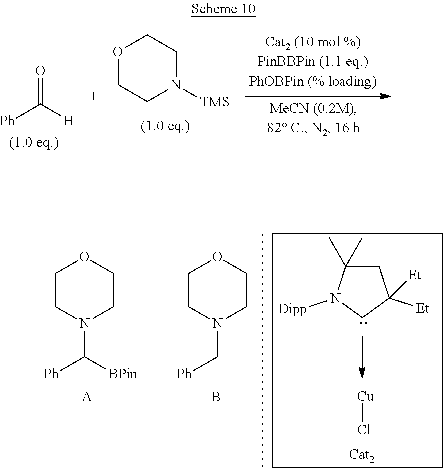

### Example 4. Methods (A and B) were Used to Prepare the Boranes

Method A: An oven dried 1-dram vial equipped with a magnetic stir bar was charged with Cat1 (6.1 mg, 0.0125 mmol, 2.5 mol %), B₂Pin₂ (133 mg, 0.6 mmol, 1.1 equiv.), and MeCN (3.0 mL, 0.17 M). The solution was allowed to stir for 2 minutes at ambient temperature. Then, amine (0.50 mmol, 1.0 equiv.) and alkyl aldehyde (0.5 mmol, 1.0 equiv.) were added in that order. The reaction vial was capped with a PTFE lined screw cap and removed from the glovebox. The reaction was stirred for 16 hours on a hot plate preheated to 50° C. After 16 hours, the solution was allowed to cool to room temperature and taken into the glovebox volatiles in the reaction mixture were concentrated under reduced pressure. Then 4 mL of a 1:1 hexane/Et₂O mixture was added to the vial to dissolve form a heterogenous mixture. The resulting heterogenous solution was then filtered through a Pasteur pipette containing 3 cm neutral dry celite. Washing with 2×3 mL of a 1:1 hexane/Et₂O mixture. The combined filtrate was concentrated under reduced pressure.

To the crude mixture, was added a magnetic stir bar followed by 3 mL of Et₂O and sealed with a cap containing a septum. The vial is then taken out of the glovebox and cooled to 0° C. before adding HCl in dioxanes (0.15 mL, 0.6 mmol, 1.2 equiv.) which upon addition turns into immediate precipitation and allowed to stir vigorously for 30 minutes at room temperature. After 30 minutes, the solids were then filtered through a Pasteur pipette containing 3 cm of celite and washed with 10 mL of Et₂O. (NOTE: If the mother liquor turns cloudy after filtration, then, the solution is passed though the same celite plug until filtrate is kept consistently clear). The solids are dissolved with DCM (ca. 3-5 mL), and the solvent is removed under reduced pressure followed by drying under high vacuum for 60 minutes. The vial containing the crude solid is then brought into the glovebox and a magnetic stir bar was added followed by 3 mL of Et₂O. Then, Et₃N (0.21 mL, 1.5 mmol, 3.0 equiv.), was added in one-portion and the solution was stirred vigorously for 1 hour at ambient temperature. After 1 h, stirring is stopped, and the solution is filtered through a Pasteur pipette containing 1 cm of dry celite and washed with 1 mL of dry Et₂O. The filtrate is then evaporated under high vacuum and azeotrope with Et₂O (3×2 mL) to yield pure 1,1-aminoborane products.

Method B: An oven dried 1-dram vial equipped with a magnetic stir bar was charged with Cat2 (00.0125 mmol, 2.5 mol %), B₂Pin₂ (133 mg, 0.6 mmol, 1.1 equiv.), and MeCN (3.0 mL, 0.17 M). The solution was allowed to stir for 2 minutes at ambient temperature. Then, trimethylsilylamine (0.50 mmol, 1.0 equiv.) and aldehyde (0.5 mmol, 1.0 equiv.) were added in that order. The reaction vial was capped with a PTFE lined screw cap and removed from the glovebox. The reaction was stirred for 16 hours on a hot plate preheated to 82° C. After 16 hours, the solution was allowed to cool to room temperature and volatiles in the reaction mixture were concentrated under reduced pressure.

To the crude mixture, was added a magnetic stir bar followed by 3 mL of Et₂O and sealed with a cap containing a septum. The vial is then taken out of the glovebox and cooled to 0° C. before adding HCl in dioxanes (0.15 mL, 0.6 mmol, 1.2 equiv.) which upon addition turns into immediate precipitation and allowed to stir vigorously for 30 minutes at room temperature. After 30 minutes, the solids were then filtered through a Pasteur pipette containing 3 cm of celite and washed with 10 mL of Et₂O. (NOTE: If the mother liquor turns cloudy after filtration, then, the solution is passed though the same celite plug until filtrate is kept consistently clear). The solids are dissolved with DCM (ca. 3-5 mL) and the solvent is removed under reduced pressure followed by drying under high vacuum for 60 minutes. The vial containing the crude solid is then brought into the glovebox and a magnetic stir bar was added followed by 3 mL of Et₂O. Then, Et₃N (0.21 mL, 1.5 mmol, 3.0 equiv.), was added in one-portion and the solution was stirred vigorously for 1 hour at ambient temperature. After 1 h, stirring is stopped, and the solution is filtered through a Pasteur pipette containing 1 cm of dry celite and washed with 1 mL of dry Et₂O. The filtrate is then evaporated under high vacuum and azeotrope with Et₂O (3×2 mL) to yield pure 1,1-aminoborane products.

Two purification strategies (1-2) used to purify the boranes.

Strategy 1: Dissolution of the crude oil in 3 mL Et₂O followed by addition of 0.15 mL of a 4 M HCl_{(dioxane)} solution to precipitate the desired product. The solids are then washed with 20 mL of Et₂O. (NOTE: If the mother liquor turns cloudy after filtration, then, the solution is passed though the same celite plug until filtrate is kept consistently clear). The solids are dissolved with DCM (ca. 3-5 mL) and the solvent is removed under reduced pressure followed by drying under high vacuum for 30 minutes. The vial containing the crude solid is then brought into the glovebox and a magnetic stir bar was added followed by 3 mL of Et₂O. Then, Et₃N was added in one-portion and the solution was stirred vigorously for 1 hour at ambient temperature. After 1 h, stirring was stopped and the solution is filtered through a Pasteur pipette containing 1 cm neutral dry celite and washed with 1 mL of dry Et₂O. The filtrate is then evaporated under high vacuum and azeotrope with Et₂O (3×2 mL) to yield pure 1,1-aminoborane products.

Strategy 2: Dissolution of the crude oil in 3 mL Et₂O followed by addition of 0.15 mL of a 4 M HCl_{(dioxane)} solution to precipitate the desired product. The solids are washed with ca. 20 mL of Et₂O. (NOTE: If the mother liquor turns cloudy after filtration, then, the solution is passed though the same celite plug until filtrate is kept consistently clear). The solids are then dried overnight under high vacuum to yield the desired HCl salts.

4-(3-phenyl-1-(4,4,5,5-tetramethyl-1,3,2-dioxaborolan-2-yl)propyl)morpholine. Method A: 3-phenylpropionaldehyde (67 mg, 0.5 mmol, 1.0 equiv.), morpholine (44 mg, 0.5 mmol, 1.0 equiv.), and B₂Pin₂ (133 mg, 0.6 mmol, 1.1 equiv.). Purification: Strategy 1. Transparent clear oil. ¹H NMR (400 MHz, CDCl₃) δ 7.27 (dd, J=8.1, 6.9 Hz, 2H), 7.18 (d, J=7.0 Hz, 3H), 3.73 (t, J=4.7 Hz, 4H), 2.70 (dt, J=13.7, 8.8 Hz, 1H), 2.64-2.53 (m, 3H), 2.53-2.45 (m, 2H), 2.08 (dd, J=7.8, 6.4 Hz, 1H), 1.96-1.85 (m, 2H), 1.29 (d, J=2.4 Hz, 12H). ¹³C{¹H} NMR (100 MHz, CDCl₃) δ 142.53, 128.32, 128.30, 125.72, 83.63, 67.23, 52.74, 33.20, 29.89, 24.98, 24.86.

4-(3-methyl-1-(4,4,5,5-tetramethyl-1,3,2-dioxaborolan-2-yl)butyl)morpholine. Method A: isovaleroaldehyde (43 mg, 0.5 mmol, 1.0 equiv.), morpholine (44 mg, 0.5 mmol, 1.0 equiv.), and B₂Pin₂ (133 mg, 0.6 mmol, 1.1 equiv.). Purification: Strategy 1. Clear oil. ¹H NMR (400 MHz, CDCl₃) δ 3.70 (t, J=4.7 Hz, 4H), 2.59 (dt, J=11.5, 4.7 Hz, 2H), 2.46 (dt, J=11.2, 4.7 Hz, 2H), 2.07 (dd, J=8.6, 7.1 Hz, 1H), 1.58 (dh, J=8.1, 6.5 Hz, 1H), 1.48-1.40 (m, 2H), 1.26 (d, J=1.5 Hz, 12H), 0.89 (dd, J=6.5, 2.9 Hz, 6H). ¹³C{¹H} NMR (100 MHz, CDCl₃) δ 83.56, 67.46, 52.93, 37.32, 26.43, 25.06, 24.95, 23.74, 22.49.

4-(2-methyl-1-(4,4,5,5-tetramethyl-1,3,2-dioxaborolan-2-yl)propyl)morpholine. Method A: Isobutyraldehyde (43 mg, 0.5 mmol, 1.0 equiv.), morpholine (44 mg, 0.5 mmol, 1.0 equiv.), and B₂Pin₂ (133 mg, 0.6 mmol, 1.1 equiv.). Purification: Strategy 1. Clear oil. ¹H NMR (400 MHz, CDCl₃) δ 3.71 (t, J=4.7 Hz, 4H), 2.48 (ddt, J=44.3, 11.1, 4.8 Hz, 4H), 2.01 (h, J=6.9 Hz, 1H), 1.77 (d, J=7.4 Hz, 1H), 1.28 (s, 12H), 0.94 (dd, J=6.8, 4.0 Hz, 6H). ¹³C{¹H} NMR (100 MHz, CDCl₃) δ 83.65, 83.63, 67.39, 67.37, 53.32, 53.31, 26.21, 25.16, 25.14, 21.05, 19.26.

4-(2-ethyl-1-(4,4,5,5-tetramethyl-1,3,2-dioxaborolan-2-yl)butyl)morpholine. Method A: 2-ethylbutanal (43 mg, 0.5 mmol, 1.0 equiv.), morpholine (44 mg, 0.5 mmol, 1.0 equiv.), and B₂Pin₂ (133 mg, 0.6 mmol, 1.1 equiv.). Purification: Strategy 1. Clear oil. ¹H NMR (400 MHz, CDCl₃) δ 3.69 (t, J=4.7 Hz, 4H), 2.48 (tdd, J=16.1, 11.0, 4.7 Hz, 4H), 1.99 (s, 1H), 1.63-1.41 (m, 3H), 1.33 (dt, J=13.8, 7.0 Hz, 2H), 1.27 (d, J=1.5 Hz, 12H), 1.11 (ddq, J=13.7, 9.0, 7.0 Hz, 1H), 0.87 (t, J=7.4 Hz, 6H). ¹³C{¹H} NMR (100 MHz, CDCl₃) δ 83.50, 67.47, 53.18, 39.18, 25.16, 25.08, 23.62, 22.97, 12.01, 11.28.

4-(cyclopropyl(4,4,5,5-tetramethyl-1,3,2-dioxaborolan-2-yl)methyl)morpholine. Method A: cyclopropanecarbaldehyde (35 mg, 0.5 mmol, 1.0 equiv.), morpholine (44 mg, 0.5 mmol, 1.0 equiv.), and Et₃SiBPin (133 mg, 0.6 mmol, 1.1 equiv.). Purification: Strategy 1. Title compound obtained as a transparent clear oil. ¹H NMR (400 MHz, CDCl₃) δ 3.75 (ddd, J=5.4, 3.7, 1.4 Hz, 4H), 2.77 (s, 2H), 2.41-2.25 (m, 2H), 1.26 (d, J=3.2 Hz, 12H), 1.08 (d, J=9.9 Hz, 1H), 0.75 (dddt, J=9.9, 8.5, 7.4, 5.0 Hz, 1H), 0.69-0.59 (m, 1H), 0.46-0.36 (m, 1H), 0.23-0.08 (m, 2H). ¹³C{¹H} NMR (100 MHz, CDCl₃) δ 83.57, 67.01, 54.23, 24.88, 24.41, 9.92, 8.39, 0.68.

4-(cyclohexyl(4,4,5,5-tetramethyl-1,3,2-dioxaborolan-2-yl)methyl)morpholine. Method A: cyclohexanecarbaldehyde (56 mg, 0.5 mmol, 1.0 equiv.), morpholine (44 mg, 0.5 mmol, 1.0 equiv.), and B₂Pin₂ (133 mg, 0.6 mmol, 1.1 equiv.). Purification: Strategy 1. White solid. ¹H NMR (400 MHz, CDCl₃) δ 3.71 (t, J=4.7 Hz, 4H), 2.52 (dt, J=9.7, 4.6 Hz, 2H), 2.42 (dd, J=10.7, 5.5 Hz, 2H), 1.87-1.63 (m, 7H), 1.28 (s, 12H), 1.27-0.89 (m, 5H). ¹³C{¹H} NMR (100 MHz, CDCl₃) δ 83.70, 77.48, 77.16, 76.84, 67.44, 53.41, 36.37, 31.84, 30.14, 27.19, 26.82, 26.59, 25.20.

4-(2,2-dimethyl-1-(4,4,5,5-tetramethyl-1,3,2-dioxaborolan-2-yl)propyl) morpholine. Method A: pivalaldehyde (43 mg, 0.5 mmol, 1.0 equiv.), morpholine (44 mg, 0.5 mmol, 1.0 equiv.), and B₂Pin₂ (133 mg, 0.6 mmol, 1.1 equiv.). Purification: Strategy 1. Clear transparent oil. ¹H NMR (400 MHz, CDCl₃) δ 3.71-3.59 (m, 4H), 2.78 (ddd, J=11.4, 6.0, 3.2 Hz, 2H), 2.53 (ddd, J=11.3, 5.7, 3.3 Hz, 2H), 1.71 (s, 1H), 1.27 (d, J=2.6 Hz, 12H), 0.92 (s, 9H). ¹³C{¹H} NMR (100 MHz, CDCl₃) δ 83.33, 68.13, 55.55, 35.11, 27.80, 25.52, 25.11.

1-(2-phenyl-1-(4,4,5,5-tetramethyl-1,3,2-dioxaborolan-2-yl)ethyl)pyrrolidine. Method A: 3-phenylpropionaldehyde (67 mg, 0.5 mmol, 1.0 equiv.), pyrrolidine (36 mg, 0.5 mmol, 1.0 equiv.), and B₂Pin₂ (133 mg, 0.6 mmol, 1.1 equiv.). Purification: Strategy 1. Transparent clear oil. ¹H NMR (400 MHz, CDCl₃) δ 7.28 (dt, J=6.8, 0.9 Hz, 2H), 7.26 (s, 1H), 7.22-7.14 (m, 3H), 2.82-2.71 (m, 1H), 2.60 (s, 3H), 2.52 (d, J=16.6 Hz, 3H), 1.96 (s, 3H), 1.77 (s, 4H), 1.30 (s, 12H). ¹³C{¹H} NMR (100 MHz, CDCl₃) δ 142.84, 128.31, 125.69, 83.41, 53.73, 33.36, 32.62, 25.10, 24.77, 24.72, 23.32.

1-(2-phenyl-1-(4,4,5,5-tetramethyl-1,3,2-dioxaborolan-2-yl)ethyl)piperidine. Method A: 3-phenylpropionaldehyde (67 mg, 0.5 mmol, 1.0 equiv.), piperidine (43 mg, 0.5 mmol, 1.0 equiv.), and B₂Pin₂ (133 mg, 0.6 mmol, 1.1 equiv.). Purification: Strategy 1. Transparent yellow oil (146 mg, 0.460 mmol, 92%). ¹H NMR (400 MHz, CDCl₃) δ 7.31-7.22 (m, 2H), 7.22-7.09 (m, 3H), 2.76-2.48 (m, 4H), 2.41 (dt, J=11.4, 5.3 Hz, 2H), 2.04 (t, J=7.1 Hz, 1H), 1.90 (qd, J=7.2, 3.8 Hz, 2H), 1.58 (p, J=5.6 Hz, 4H), 1.46-1.36 (m, 2H), 1.29 (s, 12H). ¹³C{¹H} NMR (100 MHz, CDCl₃) δ 143.01, 128.47, 128.34, 125.70, 83.45, 53.74, 33.57, 30.48, 26.40, 25.08, 25.05, 24.75.

1-(2-phenyl-1-(4,4,5,5-tetramethyl-1,3,2-dioxaborolan-2-yl)ethyl)azepane. Method A: 3-phenylpropionaldehyde (67 mg, 0.5 mmol, 1.0 equiv.), azepane (50 mg, 0.5 mmol, 1.0 equiv.), and B₂Pin₂ (133 mg, 0.6 mmol, 1.1 equiv.). Purification: Strategy 1. Transparent yellow oil. ¹H NMR (400 MHz, CDCl₃)₁H NMR (400 MHz, CDCl₃) δ 7.27 (d, J=7.3 Hz, 1H), 7.24 (d, J=1.3 Hz, 1H), 7.22-7.12 (m, 3H), 2.83-2.50 (m, 6H), 2.27 (s, 1H), 1.91-1.78 (m, 2H), 1.58 (s, 8H), 1.27 (s, 12H). ¹³C{¹H} NMR (100 MHz, CDCl₃) δ 143.18, 128.61, 128.29, 125.62, 83.01, 54.41, 33.71, 30.97, 28.98, 27.05, 25.15, 25.10.

2-(2-phenyl-1-(4,4,5,5-tetramethyl-1,3,2-dioxaborolan-2-yl)ethyl)-1,2,3,4-tetrahydroisoquinoline. Method B: 3-phenylpropionaldehyde (67 mg, 0.5 mmol, 1.0 equiv.), 1,2,3,4-tetrahydroisoquinoline (67 mg, 0.5 mmol, 1.0 equiv.), and B₂Pin₂ (133 mg, 0.6 mmol, 1.1 equiv.). Purification: Strategy 1. Dark brown oil. ¹H NMR (400 MHz, CDCl₃) δ 7.29 (d, J=7.5 Hz, 1H), 7.24-7.15 (m, 3H), 7.15-7.04 (m, 4H), 6.99 (d, J=7.9 Hz, 1H), 3.85-3.72 (m, 2H), 2.89 (d, J=5.5 Hz, 2H), 2.83 (dd, J=8.7, 3.4 Hz, 2H), 2.77-2.61 (m, 2H), 2.37-2.26 (m, 1H), 2.07-1.93 (m, 2H), 1.30 (s, 12H). ¹³C{¹H} NMR (100 MHz, CDCl₃) δ 142.82, 135.61, 134.77, 128.70, 128.53, 128.38, 126.66, 125.94, 125.76, 125.45, 83.62, 54.97, 49.51, 33.56, 30.58, 29.68, 25.10, 25.03.

1-(2-methoxyphenyl)-4-(2-phenyl-1-(4,4,5,5-tetramethyl-1,3,2-dioxaborolan-2-yl)ethyl)piperazine. Method A: 3-phenylpropionaldehyde (67 mg, 0.5 mmol, 1.0 equiv.), 1 1-(2-methoxyphenyl)piperazine (96 mg, 0.5 mmol, 1.0 equiv.), and B₂Pin₂ (133 mg, 0.6 mmol, 1.1 equiv.). Purification: Strategy 1. Red oil. ¹H NMR (400 MHz, CDCl₃) δ 7.29 (d, J=7.6 Hz, 2H), 7.23-7.14 (m, 3H), 7.02-6.89 (m, 3H), 6.85 (dd, J=7.9, 1.5 Hz, 1H), 3.85 (s, 3H), 3.13 (s, 4H), 2.79 (d, J=17.3 Hz, 2H), 2.76-2.56 (m, 4H), 2.15 (t, J=6.9 Hz, 1H), 1.96 (q, J=8.0 Hz, 2H), 1.31 (d, J=2.1 Hz, 12H). ¹³C{¹H} NMR (100 MHz, CDCl₃) δ 152.18, 142.62, 141.42, 128.28, 128.27, 125.66, 122.68, 120.92, 118.10, 111.05, 83.57, 55.23, 52.55, 50.78, 33.23, 30.09, 24.98, 24.83.

4-(1-(2-phenyl-1-(4,4,5,5-tetramethyl-1,3,2-dioxaborolan-2-yl)ethyl)piperidin-4-yl)morpholine. Method A: 3-phenylpropionaldehyde (67 mg, 0.5 mmol, 1.0 equiv.), 4-(piperidin-4-yl)morpholine (85 mg, 0.5 mmol, 1.0 equiv.), and B₂Pin₂ (133 mg, 0.6 mmol, 1.1 equiv.). Purification: Strategy 1 Transparent yellow oil. ¹H NMR (400 MHz, CDCl₃) δ 7.30-7.27 (m, 1H), 7.25 (d, J=2.3 Hz, 1H), 7.18 (dd, J=7.7, 2.0 Hz, 3H), 3.71 (dd, J=5.6, 3.6 Hz, 5H), 3.01 (dd, J=38.4, 11.0 Hz, 1H), 2.74-2.50 (m, 6H), 2.25-1.98 (m, 3H), 1.87 (p, J=7.3 Hz, 2H), 1.76 (d, J=12.1 Hz, 1H), 1.60 (s, 1H), 1.29 (s, 12H). ¹³C{¹H} NMR (100 MHz, CDCl₃) δ 142.80, 128.45, 128.34, 125.72, 83.54, 67.43, 62.44, 52.25, 51.89, 49.69, 46.23, 33.45, 30.57, 28.27, 25.05, 25.01.

1-methyl-4-(2-phenyl-1-(4,4,5,5-tetramethyl-1,3,2-dioxaborolan-2-yl)ethyl) piperazine. Method A: 3-phenylpropionaldehyde (67 mg, 0.5 mmol, 1.0 equiv.), 1-phenylpiperazine (81 mg, 0.5 mmol, 1.0 equiv.), and B₂Pin₂ (133 mg, 0.6 mmol, 1.1 equiv.). Purification: Strategy 1. Transparent clear oil. ¹H NMR (400 MHz, CDCl₃) δ 7.23 (d, J=6.9 Hz, 2H), 7.15 (d, J=7.7 Hz, 3H), 2.73-2.34 (m, 10H), 2.25 (s, 3H), 2.07 (t, J=7.0 Hz, 1H), 1.87 (q, J=7.9 Hz, 2H), 1.27 (d, J=2.0 Hz, 12H). ¹³C{¹H} NMR (100 MHz, CDCl₃) δ 128.46, 128.40, 125.80, 83.72, 55.47, 52.16, 46.17, 33.40, 30.47, 25.11, 25.00.

4-(2-phenyl-1-(4,4,5,5-tetramethyl-1,3,2-dioxaborolan-2-yl)ethyl)thiomorpholine. Method A: 3-phenylpropionaldehyde (67 mg, 0.5 mmol, 1.0 equiv.), thiomorpholine (52 mg, 0.5 mmol, 1.0 equiv.), and B₂Pin₂ (133 mg, 0.6 mmol, 1.1 equiv.). Purification: Strategy 1. White solid. ¹H NMR (400 MHz, CDCl₃) δ 7.28 (dd, J=7.9, 1.1 Hz, 1H), 7.25 (d, J=2.4 Hz, 1H), 7.18 (d, J=7.4 Hz, 3H), 2.82 (q, J=4.8 Hz, 4H), 2.72-2.55 (m, 7H), 2.14 (dd, J=8.6, 6.4 Hz, 1H), 1.86 (ddt, J=12.3, 9.0, 4.9 Hz, 2H), 1.28 (s, 12H). ¹³C{¹H} NMR (100 MHz, CDCl₃) δ 142.61, 128.45, 128.30, 125.71, 83.58, 53.94, 33.49, 29.67, 28.39, 25.03, 24.92.

N,N-dibenzyl-2-phenyl-1-(4,4,5,5-tetramethyl-1,3,2-dioxaborolan-2-yl)ethan-1-amine. Method A: Iovaleroaldehyde (43 mg, 0.5 mmol, 1.0 equiv.), dibenzylamine (99 mg, 0.5 mmol, 1.0 equiv.), and B₂Pin₂ (133 mg, 0.6 mmol, 1.1 equiv.). Purification: Strategy 1. White solid. ¹H NMR (400 MHz, CDCl₃) δ 7.40-7.34 (m, 4H), 7.27 (dd, J=8.2, 6.7 Hz, 4H), 7.21-7.15 (m, 2H), 3.73 (d, J=13.6 Hz, 2H), 3.56 (d, J=13.6 Hz, 2H), 2.38 (t, J=7.9 Hz, 1H), 1.73 (dq, J=13.3, 6.7 Hz, 1H), 1.61-1.52 (m, 1H), 1.28 (d, J=2.4 Hz, 12H), 0.78 (d, J=6.7 Hz, 3H), 0.61 (d, J=6.5 Hz, 3H). ¹³C{¹H} NMR (100 MHz, CDCl₃) δ 141.25, 129.07, 128.11, 126.64, 83.22, 56.45, 37.17, 25.26, 25.21, 25.08, 23.43, 22.16.

N,N-dibenzyl-2-phenyl-1-(4,4,5,5-tetramethyl-1,3,2-dioxaborolan-2-yl)ethan-1-amine. Method A: 3-phenylpropionaldehyde (67 mg, 0.5 mmol, 1.0 equiv.), N-benzylbut-3-en-1-amine (81 mg, 0.5 mmol, 1.0 equiv.), and B₂Pin₂ (133 mg, 0.6 mmol, 1.1 equiv.). Purification: Strategy 1. Afforded the title compound as a transparent faint orange oil. ¹H NMR (400 MHz, CDCl₃) δ 7.42-7.36 (m, 2H), 7.34-7.27 (m, 3H), 7.25-7.21 (m, 3H), 7.15 (dtd, J=7.0, 3.6, 1.7 Hz, 3H), 5.77 (ddt, J=17.0, 10.1, 6.8 Hz, 1H), 5.02-4.91 (m, 2H), 3.82-3.63 (m, 2H), 2.83-2.67 (m, 2H), 2.65-2.49 (m, 3H), 2.40 (t, J=7.6 Hz, 1H), 2.23-2.12 (m, 2H), 1.90-1.74 (m, 2H), 1.28 (s, 12H). ¹³C{¹H} NMR (100 MHz, CDCl₃) δ 143.35, 141.26, 137.55, 128.96, 128.59, 128.33, 128.12, 126.64, 125.61, 115.20, 83.35, 57.42, 52.26, 34.10, 32.95, 30.64, 25.18, 25.02.

4-(phenyl(4,4,5,5-tetramethyl-1,3,2-dioxaborolan-2-yl)methyl)morpholine. Method A: Benzaldehyde (53 mg, 0.5 mmol, 1.0 equiv.), morpholine (44 mg, 0.5 mmol, 1.0 equiv.), and Et₃SiBPin (133 mg, 0.6 mmol, 1.1 equiv.). Purification: Strategy 1. Faint yellow solid. ¹H NMR (400 MHz, CDCl₃) δ 7.40-7.09 (m, 5H), 3.72 (td, J=4.7, 2.8 Hz, 4H), 2.99 (s, 1H), 2.44 (q, J=6.0 Hz, 4H), 1.12 (d, J=20.3 Hz, 12H). ¹³C{¹H} NMR (100 MHz, CDCl₃) δ 136.25, 135.35, 129.16, 128.95, 83.83, 67.08, 67.04, 54.09, 24.55, 24.33, 21.16.

4-((4-phenoxyphenyl) (4,4,5,5-tetramethyl-1,3,2-dioxaborolan-2-yl)methyl) morpholine. Method A: 4-phenoxybenzaldehyde (99 mg, 0.5 mmol, 1.0 equiv.), morpholine (44 mg, 0.5 mmol, 1.0 equiv.), and B₂Pin₂ (133 mg, 0.6 mmol, 1.1 equiv.). Purification: Strategy 1. White solid. ¹H NMR (400 MHz, CDCl₃). ¹³C{¹H} NMR (100 MHz, CDCl₃) δ 157.35, 155.85, 133.41, 130.14, 129.69, 129.67, 129.65, 123.05, 118.87, 118.67, 118.64, 118.62, 83.83, 83.81, 83.79, 66.98, 53.96, 24.45, 24.22.

N,N-diethyl-4-(morpholino (4,4,5,5-tetramethyl-1,3,2-dioxaborolan-2-yl)methyl) aniline. Method A: 4-(diethylamino)benzaldehyde (89 mg, 0.5 mmol, 1.0 equiv.), morpholine (44 mg, 0.5 mmol, 1.0 equiv.), and B₂Pin₂ (133 mg, 0.6 mmol, 1.1 equiv.). Purification: Strategy 1. Transparent orange oil. NMR (400 MHz, CDCl₃) δ 7.19-7.12 (m, 2H), 6.64-6.57 (m, 2H), 3.72 (q, J=4.6 Hz, 4H), 3.32 (q, J=7.1 Hz, 4H), 2.84 (s, 1H), 2.43 (s, 4H), 1.20 (s, 6H), 1.16-1.11 (m, 12H). ¹³C{¹H} NMR (100 MHz, CDCl₃) δ 146.92, 130.33, 111.93, 83.70, 67.08, 54.07, 44.32, 24.58, 24.46, 12.69.

4-((4,4,5,5-tetramethyl-1,3,2-dioxaborolan-2-yl) (p-tolyl)methyl)morpholine. Method A: 4-methylbenzaldehyde (60 mg, 0.5 mmol, 1.0 equiv.), morpholine (44 mg, 0.5 mmol, 1.0 equiv.), and B₂Pin₂ (133 mg, 0.6 mmol, 1.1 equiv.). Purification: Strategy 1. Transparent clear oil. ¹H NMR (400 MHz, CDCl₃) δ 7.24-7.18 (m, 2H), 7.09 (d, J=7.8 Hz, 2H), 3.73 (td, J=4.9, 3.2 Hz, 4H), 2.95 (s, 1H), 2.48-2.37 (m, 4H), 2.31 (s, 3H), 1.15 (d, J=20.0 Hz, 12H). ¹³C{¹H} NMR (100 MHz, CDCl₃) δ 136.25, 135.35, 129.16, 128.95, 83.83, 67.08, 67.04, 54.09, 24.55, 24.33, 21.16.

4-((4-chlorophenyl) (4,4,5,5-tetramethyl-1,3,2-dioxaborolan-2-yl)methyl) morpholine. Method A: 4-chlorobenzaldehyde (70 mg, 0.5 mmol, 1.0 equiv.), morpholine (44 mg, 0.5 mmol, 1.0 equiv.), and B₂Pin₂ (133 mg, 0.6 mmol, 1.1 equiv.). Purification: Strategy 1. Transparent clear oil. ¹H NMR (400 MHz, CDCl₃) δ 7.34-7.22 (m, 4H), 3.72 (p, J=4.9 Hz, 4H), 2.98 (s, 1H), 2.42 (d, J=4.8 Hz, 4H), 1.14 (d, J=17.5 Hz, 12H). ¹³C{¹H} NMR (100 MHz, CDCl₃) δ 137.41, 132.26, 130.05, 128.55, 83.96, 66.99, 53.96, 24.49, 24.23.

4-((4-methoxyphenyl) (4,4,5,5-tetramethyl-1,3,2-dioxaborolan-2-yl)methyl) morpholine. Method A: 2-methoxybenzaldehyde (68 mg, 0.5 mmol, 1.0 equiv.), morpholine (44 mg, 0.5 mmol, 1.0 equiv.), and B₂Pin₂ (133 mg, 0.6 mmol, 1.1 equiv.). Purification: Strategy 1. Transparent clear oil. ¹H NMR (400 MHz, CDCl₃) δ 7.27 (d, J=2.1 Hz, 1H), 7.25 (s, 1H), 6.85-6.80 (m, 2H), 3.79 (s, 3H), 3.73 (q, J=4.3 Hz, 4H), 2.93 (s, 1H), 2.43 (d, J=5.9 Hz, 4H), 1.15 (d, J=20.6 Hz, 12H). ¹³C{¹H} NMR (100 MHz, CDCl₃) δ 158.44, 130.04, 113.75, 113.60, 83.74, 66.99, 55.14, 53.97, 24.49, 24.26.

4-((2,4-dimethoxyphenyl) (4,4,5,5-tetramethyl-1,3,2-dioxaborolan-2-yl)methyl) morpholine. Method A: 2,4-dimethoxybenzaldehyde (83 mg, 0.5 mmol, 1.0 equiv.), morpholine (44 mg, 0.5 mmol, 1.0 equiv.), and B₂Pin₂ (133 mg, 0.6 mmol, 1.1 equiv.). Purification: Strategy 1. White solid. ¹H NMR (400 MHz, CDCl₃) δ 7.32 (d, J=8.4 Hz, 1H), 6.49-6.41 (m, 2H), 3.78 (d, J=6.4 Hz, 6H), 3.71 (q, J=5.2 Hz, 4H), 3.48 (s, 1H), 2.60-2.37 (m, 4H), 1.19 (d, J=15.1 Hz, 12H). ¹³C{¹H} NMR (100 MHz, CDCl₃) δ 159.50, 158.64, 131.16, 118.60, 104.28, 98.39, 83.4, 67.18, 67.03, 55.36, 55.23, 53.27, 24.54.

4-((4,4,5,5-tetramethyl-1,3,2-dioxaborolan-2-yl) (thiophen-2-yl)methyl)

morpholine. Method A: thiophene-2-carbaldehyde (56 mg, 0.5 mmol, 1.0 equiv.), morpholine (44 mg, 0.5 mmol, 1.0 equiv.), and B₂Pin₂ (133 mg, 0.6 mmol, 1.1 equiv.). Purification: Strategy 1. Transparent yellow oil. ¹H NMR (400 MHz, CDCl₃) δ 7.21 (ddd, J=4.8, 1.6, 0.6 Hz, 1H), 6.96-6.91 (m, 2H), 3.79-3.66 (m, 5H), 3.37 (s, 1H), 2.59-2.40 (m, 4H), 1.20 (d, J=16.2 Hz, 12H). ¹³C{¹H} NMR (100 MHz, CDCl₃) δ 141.48, 126.57, 126.20, 125.11, 84.16, 66.97, 53.58, 24.50, 24.40.

4-((1-methyl-1H-pyrazol-4-yl) (4,4,5,5-tetramethyl-1,3,2-dioxaborolan-2-yl)methyl) morpholine. Method A: 1-methyl-1H-pyrazole-4-carbaldehyde (55 mg, 0.5 mmol, 1.0 equiv.), morpholine (44 mg, 0.5 mmol, 1.0 equiv.), and B₂Pin₂ (133 mg, 0.6 mmol, 1.1 equiv.). Purification: Strategy 1. White solid. ¹H NMR (400 MHz, CDCl₃) δ 7.42 (s, 1H), 7.29 (s, 1H), 3.86 (s, 3H), 3.72 (q, J=4.8 Hz, 4H), 2.98 (s, 1H), 2.57-2.30 (m, 4H), 1.22 (d, J=13.5 Hz, 12H). ¹³C{¹H} NMR (100 MHz, CDCl₃) δ 140.1, 129.9, 116.9, 83.8, 66.9, 53.4, 38.9, 24.5, 24.5.

4-((4-fluorophenyl) (4,4,5,5-tetramethyl-1,3,2-dioxaborolan-2-yl)methyl) morpholine. Method A: 4-fluorobenzaldehyde (62 mg, 0.5 mmol, 1.0 equiv.), morpholine (44 mg, 0.5 mmol, 1.0 equiv.), and B₂Pin₂ (133 mg, 0.6 mmol, 1.1 equiv.). Purification: Strategy 1. White solid. ¹H NMR (400 MHz, CDCl₃) δ 7.32 (dd, J=8.3, 5.5 Hz, 2H), 6.97 (t, J=8.7 Hz, 2H), 3.73 (q, J=4.6 Hz, 4H), 2.98 (s, 1H), 2.52-2.34 (m, 4H), 1.14 (d, J=18.7 Hz, 12H). ¹³C{¹H} NMR (100 MHz, CDCl₃) δ 163.05, 160.62, 134.43, 130.34, 130.26, 115.39, 115.18, 67.09, 54.02, 24.54, 24.29.

4-((4-(pyrrolidin-1-yl)phenyl) (4,4,5,5-tetramethyl-1,3,2-dioxaborolan-2-yl)methyl) morpholine. Method A: 4-(pyrrolidin-1-yl)benzaldehyde (87 mg, 0.5 mmol, 1.0 equiv.), morpholine (44 mg, 0.5 mmol, 1.0 equiv.), and B₂Pin₂ (133 mg, 0.6 mmol, 1.1 equiv.). Purification: Strategy 1. Orange to yellow solid. ¹H NMR (400 MHz, CDCl₃) δ 7.22-7.15 (m, 2H), 6.52-6.46 (m, 2H), 3.72 (q, J=4.3 Hz, 4H), 3.31-3.22 (m, 4H), 2.84 (s, 1H), 2.42 (d, J=5.8 Hz, 4H), 2.01-1.94 (m, 4H), 1.17 (d, J=20.9 Hz, 12H). ¹³C{¹H} NMR (100 MHz, CDCl₃) δ 146.84, 130.16, 124.40, 111.52, 83.57, 66.99, 54.02, 47.56, 29.69, 25.45, 24.52, 24.36.

### REFERENCES

(1) (a) Marshall, C. M.; Federice, J. G.; Bell, C. N.; Cox, P. B.; Njardarson, J. T., An Update on the Nitrogen Heterocycle Compositions and Properties of U.S. FDA-Approved Pharmaceuticals (2013-2023). J. Med. Chem. 2024, 67, 11622-11655; (b) Roughley, S. D.; Jordan, A. M., The Medicinal Chemist's Toolbox: An Analysis of Reactions Used in the Pursuit of Drug Candidates. J. Med. Chem. 2011, 54, 3451-3479.
(2) (a) Lamberth, C., Heterocyclic chemistry in crop protection. Pest. Manag. Sci. 2013, 69, 1106-1114; (b) Lamberth, C.; Jeanmart, S.; Luksch, T.; Plant, A., Current Challenges and Trends in the Discovery of Agrochemicals. Science 2013, 341, 742-746.
(3) (a) Yu, I. F.; Wilson, J. W.; Hartwig, J. F., Transition-Metal-Catalyzed Silylation and Borylation of C—H Bonds for the Synthesis and Functionalization of Complex Molecules. Chem. Rev. 2023; (b) Noor, R., Zahoor, A. F.; Irfan, M., Hussain, S. M.; Ahmad, S.; Irfan, A; Kotwica-Mojzych, K; Mojzych, M., Transition Metal Catalyzed Hiyama Cross-Coupling: Recent Methodology Developments and Synthetic Applications. Molecules 2022, 27, 5654-5707; (c) Basak, S.; Biswas, J. P.; Maiti, D., Transition-Metal-Catalyzed C—H Arylation Using Organoboron Reagents. Synthesis 2021, 53, 3151-3179.
(4) (a) Zhu, Y.-S.; Guo, Y.-L.; Zhu, Y.-Y.; Su, B., Enantioselective 1,4-Borylamination via Copper-Catalyzed Cascade Hydroborylation and Hydroamination of Arylidenecyclopropanes. J. Am. Chem. Soc. 2024, 146, 32283-32291; (b) Bhatt, S., Nicely, A. M.; Powell, C. U.; Huff, M. E.; Thibodeaux, S. B.; Wang, Y.-N.; Vasylevskyi, S.; Hull, K. L., Pd and Fe Cocatalyzed Synthesis of Remotely Borylated Aza-Heterocycles. ACS Catal. 2024, 18507-18514; (c) Gay, B. L.; Wang, Y.-N.; Bhatt, S.; Tarasewicz, A.; Cooke, D. J.; Milem, E. G.; Zhang, B.; Gary, B.; Neidig, M. L.; Hull, K. L., Palladium and Iron Cocatalyzed Aerobic Alkene Aminoboration. J. Am. Chem. Soc. 2023; (d) Lyu, M.-Y.; Morais, G. N.; Chen, S.; Brown, M. K, Ni-Catalyzed 1,1- and 1,3-Aminoboration of Unactivated Alkenes. J. Am. Chem. Soc. 2023, 145, 27254-27261; (e) Hirano, K; Miura, M., Hydroamination, Aminoboration, and Carboamination with Electrophilic Amination Reagents: Umpolung-Enabled Regio- and Stereoselective Synthesis of N-Containing Molecules from Alkenes and Alkynes. J. Am. Chem. Soc. 2022, 144, 648-661; (t) Zheng, D.; Jana, K; Alasmary, F. A.; Daniliuc, C. G.; Studer, A., Transition-Metal-Free Intramolecular Radical Aminoboration of Unactivated Alkenes. Org. Lett. 2021, 23, 7688-7692; (g) Yang, C.-H.; Han, M.; Li, W.; Zhu, N.; Sun, Z.; Wang, J.; Yang, Z.; Li, Y.-M., Direct Intramolecular Aminoboration of Allenes. Org. Lett. 2020, 22, 5090-5093; (h) Issaian, A.; Tu, K. N.; Blum, S. A., Boron-Heteroatom Addition Reactions via Borylative Heterocyclization: Oxyboration, Aminoboration, and Thioboration. Acc. Chem. Res. 2017, 50, 2598-2609; (i) Liu, Z.; Ni, H.-Q; Zeng, T.; Engle, K. M., Catalytic Carbo- and Aminoboration of Alkenyl Carbonyl Compounds via Five- and Six-Membered Palladacycles. J. Am. Chem. Soc. 2018, 140, 3223-3227.
(5) Yu, X.; Daniliuc, C. G.; Alasmary, F. A.; Studer, A, Direct Access to α-Aminosilanes Enabled by Visible-Light-Mediated Multicomponent Radical Cross-Coupling. Angew. Chem. Int. Ed. 2021, 60, 23335-23341.
(6) (a) Talavera, L.; Reund, R. R. A.; Zhang, H.; Wakeling, M.; Jensen, M.; Martin, R., Nickel-Catalyzed 1,1-Aminoborylation of Unactivated Terminal Alkenes. ACS Catal. 2023, 5538-5543; (b) Xie, Q; Dong, G., Aza-Matteson Reactions via Controlled Mono- and Double-Methylene Insertions into Nitrogen-Boron Bonds. J. Am. Chem. Soc. 2021, 143, 14422-14427; (c) Ming, W.; Liu, X.; Friedrich, A.; Krebs, J.; Marder, T. B., The Borono-Strecker Reaction: Synthesis of α-Aminoboronates via a Multicomponent Reaction of Carbonyl Compounds, Amines, and B₂pin₂. Org. Lett. 2020, 22, 365-370.
(7) (a) Franz, A. K; Wilson, S. O., Organosilicon Molecules with Medicinal Applications. J. Med. Chem. 2013, 56, 388-405; (b) Sieburth, S. M.; Nittoli, T.; Mutahi, A. M.; Guo, L., Silanediols: A New Class of Potent Protease Inhibitors. Angew. Chem. Int. Ed. 1998, 37, 812-814.
(8) Kim, J.; Hewitt, G.; Carroll, P.; Sieburth, S. M., Silanediol Inhibitors of Angiotensin-Converting Enzyme. Synthesis and Evaluation of Four Diastereomers of Phe[Si]Ala Dipeptide Analogues. J. Org. Chem. 2005, 70, 5781-5789.
(9) Madsen, J. L. H.; Andersen, T. L.; Santamaria, S.; Nagase, H.; Enghild, J. J.; Skrydstrup, T., Synthesis and Evaluation of Silanediols as Highly Selective Uncompetitive Inhibitors of Human Neutrophil Elastase. J. Med. Chem. 2012, 55, 7900-7908.
(10) (a) Min, G. K; Hernandez, D.; Skrydstrup, T., Efficient Routes to Carbon-Silicon Bond Formation for the Synthesis of Silicon-Containing Peptides and Azasilaheterocycles. Acc. Chem. Res. 2013, 46, 457-470; (b) Hernandez, D.; Nielsen, L.; Lindsay, K. B.; Angeles Lopez-Garcia, M.; Bjerglund, K; Skrydstrup, T., Stereocontrolled Synthesis of 2-Substituted-1,3-Azasilaheterocycles. Org. Lett. 2010, 12, 3528-3531; (c) Ballweg, D. M.; Miller, R. C.; Gray, D. L.; Scheidt, K. A., Stereoselective Synthesis of α-Silylamines by the Direct Addition of Silyl Anions to Activated Imines. Org. Lett. 2005, 7, 1403-1406.
(11) Niljianskul, N.; Zhu, S.; Buchwald, S. L., Enantioselective Synthesis of α-Aminosilanes by Copper-Catalyzed Hydroamination of Vinylsilanes. Angew. Chem. Int. Ed. 2015, 54, 1638-1641.
(12) (a) Zhang, W.-W.; Li, B.-J., Enantioselective Hydrosilylation of β,β-Disubstituted Enamides to Construct α-Aminosilanes with Vicinal Stereocenters. Angew. Chem. Int. Ed. 2023, 62, e202214534; (b) Chung, J. Y. L.; Shevlin, M.; Klapars, A; Journet, M., Asymmetric Synthesis of N-Boc-(R)-Silaproline via Rh-Catalyzed Intramolecular Hydrosilylation of Dehydroalanine and Continuous Flow N-Alkylation. Org. Lett. 2016, 18, 1812-1815; (c) Murai, T.; Oda, T.; Kimura, F.; Onishi, H.; Kanda, T.; Kato, S., Rhodium (II) acetate catalysed hdrosilylation of enamides and N-vinylureas leading to 1-(trialkylsilyl)alkylamine derivatives. J. Chem. Soc., Chem. Commun. 1994, 2143-2144.
(13) (a) Jiao, J.; Yang, W.; Wang, X., α-Aminocarbene-Mediated Si—H Insertion: Deoxygenative Silylation of Aromatic Amides with Silanes. J. Org. Chem. 2023, 88, 594-601; (b) Zhou, L.; Qiu, J.; Wang, C.; Zhang, F.; Yang, K; Song, Q., Synthesis of α-Aminosilanes by 1,2-Metalate Rearrangement Deoxygenative Silylation of Aromatic Amides. Org. Lett. 2022, 24, 3249-3253.
(14) Mita, T.; Michigami, K.; Sato, Y., Iridium- and Rhodium-Catalyzed Dehydrogenative Silylations of C(sp³)-H Bonds Adjacent to a Nitrogen Atom Using Hydrosilanes. Chem. Asian J. 2013, 8, 2970-2973.
(15) Zhang, X.; Geng, P.; Liu, G.; Huang, Z., Ru-Catalyzed Site-Selective Aliphatic C—H Bond Silylation of Amides and Carbamides. Organometallics 2021, 40, 2365-2370.
(16) Feng, J.-J.; Oestreich, M., Copper-Catalyzed Silylation of C(sp³)-H Bonds Adjacent to Amide Nitrogen Atoms. Org. Lett. 2018, 20, 4273-4276.
(17) Lin, S.; Liu, Y.; Gao, K.-Y.; Chen, Z.-H.; Qian, J.; Liu, X-B.; Li, Q.; Wang H., β-Silicon Effect Enables Metal-Free Site-Selective Intermolecular Allylic CH Amination. ACS Catal. 2024, 8865-8873.
(18) Zheng, J.; Zhang, H.; Kong, S.; Ma, Y.; Du, Q,; Yi, B.; Zhang, G.; Guo, R., Copper-Catalyzed General and Selective α-C(sp³)-H Silylation of Amides via 1,5-Hydrogen Atom Transfer. ACS Catal. 2024, 1725-1732.
(19) John, S. E.; Gulati, S.; Shankaraiah, N., Recent advances in multi-component reactions and their mechanistic insights: a triennium review. Org. Chem. Front. 2021, 8, 4237-4287.
(20) (a) Hosseininezhad, S.; Ramazani, A., Recent advances in the application of alkynes in multicomponent reactions. RSC Adv. 2024, 14, 278-352; (b) Ganem, B., Strategies for Innovation in Multicomponent Reaction Design. Acc. Chem. Res. 2009, 42, 463-472.
(21) Ming, W.; Soor, H. S.; Liu, X; Trofimova, A.; Yudin, A. K.; Marder, T. B., α-Aminoboronates: recent advances in their preparation and synthetic applications. Chem. Soc. Rev. 2021, 50, 12151-12188.
(22) Feng, J.-J.; Mao, W.; Zhang, L.; Oestreich, M., Activation of the Si—B interelement bond related to catalysis. Chem. Soc. Rev. 2021, 50, 2010-2073.
(23) (a) Plotzitzka, J.; Kleeberg, C., [(NHC)CuI-ER₃] Complexes (ER³=SiMe₂Ph, SiPh₃, SnMe₃): From Linear, Mononuclear Complexes to Polynuclear Complexes with Ultrashort CuI—CuI Distances. Inorg. Chem. 2016, 55, 4813-4823; (b) Hensel, A.; Nagura, K.; Delvos, L. B.; Oestreich, M., Enantioselective Addition of Silicon Nucleophiles to Aldimines Using a Preformed NHC-Copper (I) Complex as the Catalyst. Angew. Chem. Int. Ed. 2014, 53, 4964-4967; (c) Vyas, D. J.; Frohlich, R.; Oestreich, M., Activation of the Si—B Linkage: Copper-Catalyzed Addition of Nucleophilic Silicon to Imines. Org. Lett. 2011, 13, 2094-2097.
(24) Ming, W.; Liu, X.; Friedrich, A.; Krebs, J., Budiman, Y. P.; Huang, M.; Marder, T. B., Concise synthesis of α-amino cyclic boronates via multicomponent coupling of salicylaldehydes, amines, and B₂(OH)₄. Green Chem. 2020, 22, 2184-2190.
(25) (a) Kamio, S.; Nakamoto, M.; Yamagishi, T., Oestreich, M.; Yoshida, H., Copper-catalyzed silylation of aryl and alkenyl triflates with silylboronic esters avoiding base-mediated borylation. Chem. Commun. 2024, 60, 6379-6382; (b) Jia, Y.; Li, L.; Duan, L.; Li, Y.-M., The aza-Prins Cyclization of Unfunctionalized Olefins Promoted by NHC—Cu Complex and ZrCl₄. Appl. Organomet. Chem. 2020, 34, e5927.
(26) (a) Brazier,]. B.; Tomkinson, N. C. O. In Asymmetric Organocatalysis, List, B., Ed. Springer Berlin Heidelberg: Berlin, Heidelberg, 2009; pp 281-347; (b) Erkkila, A.; Majander, I.; Pihko, P. M., Iminium Catalysis. Chem. Rev. 2007, 107, 5416-5470.
(27) (a) Brak, K.; Jacobsen, E. N., Asymmetric Ion-Pairing Catalysis. Angew. Chem. Int. Ed. 2013, 52, 534-561; (b) Macchioni, A., Ion Pairing in Transition Metal Organometallic Chemistry. Chem. Rev. 2005, 105, 2039-2074.
(28) (a) Braddock, A. A.; Lee, G. E.; Theodorakis, E. A.; Romero, E. A., Interrogating Redox and Lewis Base Activations of Aminoboranes. Organometallics 2022, 41, 3845-3851; (b) Romero, E. A.; Peltier, L.; Jazzar, R.; Bertrand, G., Catalyst-free dehydrocoupling of amines, alcohols, and thiols with pinacol borane and 9-borabicyclononane (9-BBN). Chem. Commun. 2016, 52, 10563-10565.
(29) (a) Gensch, T.; Teders, M.; Glorius, F., Approach to Comparing the Functional Group Tolerance of Reactions. J. Org. Chem. 2017, 82, 9154-9159; (b) Collins, K. D.; Glorius, F., A robustness screen for the rapid assessment of chemical reactions. Nat. Chem. 2013, 5, 597-601.
(30) Tsuge, O.; Tanaka, J.; Kanemasa, S., Nucleophilic Aminomethylation of Aldehydes with α-Amino Alkylsilanes. Bull. Chem. Soc. Jpn. 1985, 58, 1991-1999.
(31) (a) Ye, F.; Zheng, S.; Luo, Y.; Qi, X; Yuan, W., Ligand-Controlled Regioreversed 1,2-Aryl-Arninoalkylation of Alkenes Enabled by Photoredox/Nickel Catalysis. ACS Catal. 2024, 14, 8505-8517; (b) Ye, F.; Tong, S.; Yuan, W., Merging Photoredox and Nickel Catalysis: A Ligand-Free Cross Coupling of Vinyl Halides and α-Silylamines toward Tertiary Allylic Alkylamines. ACS Catal. 2024, 14, 9655-9661; (c) Wang, W., Yan, X; Ye, F.; Zheng, S.; Huang, G.; Yuan, W., Nickel/Photoredox Dual-Catalyzed Regiodivergent Aminoalkylation of Unactivated Alkyl Halides. J. Am. Chem. Soc. 2023, 145, 23385-23394; (d) Zhao, Y.; Merrett,]. T.; Jin, J.; Yu, L.-J.; Coote, M. L.; Chan, P. W. H., Gold catalysed site-selective cross-coupling of tertiary α-silylamines with 1-iodoalkynes under UVA LED light. Org. Chem. Front. 2023, 10, 759-766; (e) Lahdenpera, A. S. K.; Bacos, P. D.; Phipps, R. J., Enantioselective Giese Additions of Prochiral α-Amino Radicals. J. Am. Chem. Soc. 2022, 144, 22451-22457; (f) Ruiz Espelt, L.; McPherson, I. S.; Wiensch, E. M.; Yoon, T. P., Enantioselective Conjugate Additions of α-Amino Radicals via Cooperative Photoredox and Lewis Acid Catalysis. J. Am. Chem. Soc. 2015, 137, 2452-2455; (g) Miyake, Y.; Ashida, Y.; Nakajima, K.; Nishibayashi, Y., Visible-light-mediated addition of α-aminoalkyl radicals generated from α-silylamines to α,β-unsaturated carbonyl compounds. Chem. Commun. 2012, 48, 6966-6968.
(32) Waller, H. C.; Gaunt, M. J., Silyl Radicals as Single-Electron Reductants: α-Aminoalkyl Radical Formation via a Photocatalytic Oxidatively Initiated Radical Chain Process. J. Am. Chem. Soc. 2024, 146, 25894-25901.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A process of forming a 1,1-aminosilane, the process comprising contacting for a predetermined length of time a mixture comprising an amine, an aldehyde, a sila-borane, and a copper catalyst in a solvent to form the 1,1-aminosilane.

2. The process of claim 1, wherein the amine is a compound of formula NHR¹R², wherein: R¹ and R² are independently selected from H, substituted or unsubstituted alkyl, substituted or unsubstituted alkenyl, substituted or unsubstituted alkynyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroaralkyl, provided that R¹ and R² are not both H; or R¹ and R² together form a substituted or unsubstituted ring with the nitrogen atom to which they are attached, wherein the ring may further incorporate one or more O, N, or S atoms.

3. The process of claim 2, wherein R¹ and R² are independently selected from H, substituted or unsubstituted alkyl, substituted or unsubstituted alkenyl, substituted or unsubstituted alkynyl, substituted or unsubstituted cycloalkyl, substituted or unsubstituted aryl, substituted or unsubstituted heteroaryl, substituted or unsubstituted aralkyl, or substituted or unsubstituted heteroaralkyl, provided that R¹ and R² are not both H.

4. The process of claim 2, wherein R¹ and R² together form a substituted or unsubstituted ring with the nitrogen atom to which they are attached, wherein the ring may further incorporate one or more O, N, or S atoms.

5. The process of claim 1, wherein the aldehyde is a compound of formula R³C(O)H, wherein R³ is substituted or unsubstituted alkyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroalkyl.

6. The process of claim 1, wherein the sila-borane is a compound of formula: 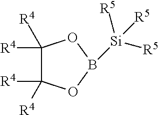
wherein:
each R⁴ is individually H, substituted or unsubstituted alkyl, or substituted or unsubstituted aryl; and
each R⁵ is individually H, substituted or unsubstituted alkyl, substituted or unsubstituted aryl, substituted or unsubstituted cycloalkyl, substituted or unsubstituted heterocycloalkyl, substituted or unsubstituted heteroaryl, or substituted or unsubstituted alkoxy.

7. The process of claim 1, wherein the sila-borane is triethylsilylpinacolborane.

8. The process of claim 1, wherein the copper catalyst is CuX(IPr), wherein IPr is a 1-(2,6-diisopropylphenyl)-1H-imidazole group, and X is F, Cl, Br, triflate, or other suitable anion.

9. The process of claim 8, wherein X is Cl or triflate.

10. The process of claim 1, wherein the 1,1-aminosilane is a compound of formula: 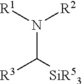
wherein:
R³ is substituted or unsubstituted alkyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroalkyl;
R¹ and R² are independently selected from H, substituted or unsubstituted alkyl, substituted or unsubstituted alkenyl, substituted or unsubstituted alkynyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroaralkyl, provided that R¹ and R² are not both H; or R¹ and R² together form a substituted or unsubstituted ring with the nitrogen atom to which they are attached, wherein the ring may further incorporate one or more O, N, or S atoms, and
R⁵ is individually H, substituted or unsubstituted alkyl, substituted or unsubstituted aryl, substituted or unsubstituted cycloalkyl, substituted or unsubstituted heterocycloalkyl, substituted or unsubstituted heteroaryl, or substituted or unsubstituted alkoxy.

11. The process of claim 1, wherein the predetermined length of time is from about 12 hours to about 72 hours.

12. A process of forming a 1,1-aminoborane, the process comprising contacting for a predetermined length of time a mixture comprising an amine, an aldehyde, bis(pinacolato)diboron (B₂Pin₂), and a copper catalyst in a solvent to form the 1,1-aminoborane.

13. The process of claim 12, wherein the amine is a compound of formula NR⁶R⁷R⁸, wherein:
R⁶ is H or Si(R⁹)₃;
R⁷ and R⁸ are independently selected from H, substituted or unsubstituted alkyl, substituted or unsubstituted alkenyl, substituted or unsubstituted alkynyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroaralkyl, provided that R⁷ and R⁸ are not both H; or R⁷ and R⁸ together form a substituted or unsubstituted ring with the nitrogen atom to which they are attached, wherein the ring may further incorporate one or more O, N, or S atoms; and
each R⁹ is independently substituted or unsubstituted alkyl, substituted or unsubstituted aryl, substituted or unsubstituted cycloalkyl, substituted or unsubstituted heterocycloalkyl, substituted or unsubstituted heteroaryl, or substituted or unsubstituted alkoxy.

14. The process of claim 13, wherein R⁷ and R⁸ are independently selected from H, substituted or unsubstituted alkyl, substituted or unsubstituted alkenyl, substituted or unsubstituted alkynyl, substituted or unsubstituted cycloalkyl, substituted or unsubstituted aryl, substituted or unsubstituted heteroaryl, substituted or unsubstituted aralkyl, or substituted or unsubstituted heteroaralkyl, provided that R⁷ and R⁸ are not both H.

15. The process of claim 13, wherein R⁷ and R⁸ together form a substituted or unsubstituted ring with the nitrogen atom to which they are attached, wherein the ring may further incorporate one or more O, N, or S atoms.

16. The process of claim 12, wherein the aldehyde is a compound of formula R¹⁰C(O)H, wherein R¹⁰ is substituted or unsubstituted alkyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroalkyl.

17. The process of claim 12, wherein the copper catalyst is CuX(IPr), wherein IPr is a 1-(2,6-diisopropylphenyl)-1H-imidazole group, and X is F, Cl, Br, triflate, or other suitable anion.

18. The process of claim 12, wherein the copper catalyst is CuX(^{Et}CAA₅) or CuX(^{iPr}BiCAAC), and X is F, Cl, Br, triflate, or other suitable anion.

19. The process of claim 12, wherein the 1,1-aminoborane is a compound of formula: 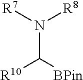
wherein:
R¹⁰ is substituted or unsubstituted alkyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroalkyl;
R⁷ and R⁸ are independently selected from H, substituted or unsubstituted alkyl, substituted or unsubstituted alkenyl, substituted or unsubstituted alkynyl, substituted or unsubstituted cycloalkyl, substituted or unsubstituted aryl, substituted or unsubstituted heterocycloalkyl, substituted or unsubstituted heteroaryl, substituted or unsubstituted aralkyl, or substituted or unsubstituted heteroaralkyl, provided that R⁷ and R⁸ are not both H; or R⁷ and R⁸ together form a substituted or unsubstituted ring with the nitrogen atom to which they are attached, wherein the ring may further incorporate one or more O, N, or S atoms.

20. The process of claim 12, wherein the predetermined length of time is from about 12 hours to about 72 hours.
